(19) United States
(12) Patent Application Publication
(10) Pub. No.: US 2026/0094198 A1
(43) Pub. Date: Apr. 2, 2026

(54) Personal Stylist System and Method for Wardrobe Management, Outfit Recommendation, and Monetization

(71) Applicant: PersonalX.com Inc., Dover, DE (US)

(72) Inventors: Adriana Ferreyr, Palm Beach, FL (US); Thomas Asikis, Zurich (CH)

(21) Appl. No.: 19/264,484

(22) Filed: Jul. 9, 2025

Related U.S. Application Data
(60) Provisional application No. 63/669,187, filed on Jul. 9, 2024.
(60) Provisional application No. 63/679,937, filed on Aug. 6, 2024.
(60) Provisional application No. 63/794,709, filed on Apr. 25, 2025.
(60) Provisional application No. 63/794,772, filed on Apr. 25, 2025.

(51) Int. Cl. G06Q 30/0601

(52) U.S. Cl. CPC G06Q 30/06311; G06Q 30/0617; G06Q 30/0633; G06Q 30/06432

(57) ABSTRACT

A computer-implemented method and system for providing personalized style recommendations in a social shopping environment are described. The method involves searching for a wardrobe associated with a specific person, identifying styles, and generating virtual fit pics for users. These virtual fit pics allow users to see digital representations of themselves wearing clothing items and include interactive elements for purchasing. Users can follow specific wardrobes, which are displayed in their content streams, and receive updates with new digital representations or clothing items. The system comprises a remote storage system, a personal stylist agent, a user interface, and a social wardrobe feed, all working together to enhance the shopping experience.

### CROSS-REFERENCE TO RELATED APPLICATIONS

This application claims priority to U.S. Provisional Paten Application No. 63/669,187 titled “Personal Stylist System and Method for Wardrobe Management, Outfit Recommendation, and Monetization” and filed on Jul. 9, 2024; claims priority to U.S. Provisional Patent Application No. 63/679,937 titled “Multi-Agent Search Method and System” and filed on Aug. 6, 2024; claims priority to U.S. Provisional Patent Application No. 63/794,709 titled “AI-Based Stylist Recommendation System and Related Methods” and filed on Apr. 25, 2025; and claims priority to U.S. Provisional Patent Application No. 63/794,772 titled “Social-Shopping Environment with Multi-Agent Search and Related Methods” and filed on Apr. 25, 2025; each of which is incorporated by reference herein in its entirety.

### TECHNICAL FIELD

The present disclosure relates to a personal stylist system and method, and more particularly, to a system and method for conducting a multi-agent shopping search within a social shopping environment.

### BACKGROUND

In recent years, the fashion industry has seen a significant shift towards digitalization, with online shopping becoming increasingly popular among consumers. This trend has been driven by the convenience and accessibility of online platforms, which allow users to browse and purchase clothing from the comfort of their homes. However, despite the growth of e-commerce, many consumers still face challenges when it comes to finding clothing that matches their personal style and preferences. Traditional online shopping platforms often lack personalized recommendations, making it difficult for users to discover new styles or outfits that suit their tastes.

Moreover, the rise of social media has transformed the way people engage with fashion, with many individuals seeking inspiration from influencers and peers. This has led to a growing demand for platforms that combine social interaction with shopping, allowing users to share their fashion choices and discover new trends through their social networks. As a result, there is a need for innovative solutions that integrate social elements into the shopping experience, providing users with personalized recommendations and the ability to explore and interact with fashion in a more engaging and interactive way.

### SUMMARY

The computer-implemented method may provide personalized style recommendations within a social shopping environment. The method can involve a personal stylist agent searching for a wardrobe linked to a specific person, with the wardrobe stored in a remote storage system. The personal stylist agent may identify styles associated with the wardrobe. A user can request recommendations in the style of the specific person, and the method may generate virtual fit pics showing digital representations of the user wearing clothing items based on the identified styles. These virtual fit pics can be provided to the user and may include interactive elements for purchasing the clothing items. The user may select to follow the wardrobe of the specific person, and the wardrobe can be displayed in the user's content stream. The specific person may provide new digital representations or clothing items, which can be displayed in the user's content stream.

The system may offer personalized style recommendations in a social shopping environment, comprising a remote storage system for storing wardrobes associated with persons. A personal stylist agent can search for a wardrobe linked to a specific person and identify styles associated with the wardrobe. A user interface may receive a request from a user for style recommendations and provide virtual fit pics showing digital representations of the user wearing clothing items based on identified styles. These virtual fit pics can include interactive elements for purchasing the clothing items. A social wardrobe feed may allow the user to follow a specific person's wardrobe, display it in the user's content stream, and show new digital representations or clothing items provided by the specific person.

The styles identified in the method may include classic, business casual, or elegant options.

The request for style recommendations can be made through a button click.

Interactive elements in the virtual fit pics may include shoppable links.

New digital representations may comprise fitpics.

The styles identified in the system may include classic, business casual, or elegant options.

The request for style recommendations in the system can be made through a button click.

Interactive elements in the system's virtual fit pics may include shoppable links.

New digital representations in the system may comprise fitpics.

The remote storage system in the method may be cloud-based.

Virtual fit pics in the method can be generated based on the user's body measurements and clothing items.

The user's content stream in the method may be a social media feed.

New digital representations or clothing items in the method can be displayed in real-time in the user's content stream.

The remote storage system in the system may be cloud-based.

Virtual fit pics in the system can be generated based on the user's body measurements and clothing items.

The user's content stream in the system may be a social media feed.

New digital representations or clothing items in the system can be displayed in real-time in the user's content stream.

The method may include receiving a purchase request from the user for clothing items and processing the request.

The system's user interface can receive a purchase request from the user for clothing items and process the request.

### BRIEF DESCRIPTION OF THE DRAWINGS

FIG. 1-1 illustrates a process for personalized wardrobe recommendations and purchases using virtual fit pics.

FIG. 1-2 illustrates a personal stylist system integrating remote storage, agent, user interface, and social wardrobe feed.

FIG. 1-3 illustrates an example sign-in screen.

FIGS. 2A-2J illustrate a sequence of example user registration screens.

FIGS. 3A-3F illustrate a sequence of example preference quiz screens.

FIGS. 4A-4C illustrate a sequence of example user preference screens.

FIGS. 5A-5E illustrate a sequence of example homepage screens for selecting a search-for-shopping service or a shopping assistant.

FIGS. 6A-6M illustrate a sequence of example account creation screens.

FIGS. 7A-7I illustrate a sequence of example outfit recommendation screens.

FIG. 8 illustrates an example personal stylist result screen.

FIG. 9 and FIG. 9 (Continued) illustrates an example fitpic screen.

FIG. 10 illustrates an example outfit analysis screen.

FIGS. 11A-11B illustrate a sequence of example guided path screens.

FIGS. 12A-12C illustrate a sequence of item recommendation screens.

FIGS. 13A-13C illustrate a sequence of example wardrobe recommendation screens.

FIG. 14 illustrates an example generated fitpic screen.

FIG. 15 illustrates an example purchase recommendation screen.

FIG. 16 illustrates an example purchase screen.

FIG. 17 illustrates and example purchase preview screen.

FIG. 18 illustrates an example purchase screen.

FIG. 19 illustrates an example purchase confirmation screen.

FIG. 20 illustrates an example purchase summary screen.

FIG. 21 illustrates an example fitpic recommendation screen.

FIG. 22 illustrates an example fitpic request screen.

FIGS. 23A-23C illustrate a sequence of example fitpic option screens.

FIG. 24 illustrates an example fitpic generation screen.

FIG. 25 illustrates an example fitpic modification screen.

FIG. 26 illustrates an example fitpic search screen.

FIGS. 27A-27B illustrate a sequence of example budget recommendation screens.

FIGS. 28A-28D illustrate a sequence of style recommendation screens.

FIG. 29 illustrates an example personal fitpic generation screen.

FIG. 30 illustrates an example personal style recommendation screen.

FIG. 31 illustrates an example influencer style recommendation screen.

FIGS. 32A-32B illustrate a sequence of stylist conversation screens.

FIG. 33 and FIG. 33 (Continued) illustrates an example fitpic display screen.

FIG. 34 illustrates an example fitpic prompt screen.

FIG. 35 illustrates an example stylist only screen.

FIGS. 36A-36B illustrate a sequence of example item style screens.

FIGS. 37A-37B illustrate a sequence of example guided style selection screens.

FIG. 38 illustrates an example personal style generation screen.

FIG. 39 illustrates an example style feed screen.

FIG. 40 illustrates an example style wardrobe screen.

FIG. 41 illustrates an example female-to-male style screen.

FIG. 42 illustrates an example personal stylist chat screen.

FIGS. 43A-43C illustrate a sequence of example feed interaction screens.

FIG. 44 illustrates an example item recommendation visualization screen.

FIG. 45 illustrates an example price alert screen.

FIG. 46 illustrates an example view visualization screen.

FIGS. 47A-47F illustrate a sequence of example personal wardrobe screens.

FIGS. 48A-48B illustrate a sequence of example third-party wardrobe screens.

FIGS. 49A-49B illustrate a sequence of example private wardrobe screens.

FIG. 50 illustrates an example wardrobe claiming screen.

FIG. 51 illustrates an example wardrobe claim verification screen.

FIG. 52 illustrates an example wardrobe badge request screen.

FIG. 53 illustrates an example wallet screen.

FIGS. 54A-54B illustrate a sequence of example wallet screens.

FIG. 55 illustrates an example upload screen.

FIG. 56 illustrates an example add fitpic screen.

FIG. 57 illustrates an example shoppable tag screen.

FIG. 58 illustrates an example wardrobe addition screen.

FIG. 59 illustrates an example social network screen.

FIGS. 60A-60C illustrate a sequence of example messaging screens.

FIGS. 61A-61B illustrate a sequence of example feed screens.

FIG. 62 illustrates an example inspiration exploration screen.

FIG. 63 illustrates an example social inspiration screen.

FIG. 64 illustrates an example fashion show inspiration screen.

FIG. 65 illustrates an example search navigation screen.

FIG. 66 illustrates an example style search screen.

FIG. 67 illustrates an example style search result screen.

FIG. 68 illustrates an example media feed screen.

FIG. 69 illustrates an example wardrobe feed screen.

FIG. 70 illustrates an example wardrobe profile screen.

FIG. 71 and FIG. 71 (Continued) illustrates an example wardrobe fitpic screen.

FIG. 72 illustrates an example wardrobe find screen.

FIG. 73 illustrates an example third-party wardrobe style generation screen.

FIGS. 74A-74B illustrate a sequence of example wardrobe style conversation screens.

FIG. 75 illustrates an example webpage fitpic screen.

FIG. 76 illustrates an example scheduled outfits screen.

FIG. 77 illustrates an example outfit scheduling screen.

FIG. 78 illustrates an example schedule generation screen.

FIG. 79 illustrates an example fitpic scheduling screen.

FIG. 80 illustrates an example schedule repetition screen.

FIG. 81 and FIG. 81 (Continued) illustrates an example shopping bag screen.

FIG. 82 illustrates an example history screen.

FIG. 83 illustrates an example notification screen.

FIG. 84 illustrates, in a flowchart, optimizing outfit recommendations using user feedback and constraints.

FIG. 85 illustrates a personalized outfit recommendation system with a recommender engine.

FIG. 86 illustrates, in a flowchart, operations for providing personalized outfit recommendations with visual representation and purchase links.

FIG. 87 illustrates the integration of an AI stylist recommendation system with a computing device.

FIG. 88 illustrates a process for personalized wardrobe recommendations and purchases using virtual fit pics.

FIG. 89 illustrates a personal stylist system integrating remote storage, agent, user interface, and social wardrobe feed.

### DETAILED DESCRIPTION

The disclosure provides a computer-implemented method and system for offering personalized style recommendations within a social shopping environment. The core components include a personal stylist agent, a remote storage system, a user interface, and a social wardrobe feed. The personal stylist agent may search for a wardrobe associated with a specific person, which is stored in a cloud-based remote storage system, and identify styles linked to that wardrobe. Users can request style recommendations through a user interface, which may generate virtual fit pics—digital representations of the user wearing clothing items based on identified styles. These virtual fit pics can include interactive elements, such as shoppable links, enabling users to purchase clothing items. The social wardrobe feed may allow users to follow specific wardrobes, displaying them in their content stream, and update the stream with new digital representations or clothing items as they are added by the specific person. This system and method can facilitate a seamless and interactive shopping experience, allowing users to visualize and purchase outfits while staying updated with the latest wardrobe additions.

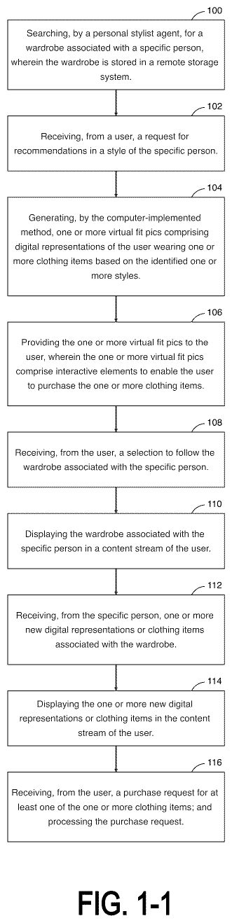

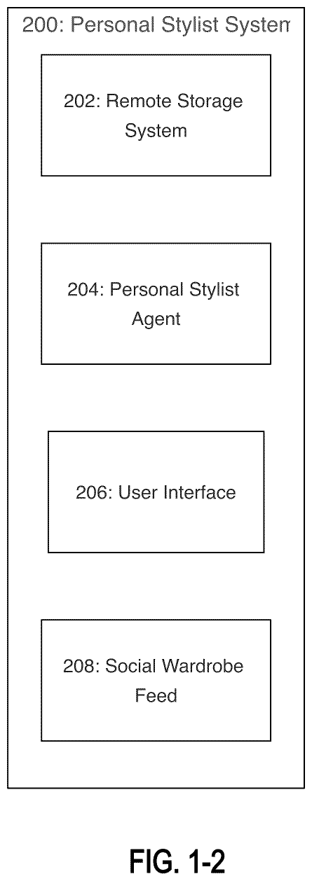

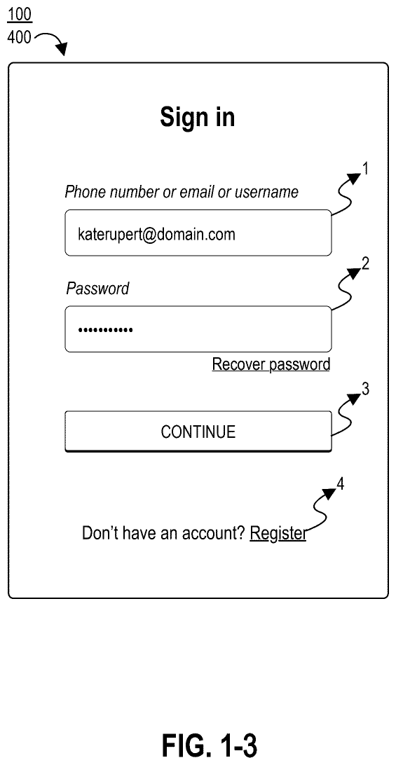

FIG. 1 is a flowchart illustrating a method in step 100 for searching for a wardrobe associated with a specific person, according to an embodiment. At step 100, the personal stylist agent may initiate a search for a wardrobe that is associated with a specific person. This wardrobe may be stored in a remote storage system, which could potentially be a cloud-based storage system. The personal stylist agent may utilize this search to identify one or more styles associated with the wardrobe, which may include styles such as classic, business casual, or elegant. The search may be conducted based on the styles that the specific person has chosen to affiliate with their wardrobe. This process may involve accessing and exploring wardrobe options and filtering these options by style. The wardrobe stored in the cloud may serve as a repository for the personal stylist agent to identify and recommend styles. The search may be facilitated by the personal stylist agent, which may be configured to efficiently locate and identify the wardrobe and its associated styles. The wardrobe's storage in a remote system may allow for seamless access and retrieval of style information, enabling the personal stylist agent to provide personalized style recommendations in a social shopping environment.

In step 102, the user interface may be designed to receive a request from a user for style recommendations associated with a specific person. This request may be facilitated through a button click, which can serve as a mechanism for the user to express interest in obtaining personalized style suggestions. The user interface may act as a conduit for this interaction, allowing the user to engage with the system in a manner that is both intuitive and efficient. The action of receiving a request for recommendations may be integral to the system's functionality, as it may initiate the process of generating tailored style advice for the user. The button click may be a component of this interaction, providing a straightforward and accessible means for the user to communicate their preferences to the system. This step may highlight the importance of user engagement in the social shopping environment, as it may set the stage for subsequent actions that aim to deliver personalized and interactive style experiences.

At step 104, the computer-implemented method may generate one or more virtual fit pics, which may comprise digital representations of the user wearing one or more clothing items based on the identified styles. The generation of these virtual fit pics may be based on the user's body measurements and the selected clothing items. This process may involve the creation of virtual pictures that can visually represent the user in various outfits, potentially enhancing the user's shopping experience by providing a more personalized and interactive approach to style recommendations. The virtual fit pics may include interactive elements, such as shoppable links, which may enable the user to purchase the clothing items directly from the virtual representation. This integration of interactive elements may facilitate a seamless transition from style visualization to purchase, thereby potentially streamlining the shopping process within the social shopping environment. The method may leverage the capabilities of the personal stylist agent to ensure that the virtual fit pics align with the user's style preferences, as identified from the wardrobe associated with a specific person. This approach may enhance the personalization of style recommendations, offering users a tailored shopping experience that reflects their unique fashion sense.

In the context of the system, the process of providing virtual fit pics to the user may involve several interconnected actions. Initially, the generation of virtual fit pics, which are digital representations of the user wearing selected clothing items, may be based on the identified styles associated with the user's preferences. These virtual fit pics may be provided to the user through a user interface, which may include interactive elements designed to facilitate the user's engagement with the clothing items. The interactive elements within the virtual fit pics may comprise shoppable links, allowing the user to explore purchasing options directly from the visual representation. This integration of interactive elements may enable the user to seamlessly transition from viewing the virtual fit pics to initiating a purchase process for the clothing items depicted. The system may leverage these interactive elements to enhance the user's shopping experience by providing a direct and intuitive pathway to purchase, thereby bridging the gap between style visualization and acquisition. The overall process may be designed to offer a personalized and engaging shopping experience, where the user can visualize potential outfits and make informed purchasing decisions based on the virtual representations provided.

At step 108, the user may choose to follow a wardrobe associated with a specific person. This action may involve the user selecting an option to receive updates related to the wardrobe of interest. The wardrobe, which may be stored in a remote storage system, could be linked to a specific person whose style the user finds appealing. By following the wardrobe, the user may gain access to a content stream that showcases the wardrobe's items. This content stream may be part of a social media feed, allowing the user to stay updated with any new digital representations or clothing items associated with the wardrobe. The process of following a wardrobe may enhance the user's engagement with the social shopping environment, providing a personalized experience tailored to their style preferences. The system may facilitate this interaction by displaying the wardrobe in the user's content stream, ensuring that any updates or new items are readily accessible. This integration of social media elements with personalized style recommendations may create a dynamic and interactive shopping experience for the user.

In the context of the system, the step of displaying the wardrobe associated with a specific person in a content stream of the user may involve several interconnected actions. The wardrobe, which may be associated with a specific person, can be displayed in the user's content stream, potentially enhancing the user's engagement with the platform. This process may involve the use of a social media feed, which can serve as the content stream for the user. The wardrobe, potentially comprising various styles and clothing items, may be showcased in this feed, allowing the user to view and interact with the wardrobe in a dynamic and engaging manner. The content stream may be designed to integrate seamlessly with the user's existing social media activities, providing a cohesive and immersive experience. The display of the wardrobe in the content stream may be facilitated by the system's ability to manage and present digital representations of the wardrobe items, potentially including images and other media. This integration may allow the user to explore the wardrobe in a visually appealing format, potentially encouraging further interaction and engagement with the platform. The system may also be capable of updating the content stream in real-time, ensuring that the user receives the most current and relevant information about the wardrobe and its associated items. This capability may enhance the user's experience by providing timely updates and maintaining the relevance of the content presented in the feed. Overall, the display of the wardrobe in the user's content stream may serve as a component of the system's functionality, potentially driving user engagement and facilitating a more personalized and interactive shopping experience.

At step 112, the system may receive new digital representations or clothing items from a specific person, which may be associated with their wardrobe. This process may involve the specific person providing new fitpics or other digital representations that reflect updates to their wardrobe. These new digital representations may be stored and managed within the system, potentially involving the use of cloud-based storage solutions to ensure accessibility and integration with the existing wardrobe data. The system may then process these new inputs to update the wardrobe's digital presence, ensuring that the latest styles and items are accurately reflected.

The new digital representations, which may include fitpics, can be integrated into the content stream of users who follow the specific person's wardrobe. This integration may involve displaying the new items in a social media-like feed, allowing users to view and interact with the latest updates in real-time. The system may facilitate this by leveraging interactive elements within the digital representations, such as shoppable links, which may enable users to explore and potentially purchase the new clothing items directly from the feed.

The process of receiving and displaying new digital representations may be designed to enhance user engagement by providing a dynamic and interactive shopping experience. By allowing users to follow specific wardrobes and receive updates in their content stream, the system may create a personalized and socially-driven shopping environment. This approach may encourage users to explore new styles and make informed purchasing decisions based on the latest fashion trends and updates from the wardrobes they follow.

At step 114, the process may involve displaying one or more new digital representations or clothing items in the content stream of the user. This step may be part of a broader system designed to provide personalized style recommendations within a social shopping environment. The content stream, which may be a social media feed, can serve as a platform where users may view updates related to wardrobes they follow. The new digital representations or clothing items, potentially including fitpics, may be displayed in real-time, allowing users to stay updated with the latest additions to the wardrobes they are interested in. This real-time display may enhance user engagement by providing immediate access to new styles and clothing items. The system may utilize a personal stylist agent to manage and update the content stream, ensuring that the user receives the most current information. The integration of these elements may facilitate a dynamic and interactive shopping experience, where users can explore and potentially purchase new clothing items directly from their content stream.

At step 116, a purchase request for at least one of the clothing items may be received from the user, and the processing of this purchase request may be initiated. The user may interact with the system to express interest in acquiring specific clothing items, which may have been previously recommended or visualized through virtual fit pics. The system may facilitate this process by providing a seamless interface for the user to make selections and proceed with the purchase. The processing of the purchase request may involve verifying the availability of the selected items, confirming the user's payment details, and ensuring the transaction is completed successfully. This step may be crucial in transitioning from the recommendation phase to the actual acquisition of clothing items, thereby enhancing the user's shopping experience within the social shopping environment. The system may also ensure that the user's preferences and previous interactions are taken into account to streamline the purchase process, potentially offering personalized suggestions or alternatives if the initially selected items are unavailable.

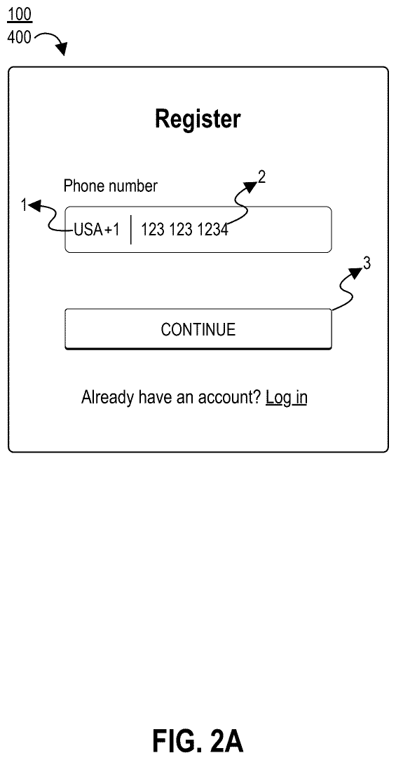

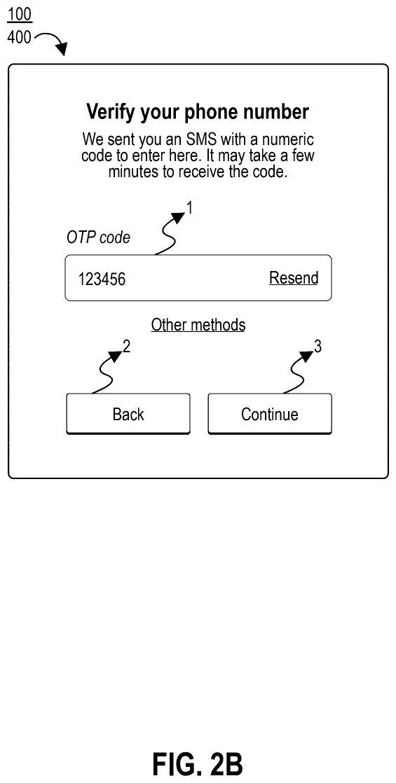

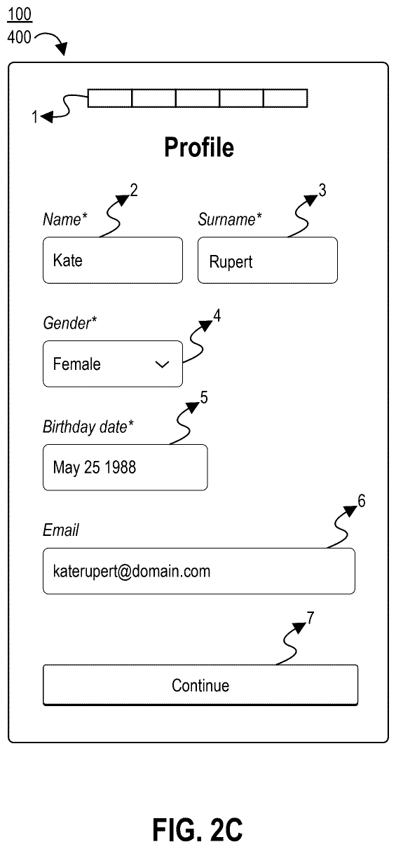

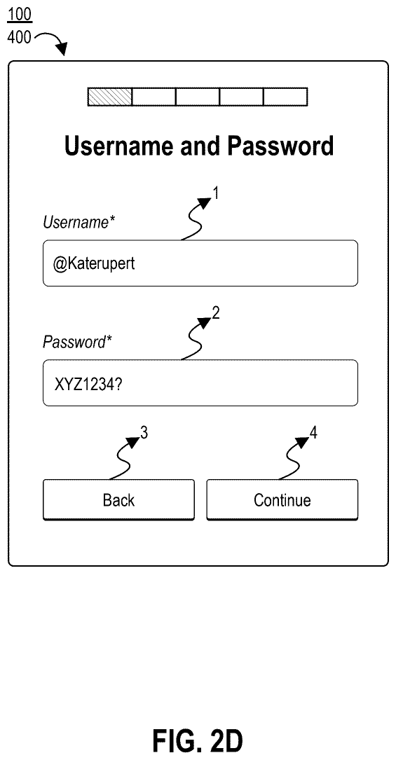

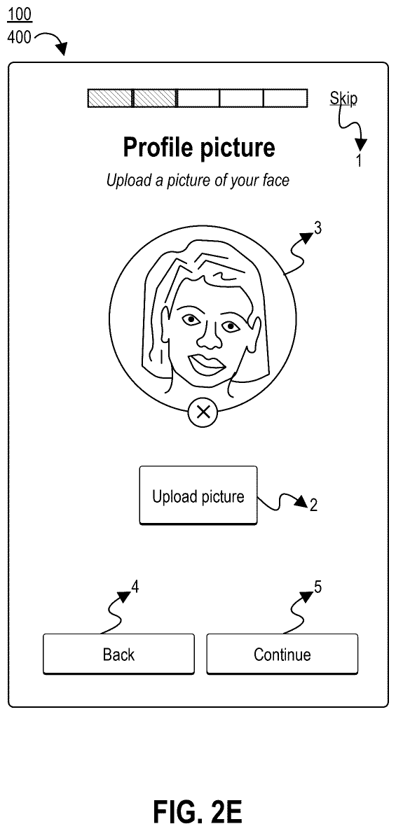

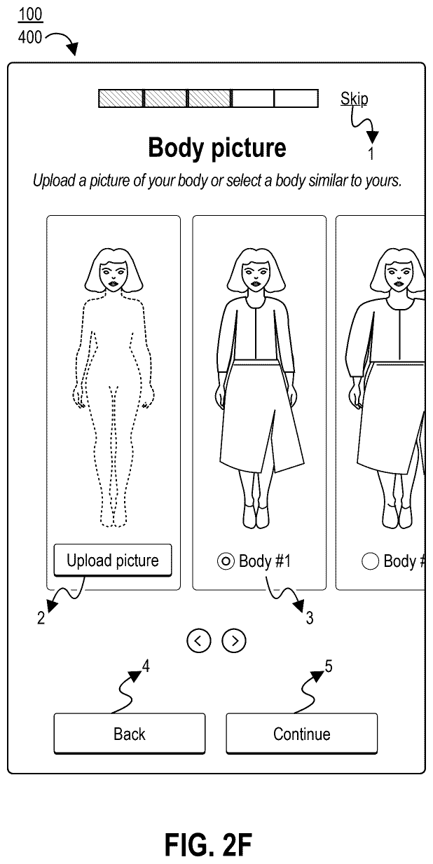

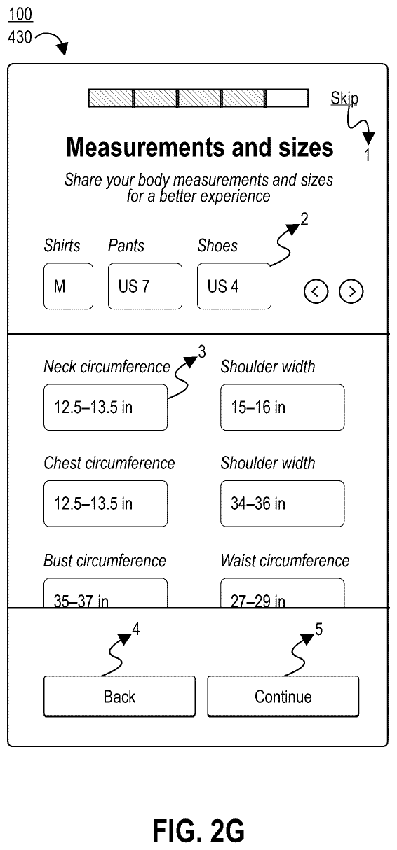

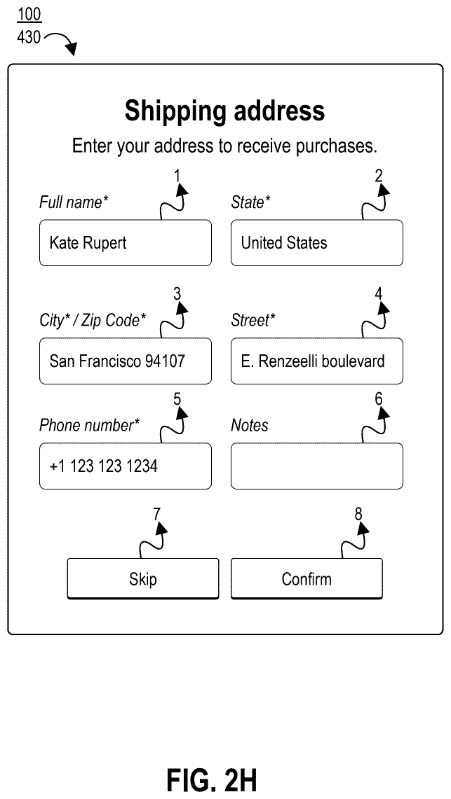

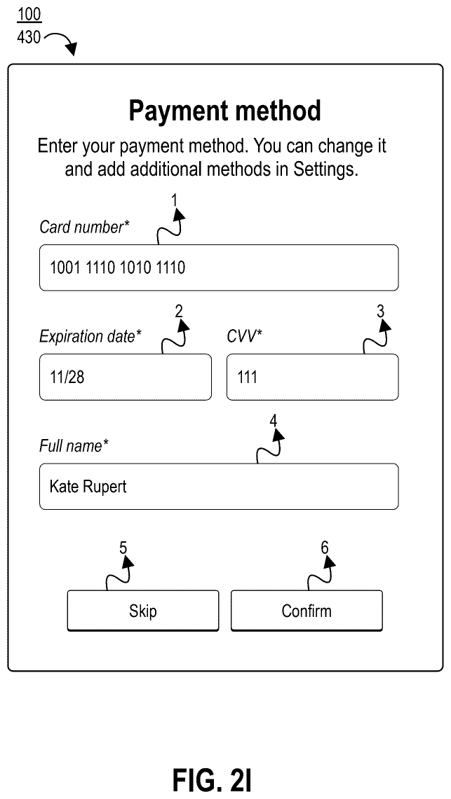

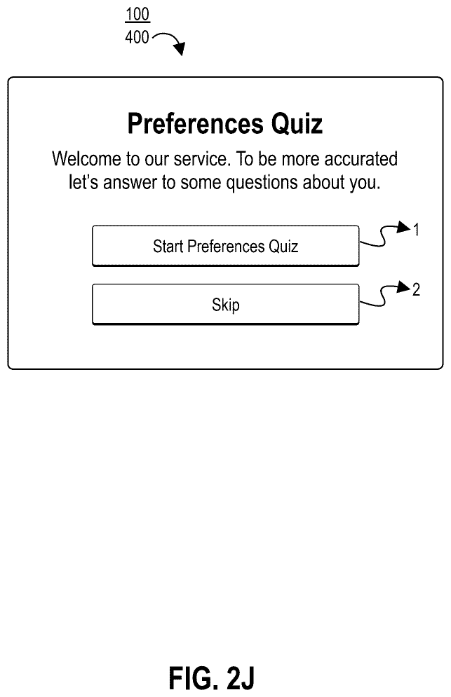

FIG. 2 illustrates the Remote Storage System, which may be a component in the social shopping environment. The Remote Storage System 202 may store wardrobes in a cloud-based system, allowing for efficient and scalable storage solutions. This system may facilitate the storing of wardrobe data, enabling the personal stylist agent to search for a wardrobe associated with a specific person. The wardrobe data may be accessed and explored for style recommendations, which may be filtered by style, such as classic, business casual, or elegant. The Remote Storage System 202 may work in conjunction with other components, such as the Personal Stylist Agent and the User Interface, to provide a seamless user experience. The Personal Stylist Agent may search for wardrobes stored in the cloud and identify styles associated with those wardrobes. The User Interface may receive user requests for style recommendations and process purchase requests. The Social Wardrobe Feed may display wardrobes and updates in the user's content stream, providing real-time updates of new digital representations or clothing items. The integration of these components may enable the generation of virtual fit pics, which may include shoppable links, allowing users to visualize outfits and make purchases directly. The Remote Storage System 202 may play a role in ensuring that the wardrobe data is readily available for these processes, supporting the overall functionality of the social shopping environment.

The Personal Stylist Agent component 204 may be responsible for searching and identifying styles from wardrobes stored in a cloud-based system. This component may function by accessing the wardrobe data associated with a specific person and filtering wardrobe options by style, such as classic, business casual, or elegant. The Personal Stylist Agent may utilize a style identification sub-component to perform this task, which may involve analyzing the stored wardrobe data to identify the styles that align with the user's preferences or requests.

The Personal Stylist Agent may also interact with the user interface to receive user input for style recommendations. This interaction may be initiated by a button click, which may trigger the agent to search for wardrobe options based on the specified styles. The agent may then generate virtual fit pics, which are digital representations of the user wearing selected clothing items. These virtual fit pics may include shoppable links, allowing the user to visualize outfits and make purchases directly from the images.

Additionally, the Personal Stylist Agent may contribute to the social wardrobe feed by updating the user's content stream with new digital representations or clothing items associated with the followed wardrobes. This process may involve receiving updates from the specific person who owns the wardrobe and displaying these updates in real-time within the user's feed. The agent's ability to search, identify, and update styles may enhance the personalized shopping experience by providing tailored recommendations and facilitating seamless interactions within the social shopping environment.

The user interface component 206 may serve as an element in the system, facilitating the interaction between the user and the personalized style recommendation process. This component may be responsible for receiving user requests, such as when a user may click a button to request style recommendations in the style of a specific person. The user interface may also process purchase requests, enabling users to engage with the system seamlessly. The subcomponent, Virtual Fit Pics, may generate virtual fit pics that include shoppable links, allowing users to visualize themselves in various outfits and potentially make purchases directly through the interface. The user interface may thus act as a conduit for delivering style recommendations to the user by creating a visual representation of the style through these virtual fit pics. The actions associated with the user interface may include receiving user input for style recommendations and facilitating the visualization of outfits, which may be crucial for enabling users to explore and purchase clothing items based on their preferences. The integration of these functionalities within the user interface component 206 may enhance the overall user experience by providing a streamlined and interactive platform for personalized style exploration and shopping.

The Social Wardrobe Feed component 208 may display wardrobes and updates in the user's content stream. This component may include a Real-time Display sub-component, which may display new digital representations in real-time. The content stream may be associated with a specific person and may showcase the wardrobe in the user's feed. The feed may receive updates with new wardrobe items, which may include new digital representations or clothing items. These updates may be displayed in the content stream, allowing users to follow wardrobes and receive updates in their feed. The Social Wardrobe Feed component 208 may facilitate the continuous engagement of users with the wardrobe content, enhancing the social shopping experience by providing real-time updates and interactive elements. The component may integrate seamlessly with other system components, such as the Personal Stylist Agent and User Interface, to ensure a cohesive and personalized user experience.

The drawings show the processes by which the user can interact with a generic search for a shopping prompt field, or select a more specialized assistant to have a different shopping experience. The user can ask to a virtual AI assistant (Personal Stylist) to generate outfits, images of a generic model or the user's realistic avatar wearing the recommended items in a picture (Fitpics) through a specific button in the profiles of other users (or also called Wardrobe) or options in the prompt field to be selected or guided paths with the compilation of fields or through a direct text request written by the user (Tagging the profile of a user whose style you want to replicate). Wardrobe is a profile where the user collects personal items and uploaded or AI generated fitpics. Personal Stylist is able to generate fitpics and recommend to the user the related items to purchase to create the exact outfit. Personal Stylist is able to generate fitpics with the items that the user already has added in wardrobe (Items that the user does not have to purchase but already owns).

The system shows some guided path or gadget as simplified paths to complete an action. One of the guided paths will be a way to easily generate an outfit in the style of someone.

Prompt field is the field where the user can select options (attach images, select a profile whose style the user wants to replicate), select a type of AI model (to generate fitpics or a more basic model that only recommends items without generating images), write more or less specific requests, click on the ‘Send’ button to send the request or response to the assistant. In the case that the user's prompt is not complete, the Personal Stylist could start to ask for some more info about the occasion, date and time and location, budget, etc. (Little questionnaire). In that description the word ‘System’, referring to the service and technology that makes it possible, could be replaced with ‘PersonalX’ or with a name of the assistant that is specialized to offer some specific features or recommendations.

System is a AI technology that includes all offered assistants (sometimes named ‘Agent’ or ‘Services’) In case a user wants to replicate another user's style but with a different gender, the Personal Stylist will be able to adjust that style to the user's gender. Personal Stylist will ask to choose one of this option: 1. Masculine clothing in the style of [User name and Surname or @username] for you, with your size and other preferences, 2. Feminine clothing in the style of [User name and Surname or @username] for you, with your size and other preferences), 3. Masculine clothing in the style of [User name and Surname or @username] for someone else).

Example: If the main user is male and wants to replicate a female person's style, the assistant will be able to adjust that style to the male gender. In case the user wants exactly that style but with female clothes, he/she can request it from the assistant. Personal Stylist is also able to adjust a certain style based on specific budgets, primary user's age, availability of items and more.

Users can use the service without registering or logging in. However, it may be required in certain contexts or to complete certain actions. The registration of an account is essential to share with the service information such as personal shipping addresses or payment methods, as well as to share personal preferences such as brands, colors, sizes, etc.

FIG. 1-3 The figure describes the process through which the user logs into his account. The user can login to the service through phone number or email or username. Descriptions of arrows: (1) The user enters the account email. (2) The user enters the password (3) The user clicks the button ‘Continue’ to proceed and access. (4) The user doesn't have an account and clicks on the button ‘Register’.

FIG. 2A The figure describes the process through which the user registers an account. Descriptions of arrows: (1) The user selects the Country and related prefix. (2) The user enters the phone number. (3) The user clicks the button ‘Continue’ to proceed.

FIG. 2B The figure describes the process through which the user verifies the phone number entering the numeric code received via text message (SMS). Descriptions of arrows: (1) The user enters the received OTP code (2) The user clicks the button ‘Back’ to return to the previous page. (3) The user clicks the button ‘Continue’ to proceed.

FIG. 2C The figure describes the process through which the user creates his general profile. Fields marked with an asterisk are mandatory. Descriptions of arrows: (1) The user enters his name and (3) his surname. (4) The user selects the gender ‘Female’. (5) The user enters the birthday date. (6) The user enters the email. (7) The user clicks the button ‘Continue’ to proceed.

FIG. 2D The figure describes the process through which the user chooses his username and password. Fields marked with an asterisk are mandatory. Descriptions of arrows: (1) The user enters a username. The username must be unique with no special symbols and not yet used on the platform. (2) The user enters a password. (3) The user clicks the button ‘Back’ to return to the previous page. (4) The user clicks the button ‘Continue’ to proceed.

FIG. 2E The figure describes the process through which the user uploads his face picture. Uploading the personal face picture the user makes it possible for the platform to generate images that have the person's face, in a sort of realistic personal avatar. Filling in is not mandatory and the user can skip. Descriptions of arrows: (1) The user clicks the button ‘Skip’ to skip to the next page. (2) The user clicks the button ‘Upload picture’ to upload a picture of his face. (3) The user uploaded a picture of his face. (4) The user clicks the button ‘Back’ to return to the previous page. (5) The user clicks the button ‘Continue’ to proceed.

FIG. 2F The figure describes the process through which the user uploads his body picture or chooses one of the model images that best represents his body, without having to upload any personal images. Uploading the personal body picture or choosing a body-model, the user makes it possible for the platform to generate images that have the person's face and body, in a sort of realistic personal avatar. Filling in is not mandatory and the user can skip. Descriptions of arrows: (1) The user clicks the button ‘Skip’ to skip to the next page. (2) The user clicks the button ‘Upload picture’ to upload a picture of his body. (3) The user instead of uploading a picture of his body selects a body-model trying to select the body that matches with his personal real body. (4) The user clicks the button ‘Back’ to return to the previous page. (5) The user clicks the button ‘Continue’ to proceed.

FIG. 2G The figure describes the process through which the user enters his body measurements and sizes (Shirts sizes, shoes, sizes, etc.). Uploading the personal measurements and sizes, the user makes it possible for the platform to generate a more realistic personal avatar and recommend items perfect for the user in terms of sizes. The information is not public but is shared with the platform—the user can manage their measurements and sizes in the settings of their account. Filling in is not mandatory and the user can skip. Descriptions of arrows: (1) The user clicks the button ‘Skip’ to skip to the next page. (2) The user enters personal sizes. (3) The user enters personal body measurements. (4) The user clicks the button ‘Back’ to return to the previous page. (5) The user clicks the button ‘Continue’ to proceed.

FIG. 2H The figure describes the process through which the user enters the shipping address. Filling in is not mandatory and the user can skip. Descriptions of arrows: (1) The user enters his full name, (2) State, (3) City and zip code, (4) Street, (5) phone number and (6) notes. (7) The user clicks the button ‘Skip’ to skip to the next page (8) The user clicks the button ‘Confirm’ to proceed.

FIG. 2I The figure describes the process through which the user enters the payment method. Filling in is not mandatory and the user can skip. Descriptions of arrows: (1) The user enters his card number, (2) expiration date, (3) CVV security code number, (4) full name. (5) The user clicks the button ‘Skip’ to skip to the next page (6) The user clicks the button ‘Confirm’ to proceed.

FIG. 2J The figure describes the process through which the system asks to proceed with Preferences Quiz, a questionnaire to share personal preferences answering questions. Filling in is not mandatory and the user can skip. Descriptions of arrows: (1) The user clicks the button ‘Start Preferences Quiz’ to start the questionnaire. (2) The user clicks the ‘Skip’ button to skip it.

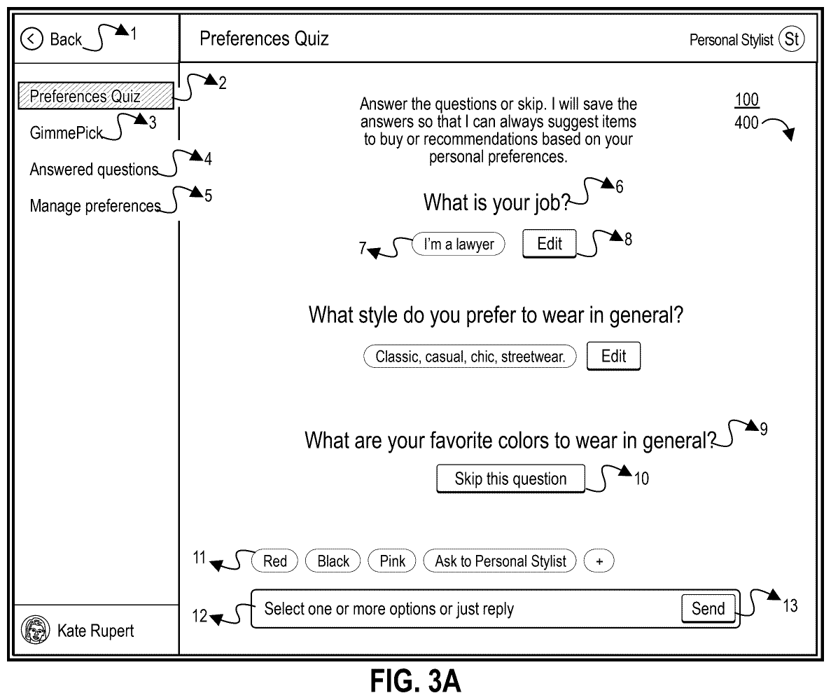

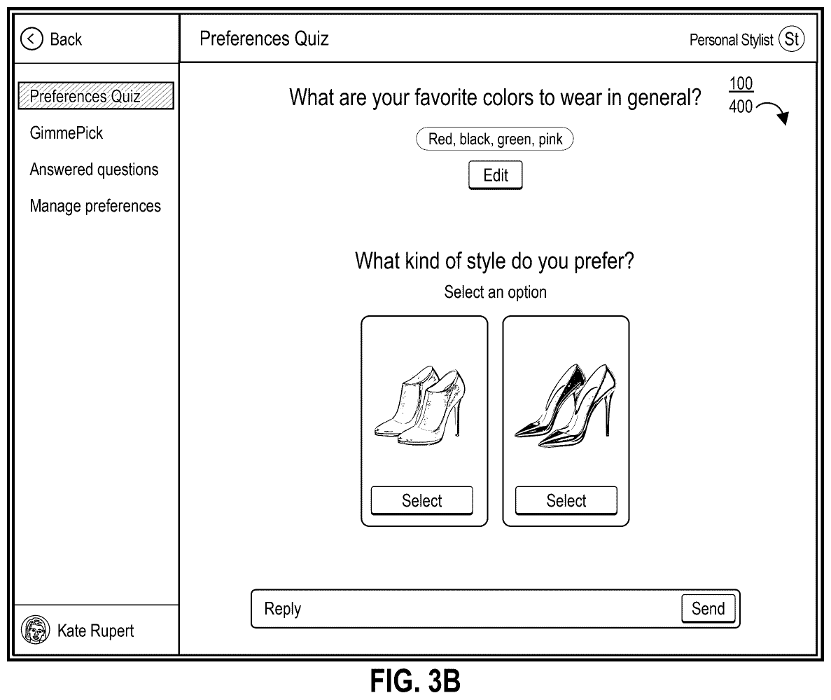

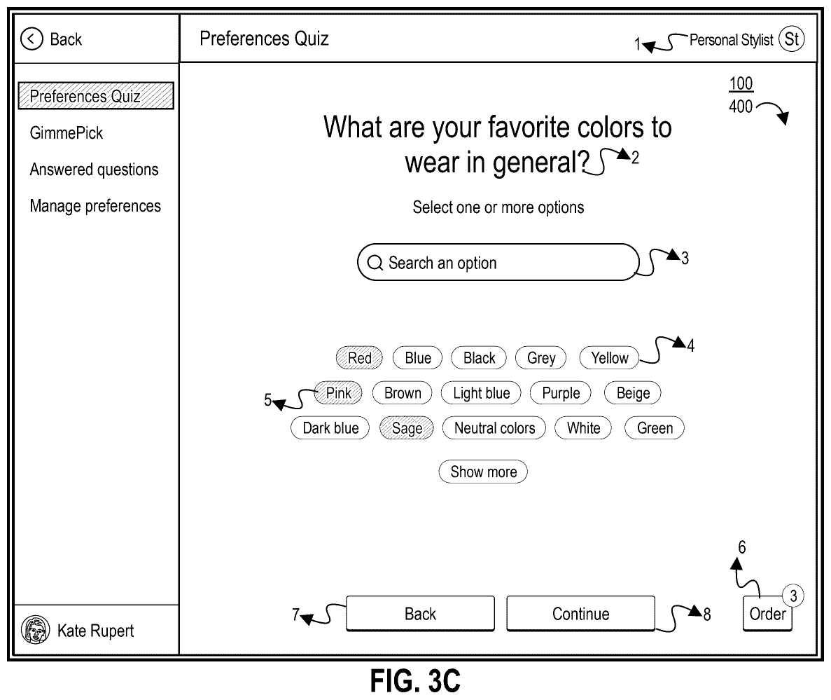

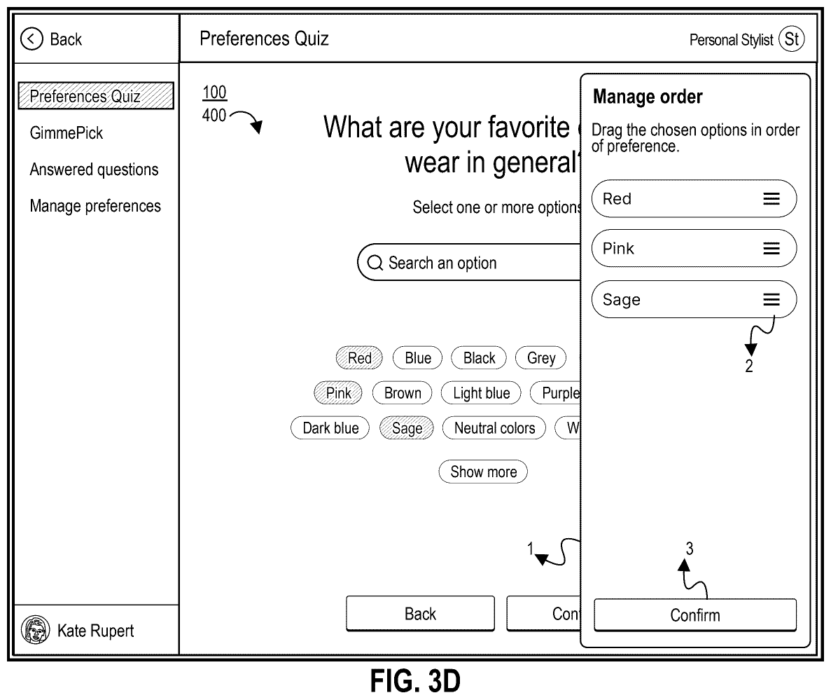

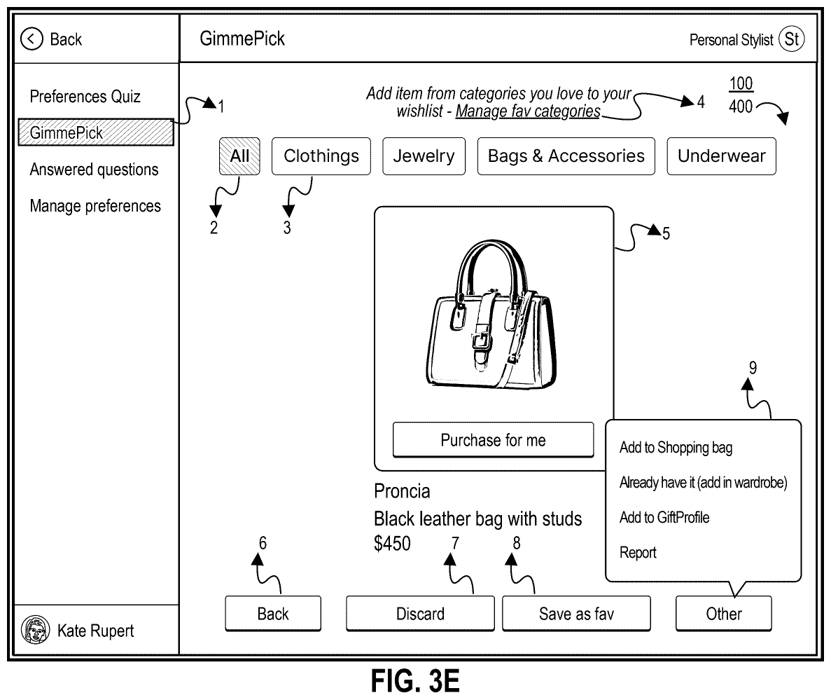

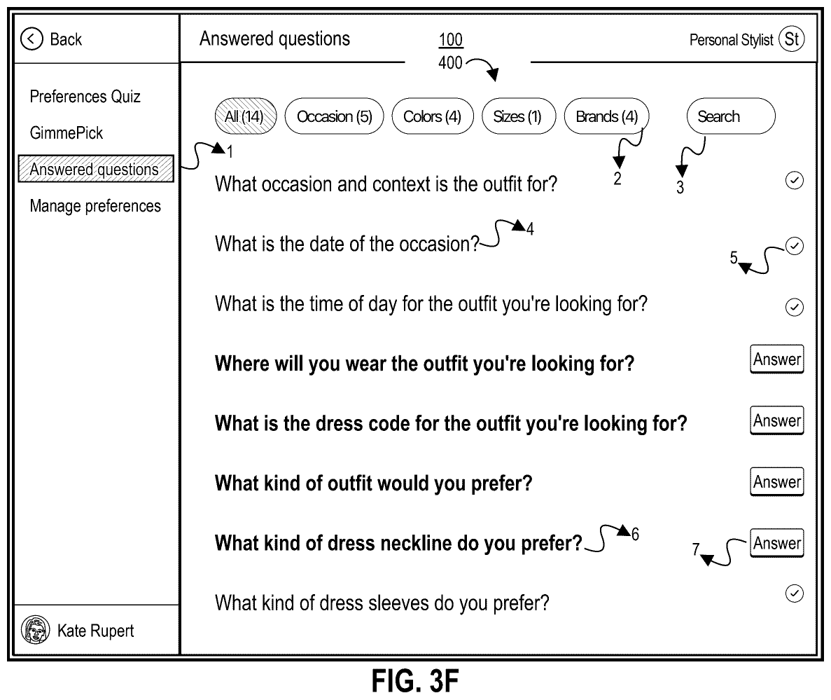

FIG. 3A The user clicks on the sidebar to the left of the screen the button ‘Preferences Quiz’ to access the questionnaire about personal preferences. Descriptions of arrows: (1) The user can click on the button ‘Back’ to return to the homepage. (2) The user selected the option ‘Preferences Quiz’ as type of Quiz. There will be questions to answer typing in the prompt field the answer or just filling some requests or just selecting options. Other options related to Preferences Quiz will be in the side bar when the user selects preferences Quiz from the homepage and will be: (3) GimmePick, (4) Answered questions, (5) Manage preferences. (6) The system shows in the central area of the screen the flux of all answered questions, (7) the answer by the user and (8) a button ‘Edit’ to edit the answer. The Preferences QUiz is an infinite flux of questions to answer (9) the system shows to collect data by the user and use that data to generate best answers and personalized shopping or visual recommendations. (10) The user clicks the button ‘Skip this question’ to skip questions. Some questions may be asked again at some point in time. Skipped questions will be asked again at some point in time. (11) The system shows some possible options that the user can click to accelerate the communication avoiding typing something. The selected option could be added in the prompt field and then the user can proceed to ‘Send’ it. Suggested options are text that will be added in the prompt field. (12) The user is totally free to answer the questions by typing in the prompt field and (13) clicking on the ‘Send’ button to send the answer.

FIG. 3B The system shows as options to select some pictures. The system asks ‘What kind of style do you prefer?’ and the user can choose an option.

FIG. 3C The system shows some options to be selected to continue the quiz. Descriptions of arrows: (1) The user can select the type of assistant (or argument) for the Preferences Quiz on the top nav bar. In that figure the user selected ‘Personal Stylist’ to only see questions related to the fashion category-argument. (2) The system shows the question ‘What are your favorite colors to wear in general?’. (3) The user can search for an option. (4) The system shows some possible options to select. (5) The user selects an option. (6) The user can click the button ‘Order’ to manage the selected options in a preferred order. (7) The user clicks the button ‘Back’ to return to the previous question or just scrolls the page. (8) The user clicks the button ‘Continue’ to proceed to the next question.

FIG. 3D The system shows the panel to organize the selected options in a preferred order. The user just moves up and down the options organizing the list in the order of preference. Descriptions of arrows: (1) The system shows the panel ‘Manage order’. (2) The user drag the option ‘Sage’ in the bottom as the last answer. The original order was by selection. Now the user has manually arranged the list. (3) The user clicks the button ‘Confirm’ to close the panel and continue the quiz.

FIG. 3E The figure describes the process through which the user accesses the feature GimmePick, to visualize items and discard them or Save as favorite. The system will show items to better understand the user's preferences and collect new data. The system could recommend the item saved as favorite through GimmePick as recommendations. Descriptions of arrows: (1) The user selects the option ‘GimmePick’ on the sidebar to the left. (2) The user selects the category ‘All’ to show all types of items. (3) The user can select the category ‘Clothings’ as a filter to only see items of that category. (4) These options are the user’ favorite categories, but the user can manage them by clicking on the button ‘Manage fav categories’. (5) The system shows the item with the item picture, a button ‘Purchase for me’ so the user can click and instantly purchase the item, the brand name, item name and the current price. (6) The user clicks the button ‘Back’ to return to the previous item, (7) the button ‘Discard’ to discard the item. In this case the system understands that the user does not like that item and will avoid recommending it in the future. (8) The user clicks the button ‘Save as fav’ to save the item in the saved content list (Saved page in the personal Wardrobe). (9) The user clicks the button ‘Other’ to see more options like ‘Add the item to shopping bag’, ‘Already have that item’ (Clicking here the user can also add it in personal wardrobe), ‘Add to GiftProfile’, ‘Report’.

FIG. 3F The figure describes the process through which the user accesses the page to see the list of Answered questions and the next questions. Descriptions of arrows: (1) The user clicks the button ‘Answered question’ on the sidebar to the left. (2) The user clicks some filters on the top. (3) The user search filters. (4) The system shows answered questions with (5) a check symbol, (6) and questions not answered yet (7) with a button ‘Answer’ to answer it.

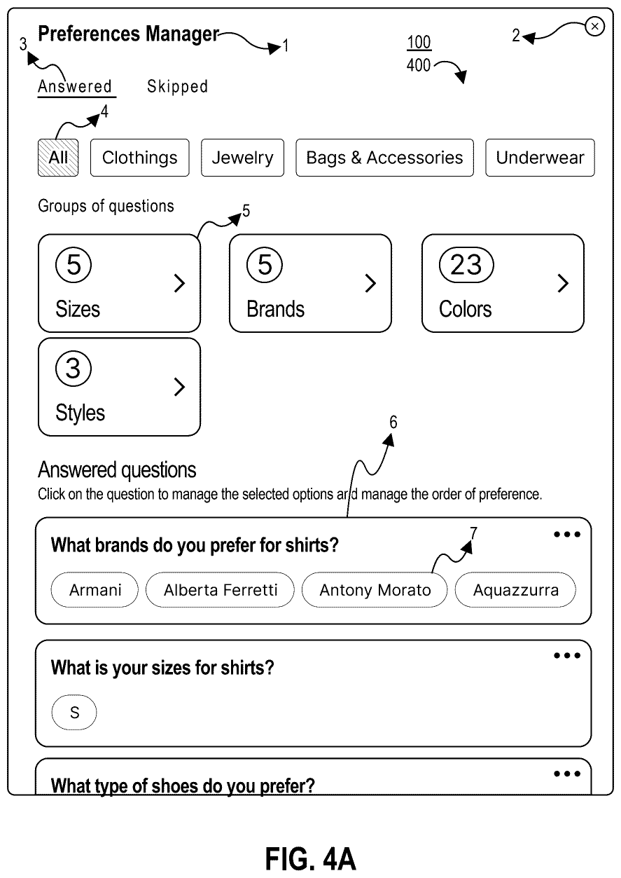

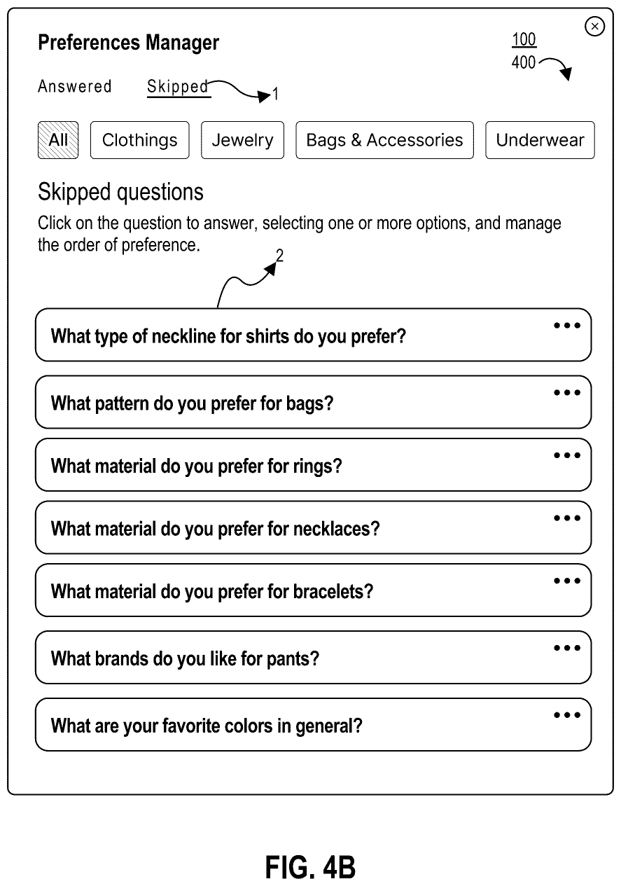

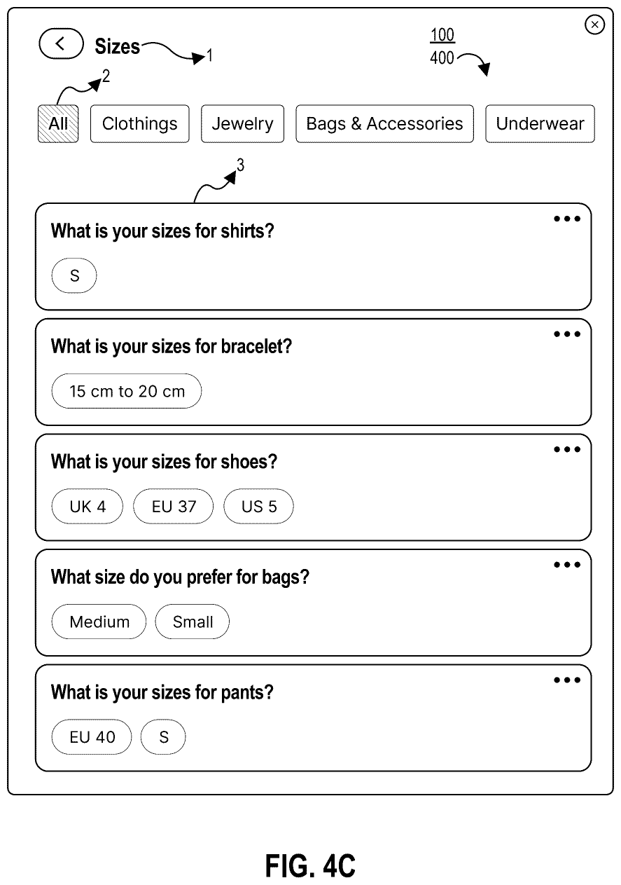

FIG. 4A The figure describes the process through which the user accesses the page to manage personal preferences in a more extended version. Descriptions of arrows: (1) The user selects the ‘Preferences Manager’ page to manage all preferences she shared in the preferences quiz or during a process of outfit creation. (2) The user selects the ‘Close’ button to close the process and return to the homepage. (3) The user selects the section ‘Answered’ to see the list of all answers. Some filters appear on the top of the page. (4) The user selects ‘All’ to see the total list. (5) There are some groups of questions, like ‘Sizes’ with the number of questions related to the sizes, ‘Brands, ‘Colors’, and ‘Styles’. They work like folders where inside there are related answered questions. The system shows the list of answered questions. (6) The first of this list is ‘What brands do you prefer for shirts?’ (7) with related selected options (like Armani, Alberta Ferretti, etc . . . ).

FIG. 4B The figure describes the process through which the user accesses the page to manage skipped questions. Descriptions of arrows: (1) The user selects the page ‘Skipped’ to have the list of all questions she skipped and so that not have an answer. (2) The system shows the list of all questions that don't have an answer. It could be filtered with some button-filter on the top of the page, they are some categories.

FIG. 4C The figure describes the process through which the user selects a group of questions (Sizes questions) to visualize related questions. Descriptions of arrows: (1) The user selects from the page Preferences Quiz page the group of questions related to the ‘Sizes’ that have inside all questions about sizes of everything. The user clicks the button ‘Back’ to return to the previous page. Some filters appear on the top of the page. The user selects ‘All’ to see the total list. (3) The system shows in a list all questions he answered about sizes like ‘What is your sizes for shirts?’ selecting the option ‘S’. When the system already has an answer for a question it will be able to consider that info also for the next processes, so it will not be asked again in future, however here the user is able to edit or delete it.

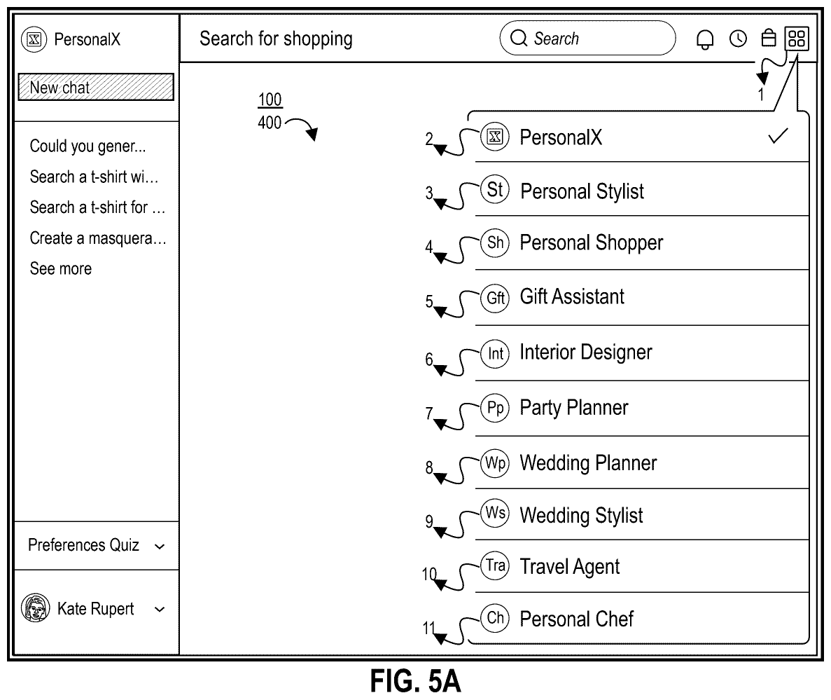

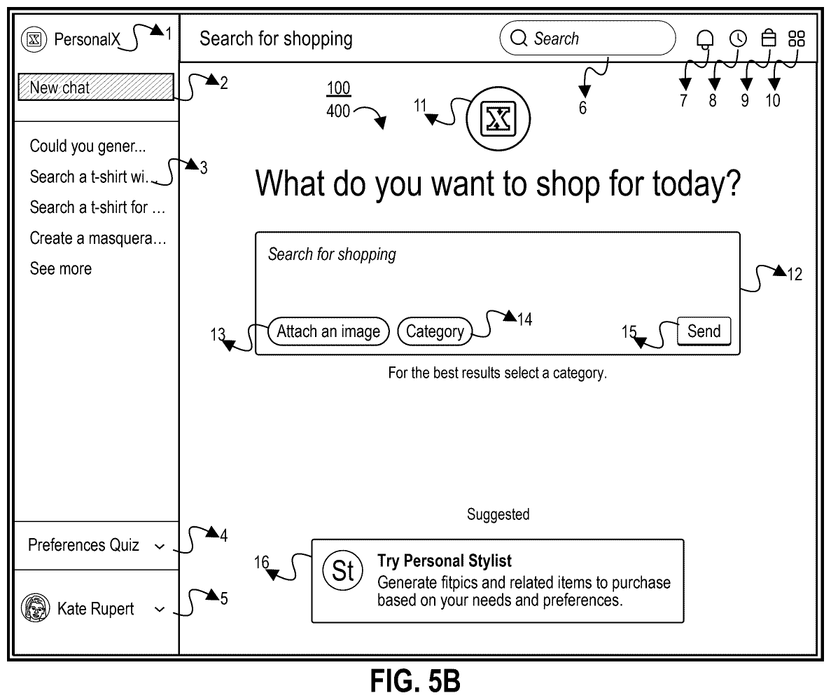

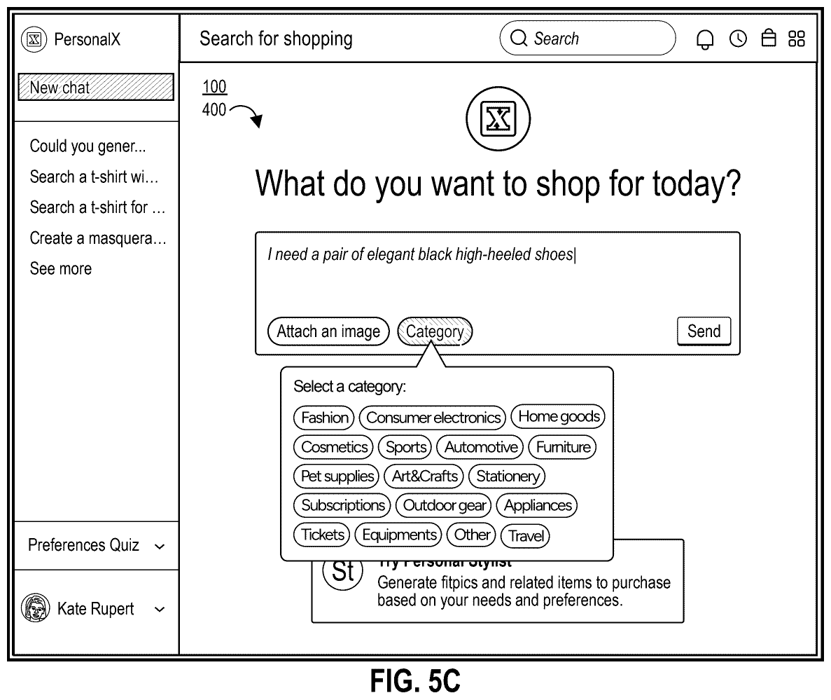

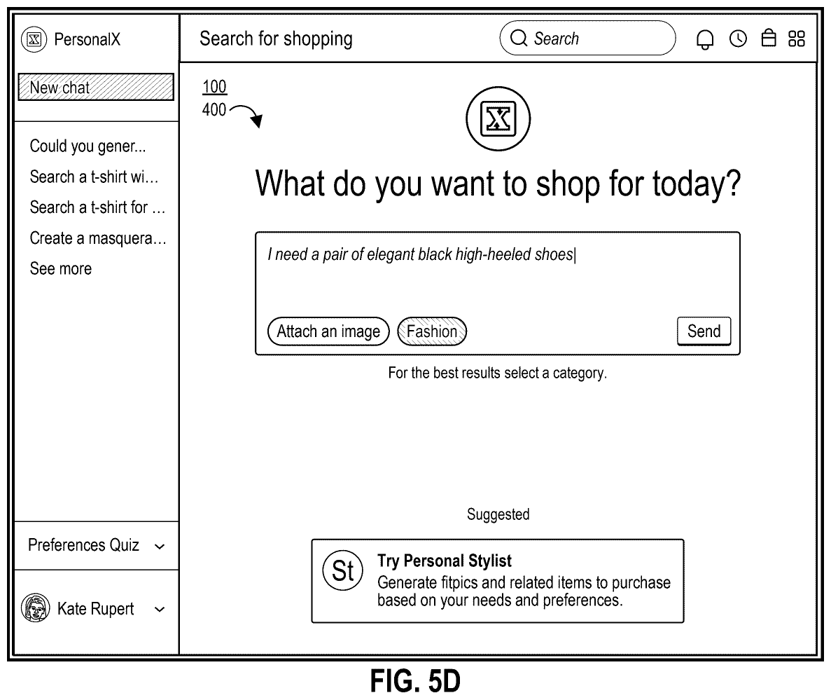

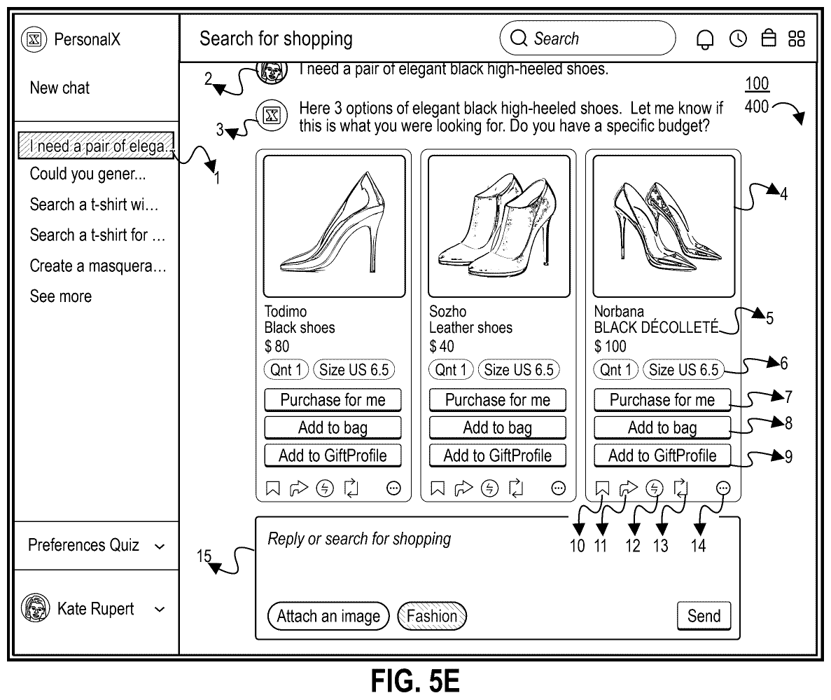

FIG. 5A The figure describes the process through which the user accesses the homepage and selects the main search-for-shopping service or a specific assistant. Descriptions of arrows: (1) The user clicks the button ‘List of assistants’ on the nav bar to the top. (2) The user selects the option ‘PersonalX’ to access the general page to search for shopping. The user can also choose specific assistants related to some specific category (Fashion, food, travels, etc.) to receive more specific and curated recommendations, like (3) Personal Stylist, (4) Personal Shopper, (5) Gift Assistant, (6) Interior Designer, (7) Party Planner, (8) Wedding Planner, (9) Wedding Stylist, (10) Travel Agent, (11) Personal Chef. These assistants will be able to ask the user questions to better find a specific result and based on the user preferences. Selecting an assistant gives the user access to some specific features related to the category. Example: The user selects the Personal Stylist, some related features will appear on the sidebar to the left (Wardrobe, Feed, Inspiration, . . . ). Similar for the other assistants.

FIG. 5B The figure describes the process through which the user accesses the homepage and selects the ‘PersonalX’ option. Descriptions of arrows: (1) The user chooses ‘PersonalX’ option and the logo will appear in the sidebar. (2) The system automatically selects the first option ‘New chat’ to show the user the prompt field and start a new search for shopping. (3) A list of previous searches (prompts) will appear in the sidebar as shortcuts. (4) The user can continue to answer questions by clicking the button ‘Preferences Quiz’. (5) The user can access other options related to his account. (6) The user can search for previous searches or assistants chats. (7) The system shows the ‘Notifications’ button, (8) the ‘History’ button to see the list of previous searches, (9) ‘Shopping bag’, (10) ‘List of Assistants’. (11) The logo of selected assistant appears in the central area with (12) the prompt field (also named chat field) as the space where the user can type a prompt to interact with the system. (13) The user can attach an image in the prompt field, (14) select a category for a more accurate search. (15) The user clicks the button ‘Send’ to send the prompt to the system and start the search or the chat. (16) The system displays a suggested option ‘Try Personal Stylist’. Clicking the user will be directed to the Personal Stylist assistant and related features.

FIG. 5C The figure shows how the user clicks the ‘Category’ button to select a category for a more accurate search and experience.

FIG. 5D The figure shows the category ‘fashion’ selected by the user. The user is asking ‘I need a pair of elegant black high-heeled shoes’. FIG. 5E The figure describing the process through the system shows the chat, after the user has typed a prompt on the homepage and clicked the button ‘Send’. Descriptions of arrows: (1) The system automatically creates a new chat in history and shows a preview in the sidebar on the left with a preview of the prompt. (2) The system shows the user's prompt. (3) The system shows the result generating 3 options (as default the system shows 3 options, but the user can choose more than one) of items as recommendations to purchase. The systems can ask more questions to better recommend items: that questions can include: ‘What is the budget?’, ‘What brands do you prefer?’, ‘Which options do you prefer: best price, best quality or both?’, ‘Do you have any other specific requests?’, and similar questions related to the type of the item (style, brand, accessories included, etc.), a specific characteristic of the item (color, model, size, quantity, shape, etc.), context or type of use (occasion, location, date of occasion, specific context of use, etc.). (4) The system shows a list of possible items to purchase related to the user request and answers. The system shows the item picture, (5) brand name, item name, price of selected seller (The system shows the current best price available online), (6) Available seller options that the system automatically choose for the user, but the user is able to manage if available on the selected seller (Quantity to purchase, size, color, model, etc). (7) The system shows some buttons like ‘Purchase for me’ for the instant purchase of the item, (8) ‘Add to shopping bag’ to add the item in the shopping bag and continue the purchase through that feature, (9) ‘Add to Giftprofile’ to add the item in the personal Giftprofile, a sort of personal public wishlist where other users can purchase gifts for that user. (10) The system shows other buttons under each item like ‘Save’ to save the item as favorite, (11) ‘Share’, (12) ‘Generate a similar option’, (13) ‘Generate a different option’, (14) ‘Other options. (15) The user can continue the chat just typing a new request in the prompt field.

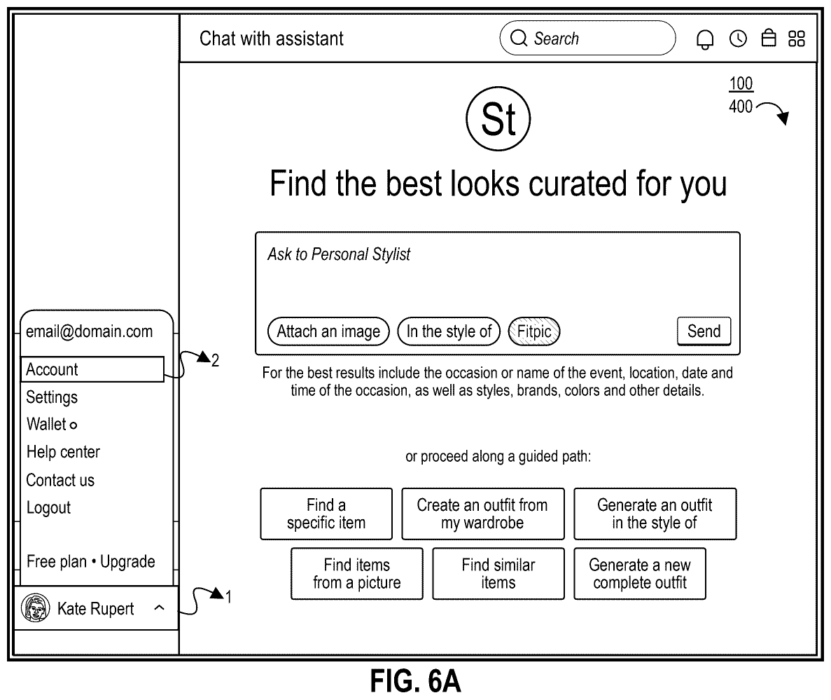

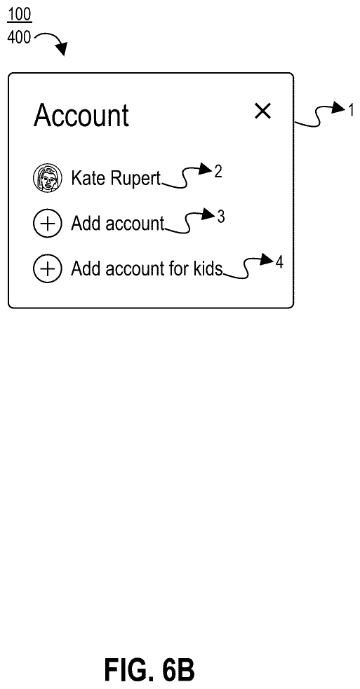

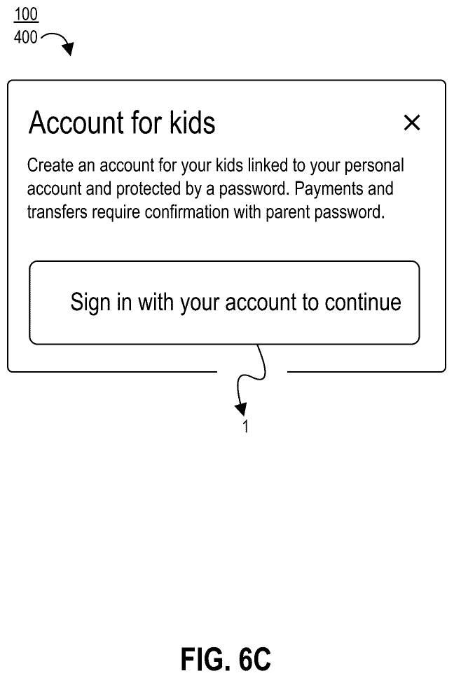

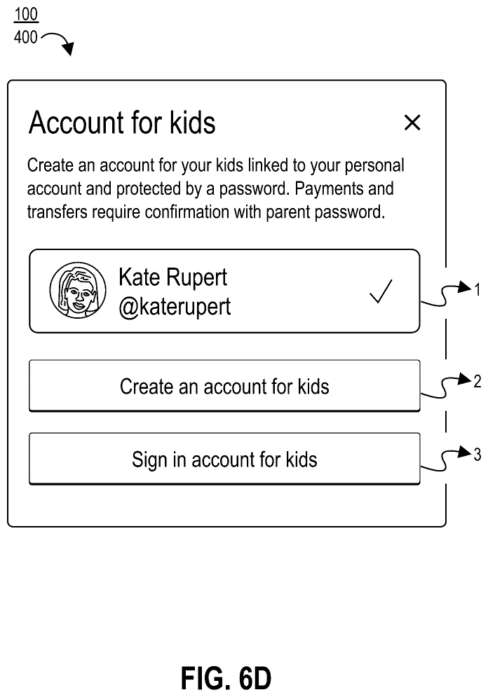

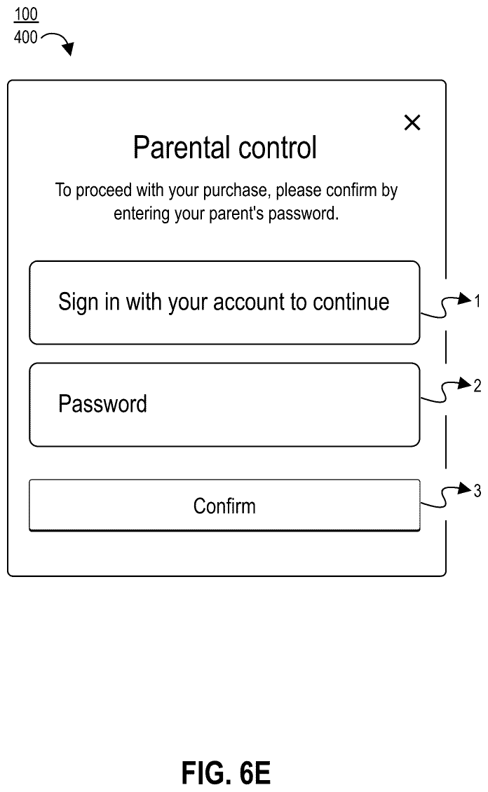

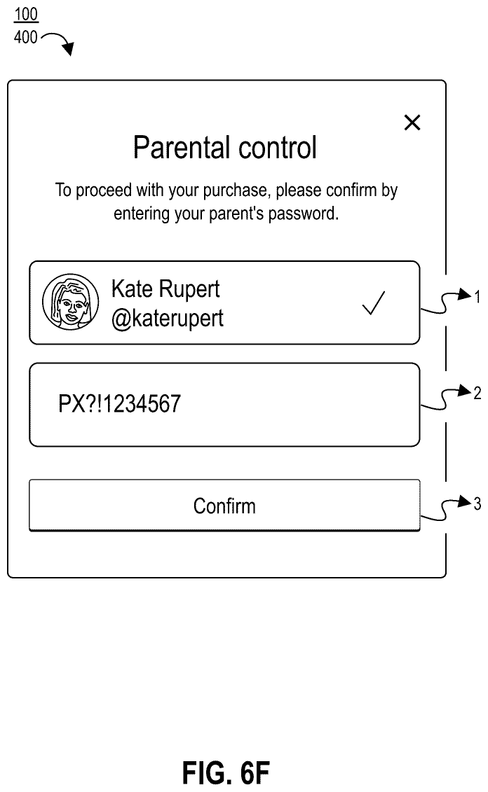

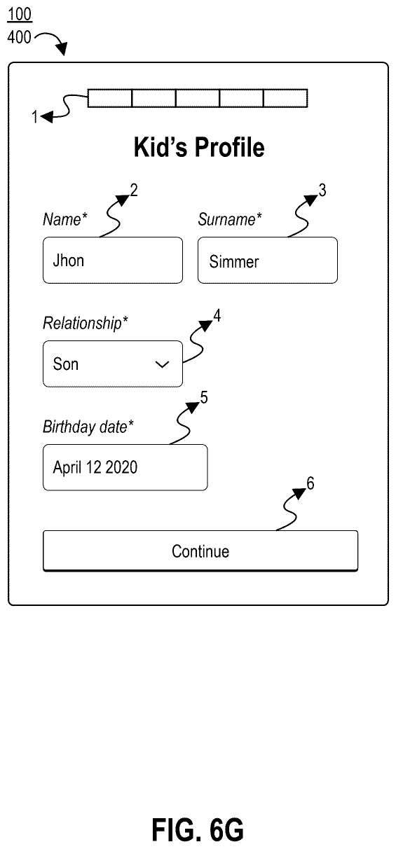

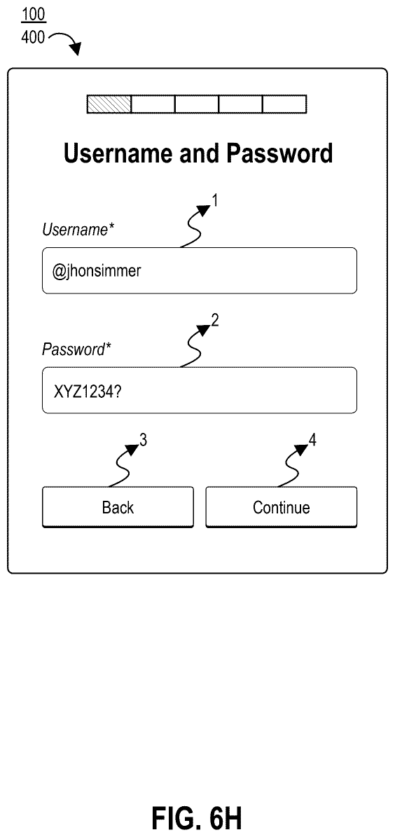

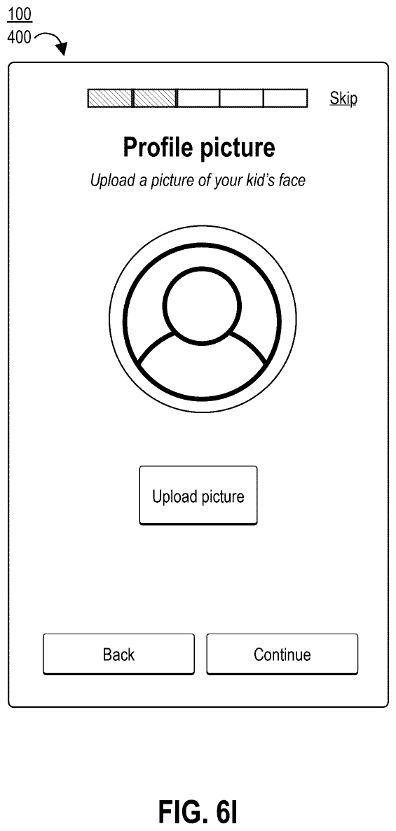

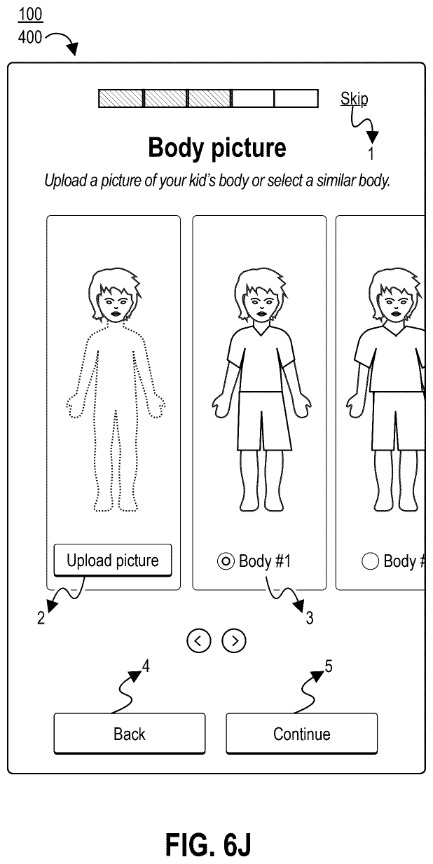

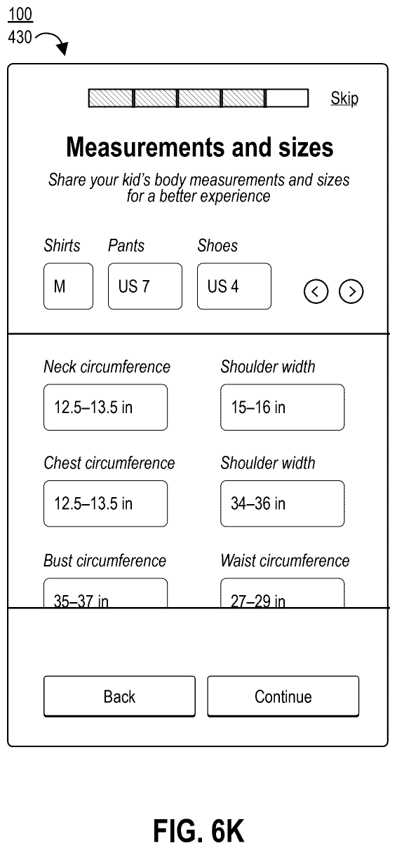

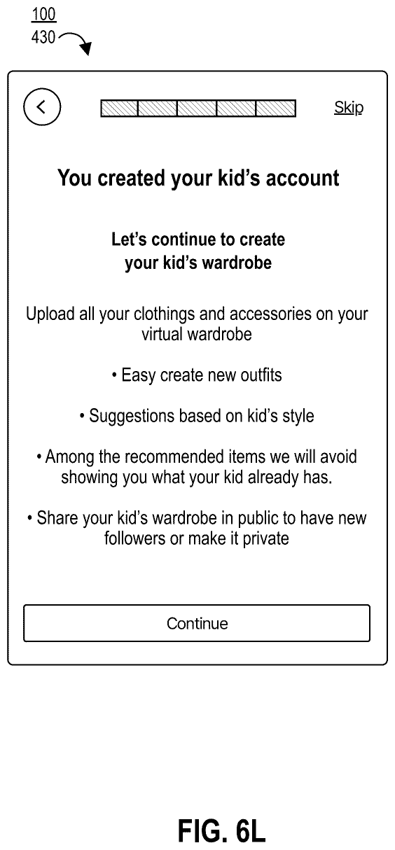

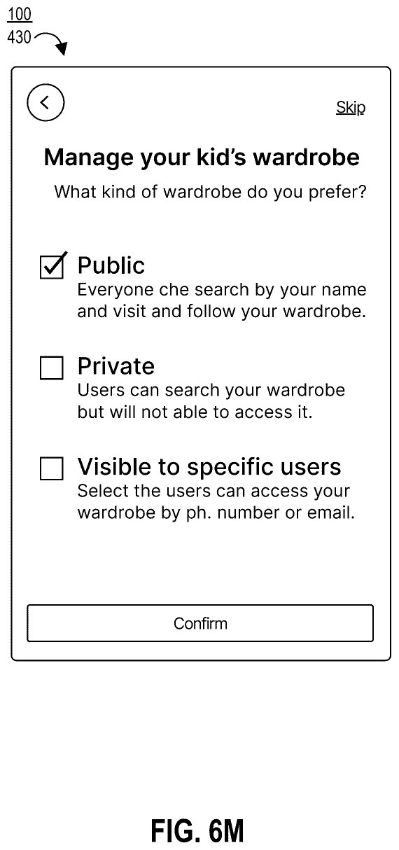

FIG. 6A The figure describes the process through which the user can create an account for kids to create this type of account you do not need another email or phone number. It will be a profile based on the main profile. However, the new child account will be completely independent in terms of preferences (user choices will only have effects on this specific account). So the peculiarity of this account for kids is that it is not necessary to have a new phone number or email. In addition, thanks to this type of account, the parent can control any purchases or payments, thanks to the ‘Parental Control’ feature. This account needs a specific new username and password. Descriptions of arrows: (1) The user clicks on the account button in the sidebar to the left and (2) select the option ‘Account’.

FIG. 6B The system shows a popup to make a choice. Descriptions of arrows: (1) A popup is opened. (2) The user can select his personal account to access again to the personal account or (3) add a new or existing account or (4) add a new or existing account for kids.

FIG. 6C Clicking on the option ‘Add account for kids’ the system shows a new popup to start creating the new account. Descriptions of arrows: (1) The user to continue needs to sign in with his main account as parent. The account for kids will be related to his phone number and email address.

FIG. 6D After the signing process, the user can continue. Descriptions of arrows: (1) The user accessing with his account (2) clicks on the button ‘Continue’ to proceed. (3) The user clicking ‘Sign in account for kids’ adds to the device the access of an existing account for kids, simply accessing with username and password of the existing account for kids. In the case of multiple profiles for children, it is necessary to specify that each child will have his or her own personal password (recoverable only after confirming that he or she is a parent thanks to the Parental control process) and username with which to access on any device.

FIG. 6E The figure shows a popup that appears to complete some actions related to an account for kids. If the kid's account wants to complete a purchase, retrieve and change username or password, modify profile, make payments for any reason, the parent's account password must be entered as confirmation. The parent can also apply this Parental Control security feature to all features of the PersonalX service, thus setting limits. Descriptions of arrows: (1) The Parental Control popup appears and the user has to sign in with a personal account to continue (Parent sign in is made one only time, for the next time you will already be automatically signed in and will only have to enter your password) and the parent user sign in in with personal account. (2) The user enters again the parent password and (3) confirms.

FIG. 6F The user signed in with his account and can continue. Descriptions of arrows: (1) The user signed in with his account (2) just enters his password (For the following times his account will appear as a parent having already signed in, but he will have to confirm his identity with the password each time to ensure maximum security. A notification may be sent to the parent account each time.) and (3) confirm to proceed.

FIG. 6G The user accesses the process to create an account for Kids. Descriptions of arrows: (1) The user accesses the page to create a new account for kids, and the system asks some options to be filled and a progress bar on the top. (2) The user enters the kid's name, (3) the kid's surname, (4) relationship (Daughter, son or other), (5) kid's birthday date. (6) The user clicks on ‘Continue’ to access the next page.

FIG. 6H The user accesses the next page. Descriptions of arrows: (1) The user enters the kid's username, (2) kids'account password, (3) the user clicks the button ‘Back’ to return back or (4) continue to proceed.

FIG. 6I The figure shows how the user can upload a profile picture for the kid's account.

FIG. 6J The figure shows how the user can upload body pictures for the kid's account. Descriptions of arrows: (1) The user skips the process. (2) The user uploads a picture of the kid's body (Face and body) or (3) chooses a body picture that represents the kid's body, avoiding to upload a picture or scan the body of the kid. (4) The user returns back or (5) continues the process.

FIG. 6K The figures show the next popup asking for the measurements and sizes of the kid. The user can enter sizes for each category (skirt, shirt, shoes, etc.) and body measurements to suggest the perfect sizes in the recommended items. This data will be visible in the preferences management section. If the user skips these requests in the preferences quiz it may appear as a question (example: what is your size for pants?, etc.)

FIG. 6L The figure shows a popup where the system informs the user that it will be possible to upload items in the kid's wardrobe.

FIG. 6M The figure shows a popup where the system shows some settings for the kid's wardrobe. The wardrobe can be public, private or visible to some specific users (Only some users that have relationships with the kids).

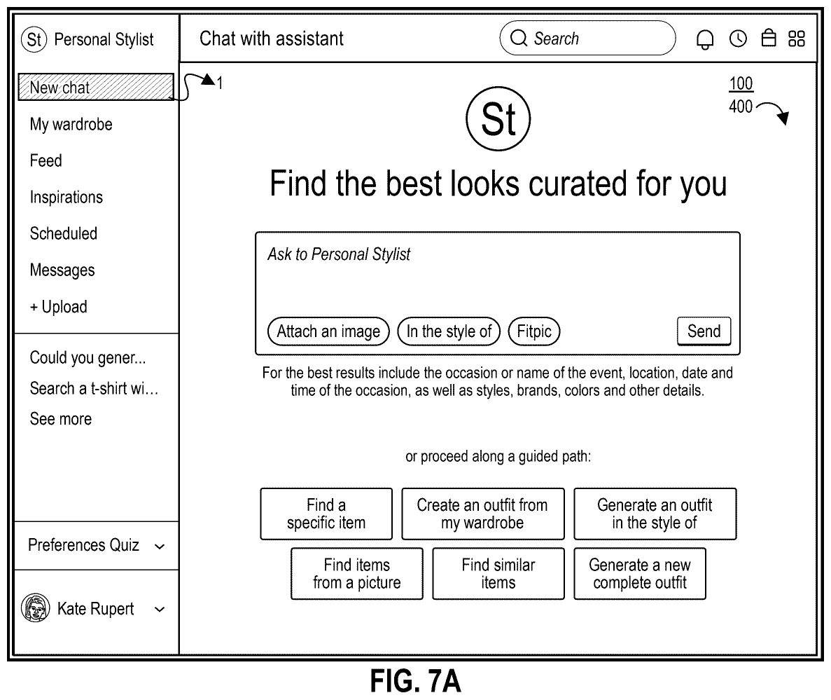

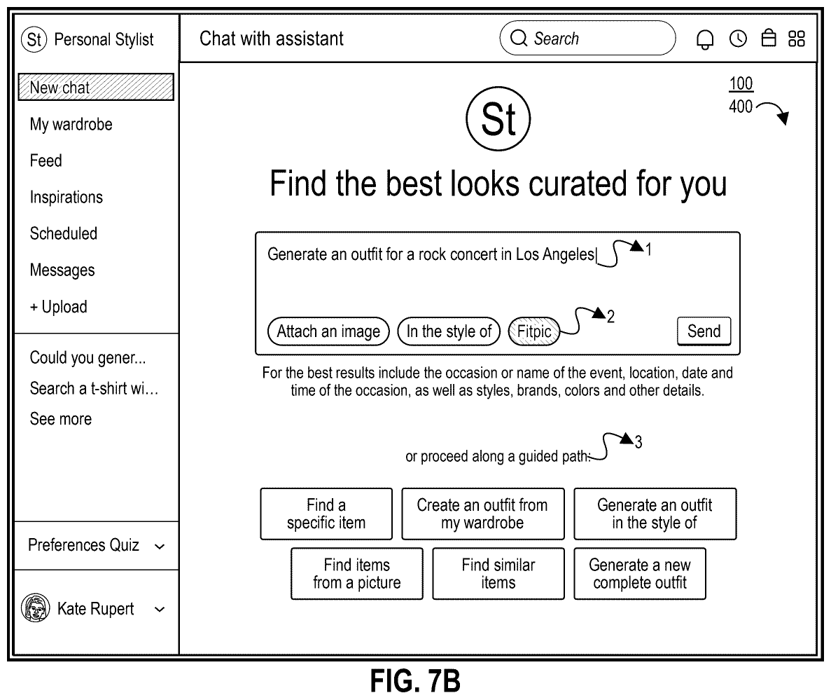

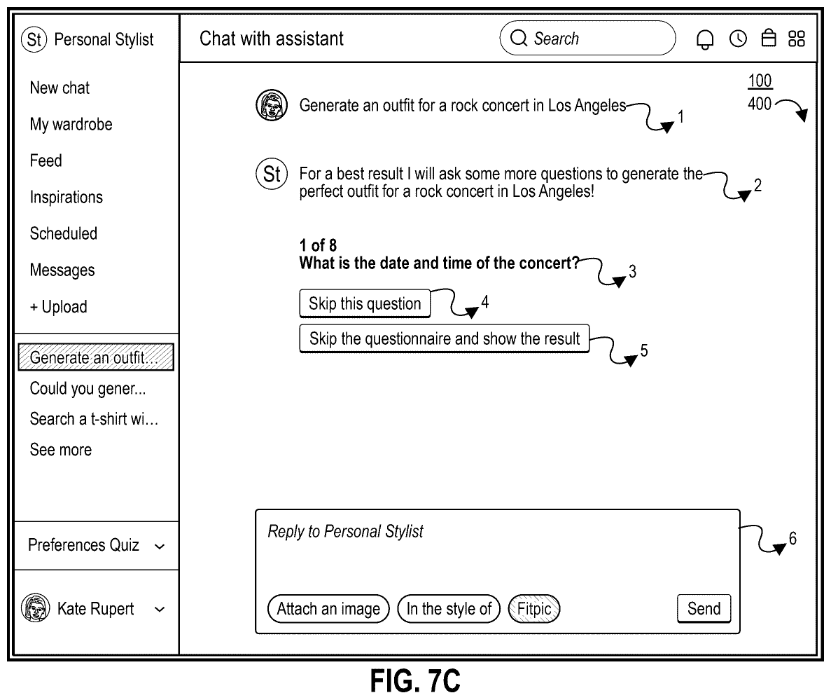

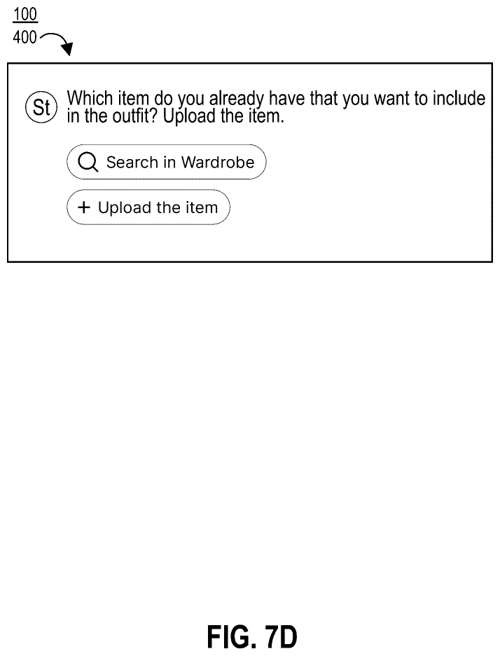

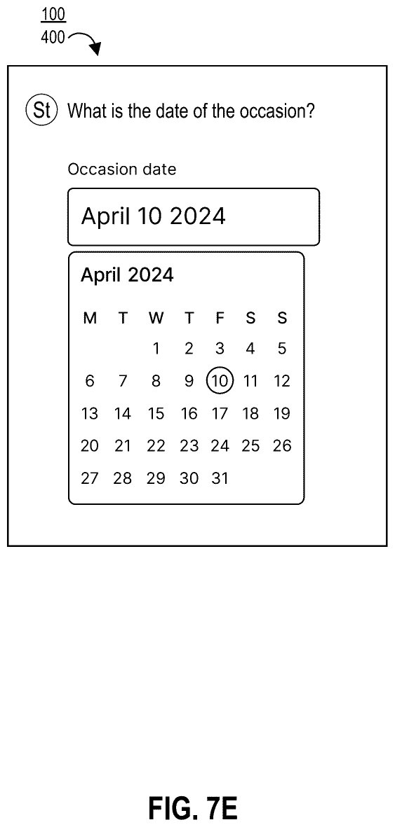

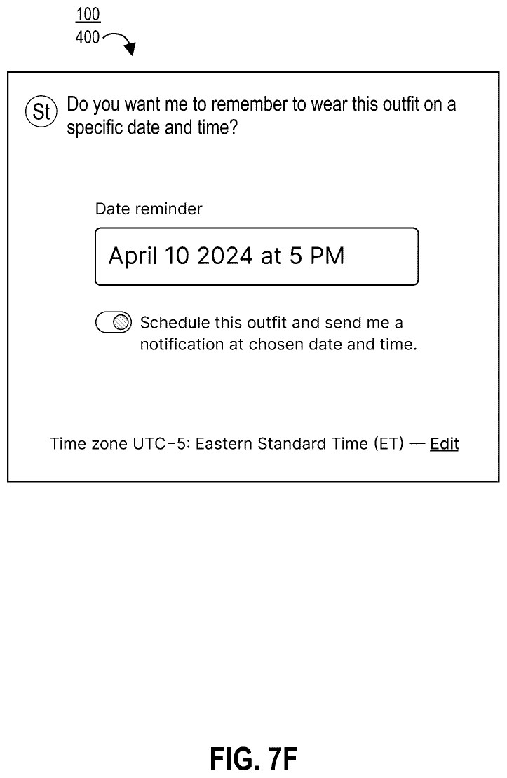

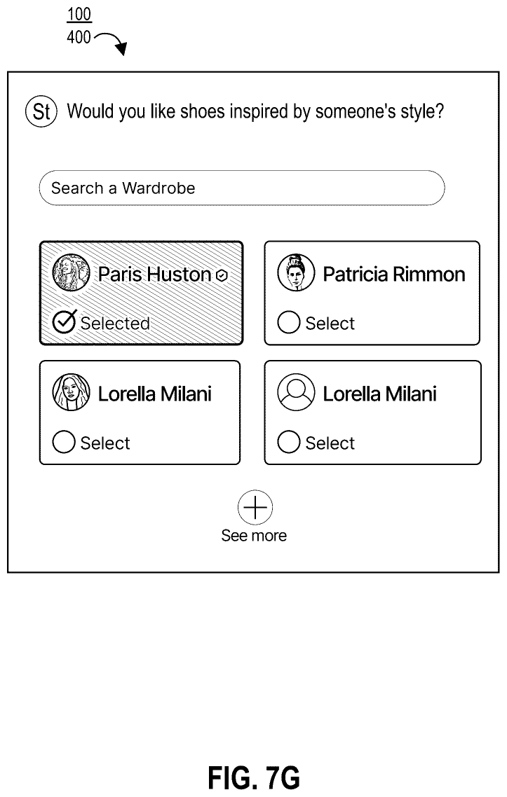

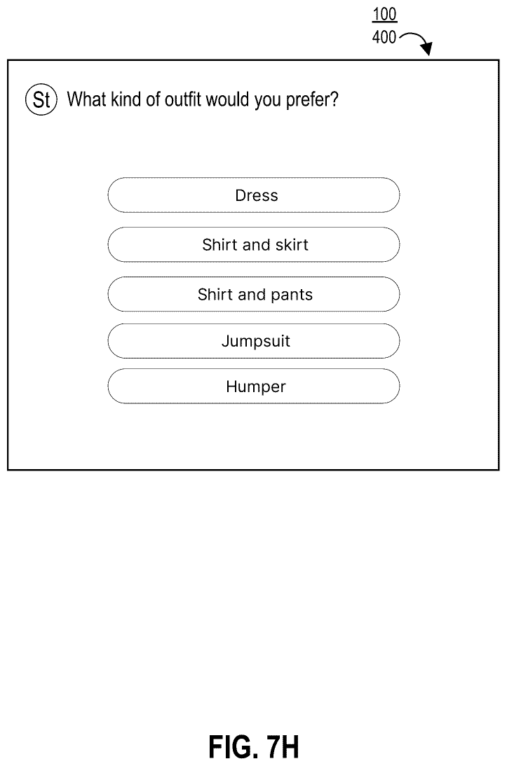

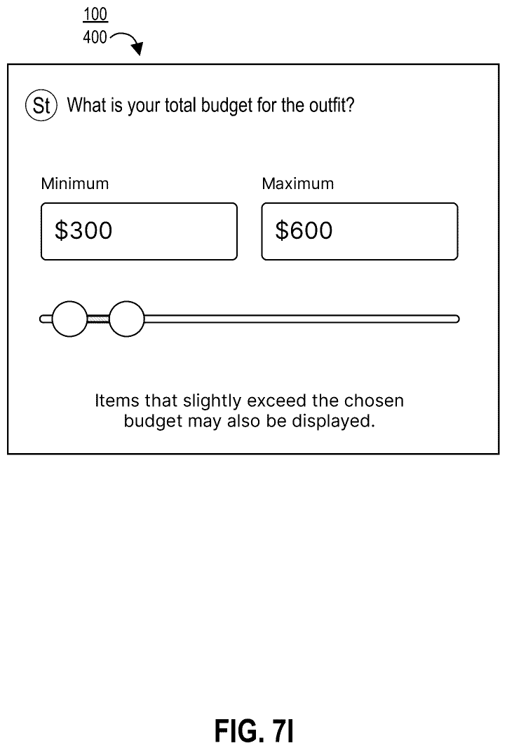

FIG. 7A The user accesses the Personal Stylist assistant to get recommendations by a more specialized agent. Descriptions of arrows: (1) The user clicks the button ‘New chat’ to open the homepage and type a new prompt.

FIG. 7B The Personal Stylist is able to generate fitpics (image of the user or a generic avatar wearing the recommended items) or just create a list of one or more recommended items to purchase, based on the prompt, the user's preferences and the answers of the user to some questions the agent can ask. Descriptions of arrows: (1) The user types a prompt ‘Generate an outfit for a rock concert in Los Angeles’ and (2) enable the option ‘Fitpic’ to ask the Personal Stylist to generate a Fitpic and related items to purchase. For best results, the agent invites the user to send a very specific prompt with some information, including the occasion or name of the event, location, date and time of the occasion, as well as styles, brands, colors and other details. (3) Other gadgets-options will appear as guided paths: To find a specific item, create an outfit from the user's wardrobe, generate an outfit in the style of someone, find items from a picture, find similar items, generate a new complete outfit.

FIG. 7C The figures show how the systems show the newly started chat. Descriptions of arrows: (1) The prompt of the user is not complete, some information is missed, the only information is that he wants an outfit, the occasion (concert) and the concert venue (Los Angeles). The Personal Stylist to create a result needs more information so it starts the little questionnaire. (2) Personal Stylist responds ‘For the best result I will ask some more questions to generate the perfect outfit for a rock concert in Los Angeles! (3) showing the question and the number of the questions it is going to ask ‘1 of 8—What is the date and time of the concert?’. (4) The user can skip the question or (5) skip the questionnaire and generate a result. (6) The user can answer in the prompt field. Other questions that can be included in the questionnaire about the items the Personal Stylist would like to include, like clothes (dresses, pants, shirts, t-shirts, skirts, etc . . .) or accessories (bags, jewels, shoes, etc . . . ).

It starts with general questions like:
What is the occasion or the context or the event for this outfit?
Where is this occasion located?
What is the date you will wear this outfit?
What is the time of day for the outfit you're looking for?
What colors would you like in general?
What style do you like in general?
Do you have any favorite brands in general?
Would you like to include accessories such as bags, jewelry, shoes?
What type of outfit would you like? (Shirt with shirt, dress, etc.)

And based on the user's choices the Personal Stylist will continue asking more specific questions related to the specific selected types of items:
What size are you for [Item]? (if not already included in the answers of the Preferences Quiz).
What kind of [Item] neckline do you prefer?
What kind of [Item] sleeves do you prefer?
What kind of [Item] heels do you prefer?
What type of pattern do you like for [Item]?
What fabrics do you prefer for [Item]?
What type of [Item] do you prefer?
Already have [Item]? Upload it here
Do you want to add other details for [Item]? At the end of the questions related to the specific items:
What kind of budget do you have? (Min. and Max.)
How many options do you want me to generate?

Other similar questions, such as about types of favorite clothes, any sizes or preferences in general. In addition, the user can upload images or express preferences even before the assistant asks them. The user can also decide whether to create fitpics with their own avatar or a generic one. Some information such as sizes or brand preferences are asked only the first time and are saved in the personal preferences that the user can manage. The user can skip the entire questionnaire or skip each question. The questions asked depend greatly on the main prompt submitted by the user, the choices he selects during the short questionnaire, and his preferences saved in the system. Personal Stylist will not necessarily ask questions about every item, but it may select certain items at its discretion even if not directly chosen by the user. In some cases, the Personal Stylist may suggest something different to the user, based on what they think is appropriate to wear (If the user would like an all-black suit for a wedding, the Personal Stylist will suggest that a colored suit would be appropriate.). However, the user's choices always take priority.

Personal Stylist could also ask questions related to the type of fitpic (image of outfit) that should generate following the user preferences (Ambient, personal avatar or generic avatar, filters, image scenes, etc.). The user can ask to include in the generated outfit a specific item or an item uploaded to their wardrobe. In this last case the item will be included in the outfit and it will not be necessary to purchase it again.

FIG. 7D The system asks the user ‘Which items do you already have that you want to include in the outfit? Upload the item.’ The user can search an item from his wardrobe or upload a new item.

FIG. 7E The system asks the user ‘What is the date of the occasion?’. The user can prompt his answers or select a date in the shown fields.

FIG. 7F The system asks the user ‘Do you want me to remember to wear this outfit on a specific date and time?’ The user can prompt his answers or select in the shown fields. The user will receive a notification with the outfit to wear on a specific date and time.

FIG. 7G The system asks the user ‘Would you like shoes inspired by someone's style?’. The user can search a wardrobe or select a suggested wardrobe. The system can generate an outfit based on the style of someone.

FIG. 7H The system asks the user ‘What kind of outfit would you prefer?’. Some options will appear to be selected. The user can prompt his answers or select one (or multiple) options.

FIG. 7I The system asks the user ‘What is your total budget for the outfit?’. The user can prompt his answers or fill in the fields or select minimum and maximum with the horizontal selector. Recommended items that slightly exceed the chosen budget may also be displayed.

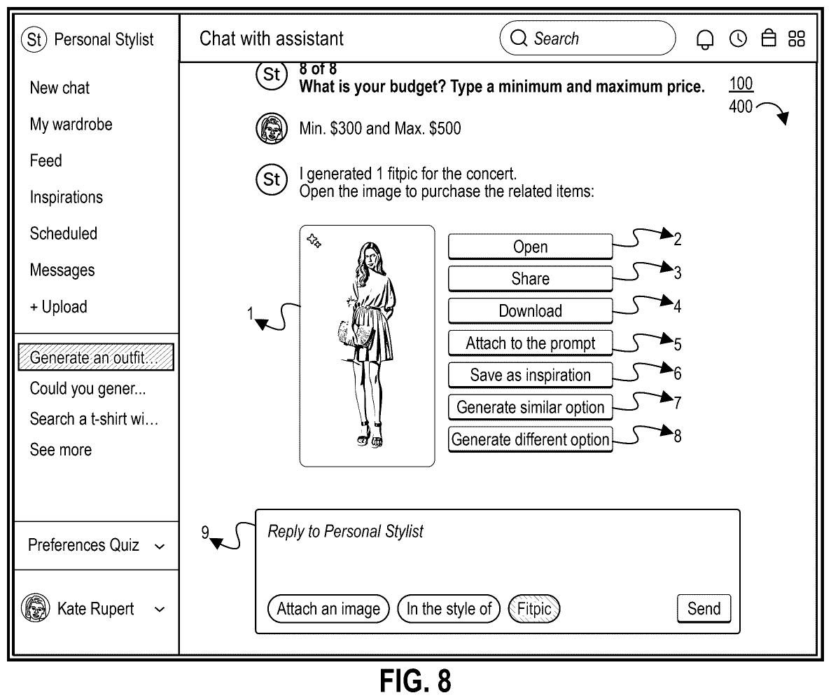

FIG. 8 The Personal Stylist generates a result (Fitpic with related recommended items to purchase). Descriptions of arrows: (1) The Personal Stylist generates a fitpic (Image of the personal or generic avatar wearing an outfit) with the recommended outfit (real items the user can purchase) on the preferences and budget selected by the user. (2) The user clicks the button ‘Open’ to open the image and see the recommended items to purchase. As an alternative the user can directly click/tap on the generated image. (3) The user clicks the button ‘Share’ to share the generated content and related items in a private message, on social networks, on the personal wardrobe (then automatically shared on the feed). (4) The user clicks the button ‘Download’ to download the image. (5) The user clicks the button ‘Attach to the prompt’ to attach the image in the prompt field to ask the Personal Stylist something related to the image. (6) The user clicks the button ‘Save as inspiration’ to save the image and related items to purchase in the section ‘Saved’ of personal wardrobe. That section is totally private. (7) The user clicks the button ‘Generate similar option’ to generate an alternative fitpic very similar following other user's preferences that the user can manually set in a panel. (8) The user clicks the button ‘Generate different option’ to generate a totally different fitpic following other user's preferences that the user can manually set in a panel. (9) The user can prompt new requests replying to the Personal Stylist.

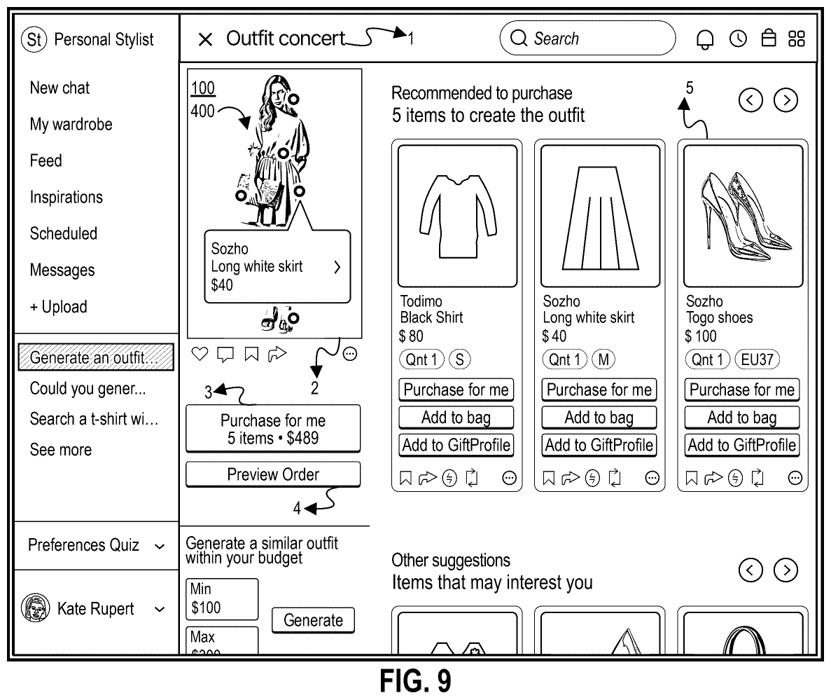

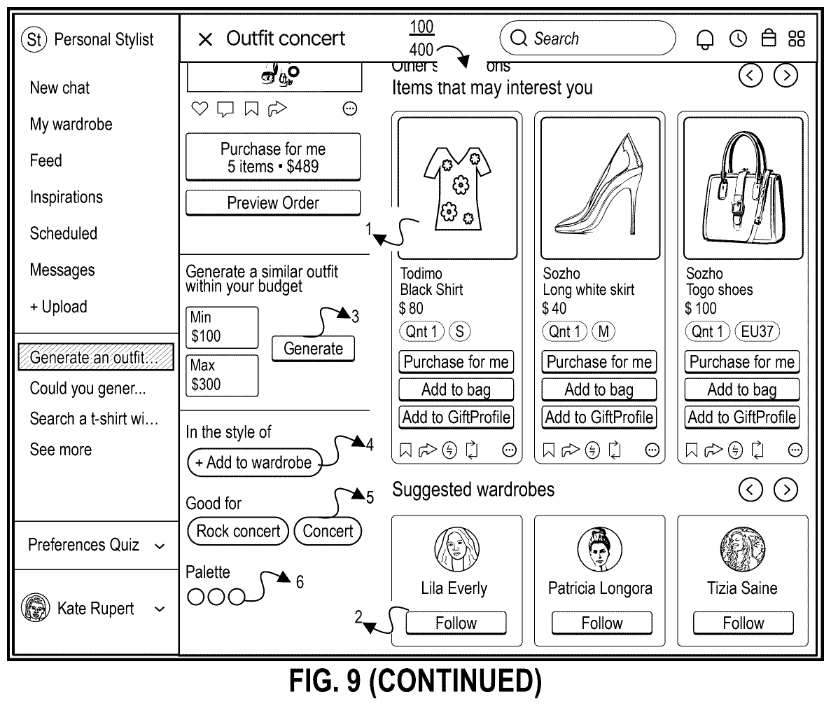

FIG. 9 The user opens the generated fitpic. Descriptions of arrows: (1) The user opens the fitpic and the system shows a page with the name of the outfit, the generated fitpic on the left side and the recommended items to purchase to recreate in real life the same outfit generated in the fitpic. (2) The fitpic, on each part related to an item will show some shoppable tags (Same links of the items in the right side). (3) The user can click the ‘Purchase for me’ button’ to purchase the whole outfit in just one click. (4) The user can click the button ‘Preview order’ to open a view with the list of all items, the possibility to exclude or include some of them and purchase with one click. (5) On the right side the system shows the recommended items to purchase, other suggestions and related wardrobe to follow based on the style of the generated outfit.

FIG. 9 (Continued) The left side and the right side of the screen are scrollable, in a separate way, so that you can view all the possible actions related to the fitpic and also scroll the list of proposed articles. Descriptions of arrows: (1) The user scrolls the right side of the page to see more. The system shows after the recommended items, other suggested items the user may be interested in (2) and suggested wardrobes the user can follow, based on the style of the generated fitpic or based on the recommended items. (3) The user can generate a new similar outfit within a specific new budget. The new outfit will have of course new different recommended items within the chosen budget. (4) The user can add the generated fitpic in the personal wardrobe (then automatically shared on the feed). (5) The system shows some related tags ‘Good for’ to communicate that the generated outfit is perfect for some specific contexts, occasions, events, locations, time of day, date, season, weather, etc. (6) The system shows the color palette of the outfit and/or other related information.

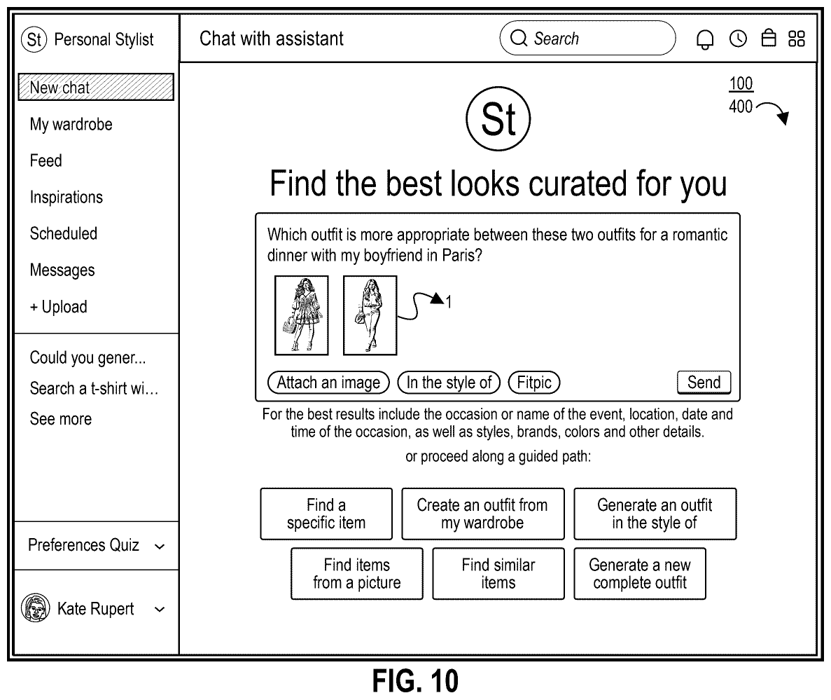

FIG. 10 The user attaches images in the prompt field for a specific request, asking the Personal Stylist which of the two images representing an outfit are more appropriate for a specific occasion, place, date and context. Descriptions of arrows: (1) The user uploads two images of outfits (fitpics) in the prompt field, asking ‘Which outfit is more appropriate between these two outfits for a romantic dinner with my boyfriend in Paris?’. Personal Stylist will start a little questionnaire and at the end will generate a result, responding to the user which outfit is perfect. The Personal Stylist, in the case, could also take into account, at its discretion if necessary, the preferences of other people mentioned. The system, thanks to the Preferences Quiz, also knows the relationships that exist between users. For example, if the userX is the boyfriend of userY, and userY is mentioning userX for some reason, in this case the system knows who is the boyfriend of userY and could therefore take into account the preferences of userX.

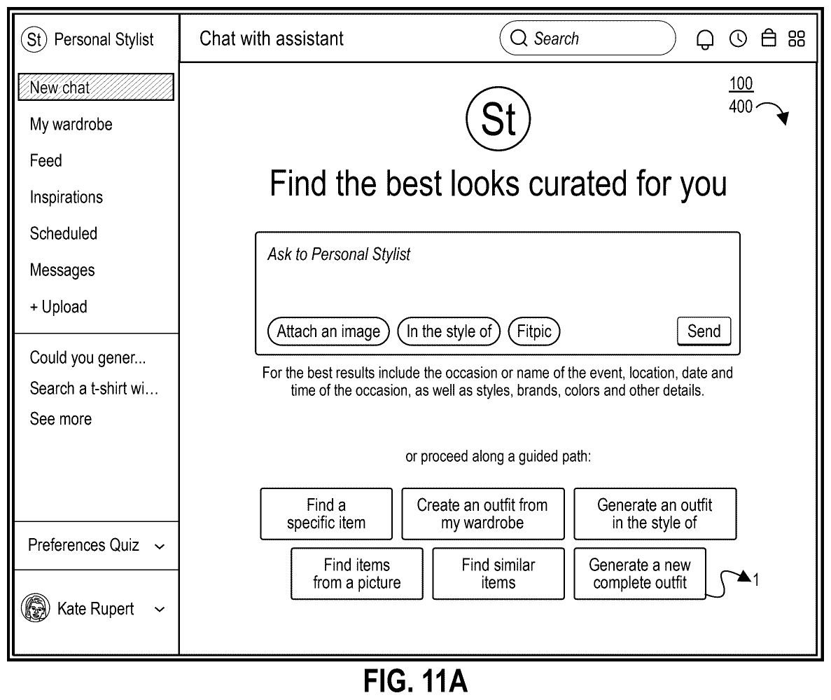

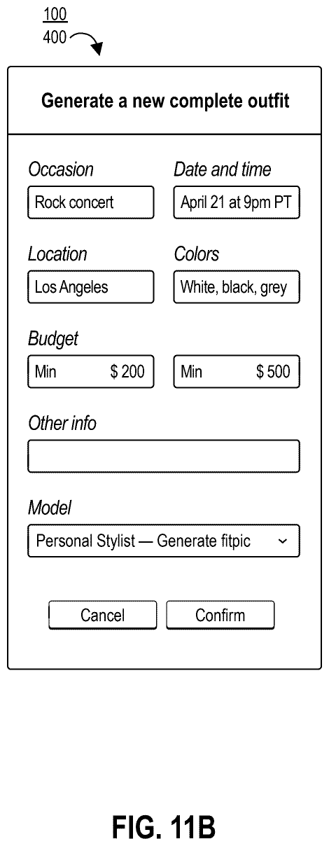

FIG. 11A The system shows a gadget, as a guided path, in the homepage, to generate a new complete outfit. Descriptions of arrows: (1) The user clicks the button ‘Generate a new complete outfit’.

FIG. 11B The system shows a panel to fill to generate a new complete outfit. The system is asking about the occasion, date and time, location, colors, budget, other info and the model to generate a fitpic with related items or just recommend items to purchase.

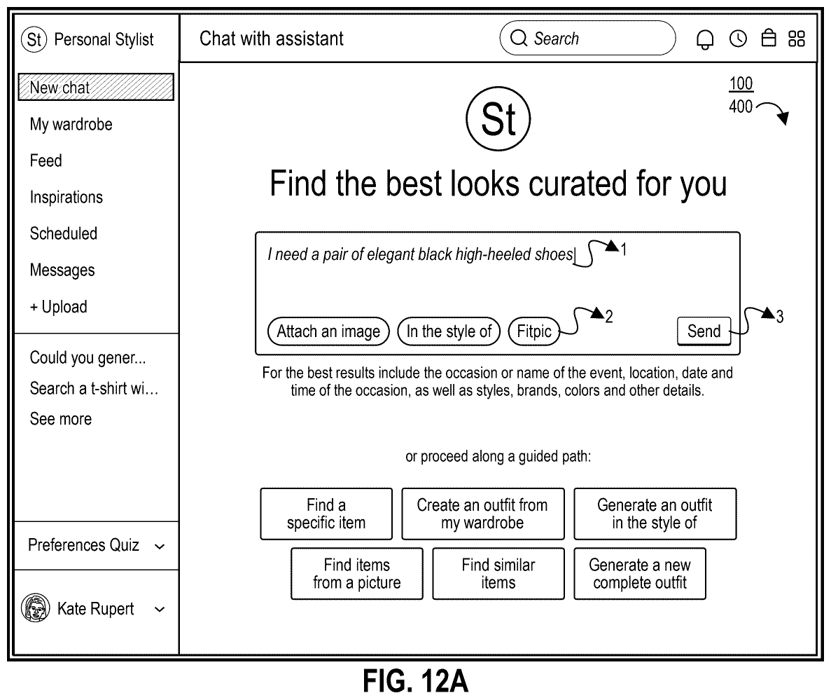

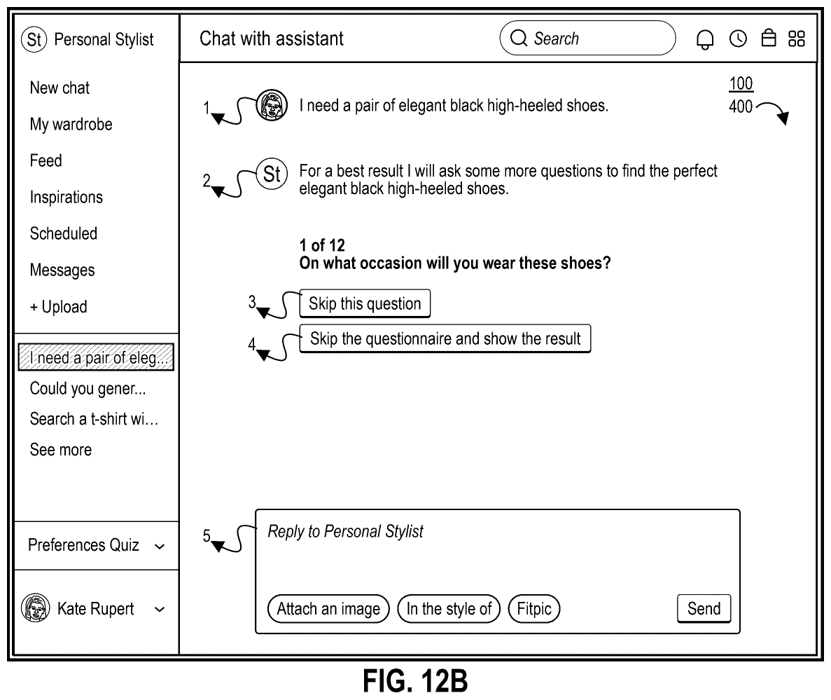

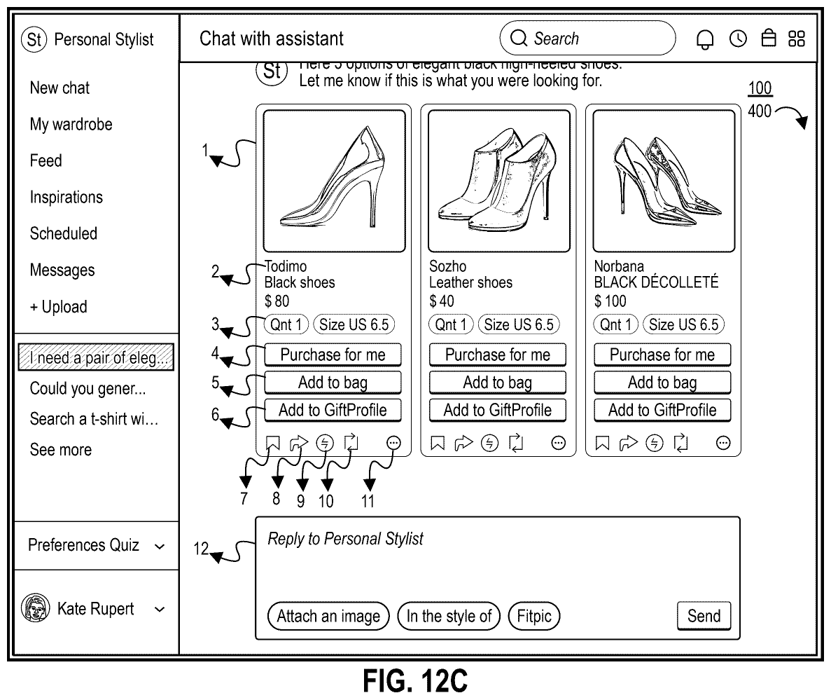

FIG. 12A The user accesses the Personal Stylist assistant to get recommendations by a more specialized agent to find a specific item. Descriptions of arrows: (1) The user types in the prompt field ‘I need a pair of elegant black high-heeled shoes’. (2) The user unselect the option ‘Fitpic’ because he doesn't need to generate images but he just wants recommendations for a specific item. So the result will be an item or a list of items to purchase. (3) The user clicks the button ‘Send’ to send the request.

FIG. 12B The figures show how the systems show the newly started chat. Descriptions of arrows: (1) The prompt of the user is not complete, some information is missed, the only information is that he wants ‘a pair of black’, the style is ‘elegant’, the color is ‘black’, type of shoes is ‘High-heeled’. Data like brands, occasions, locations, date of occasion, time of occasions, budget, number of options, are missed. For that reason the Personal Stylist will start a little questionnaire to get more information and generate a perfect result. (2) Personal Stylist responds ‘For the best result I will ask some more questions to find the perfect elegant black high-heeled shoes’. Showing the question and the number of the questions it is going to ask ‘1 of 12—On what occasion will you wear these shoes?’. (3) The user can skip the question or (4) skip the questionnaire and generate a result. (5) The user can answer in the prompt field.

It starts with general questions like:
What is the occasion or the context or the event for this item?
Where is this occasion located?
What is the date you will wear this item?
What is the time of day for the outfit you're looking for?
What colors would you like in general?
What style do you like in general?
Do you have any favorite brands in general? And based on the user's choices the Personal Stylist will continue asking more specific questions related to the specific selected types of items:
What size are you for [Item]? (if not already included in the answers of the Preferences Quiz).
What type of pattern do you like for [Item]?
What fabrics do you prefer for [Item]?
What materials do you prefer for [Item]?
What type of [Item] do you prefer?
Already have a similar item? Upload it here
Do you want to add other details for [Item]? At the end of the questions related to the specific items:
What kind of budget do you have for this item?
(Min. and Max.)
How many options do you want me to generate?

The user can skip the entire questionnaire or skip each question. The questions asked depend greatly on the main prompt submitted by the user, the choices he selects during the short questionnaire, and his preferences saved in the system. In some cases, the Personal Stylist may suggest something different to the user, based on what they think is appropriate to wear (If the user would like an all-black suit for a wedding, the Personal Stylist will suggest that a colored suit would be appropriate.). However, the user's choices always take priority.

FIG. 12C The Personal Stylist generates a result (3 item options the user can choose and purchase). Descriptions of arrows: (1) The Personal Stylist generates a result showing three item options, showing for each item the item picture, (2) brand name, item name and price (the system show an item sold by an external seller, and the price is the best price offered online for that specific item). Related to the chosen seller could appear some information like ‘Last in stock’ or the possibility to change seller. PersonalX could have affiliate partnerships with external sellers. Other information could appear like seller info, return info, shipping costs, points value, credits amount, set price alert, notifications, badges and more. (3) The system shows available seller options that the system automatically chooses for the user, but the user is able to manage if available on the selected seller (Quantity to purchase, size, color, model, material, fabric, pattern, etc). (4) The system shows some buttons like ‘Purchase for me’ for the instant purchase of the item, (5) ‘Add to shopping bag’ to add the item in the shopping bag and continue the purchase through that feature, (6) ‘Add to GiftProfile’ to add the item in the personal GiftProfile, a sort of personal public wishlist where other users can purchase gifts for that user. (7) The system shows other buttons under each item like ‘Save’ to save the item as favorite, (8) ‘Share’, (9) ‘Generate a similar option’, (10) ‘Generate a different option’, (11) ‘Other options. (12) The user can continue the chat just typing a new request in the prompt field.

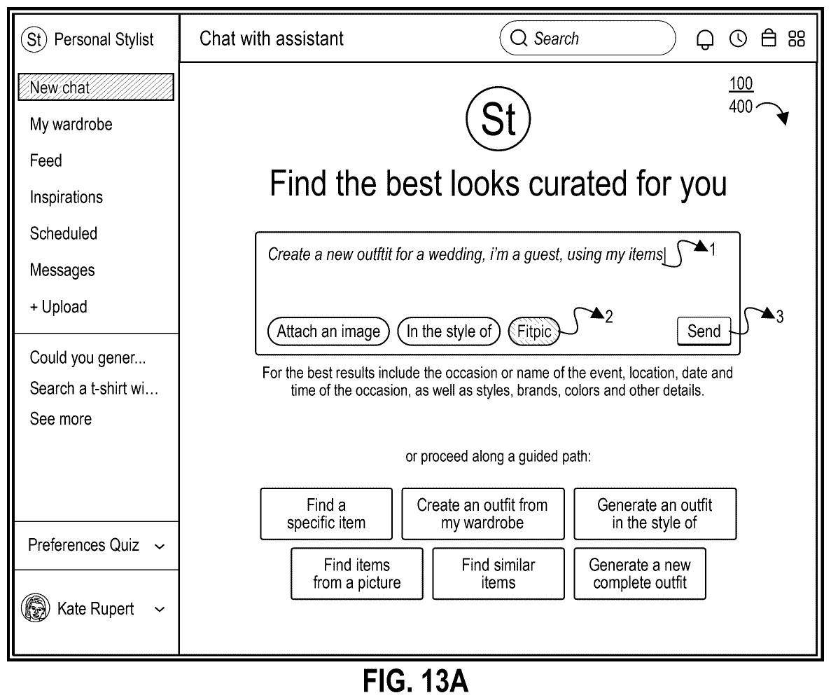

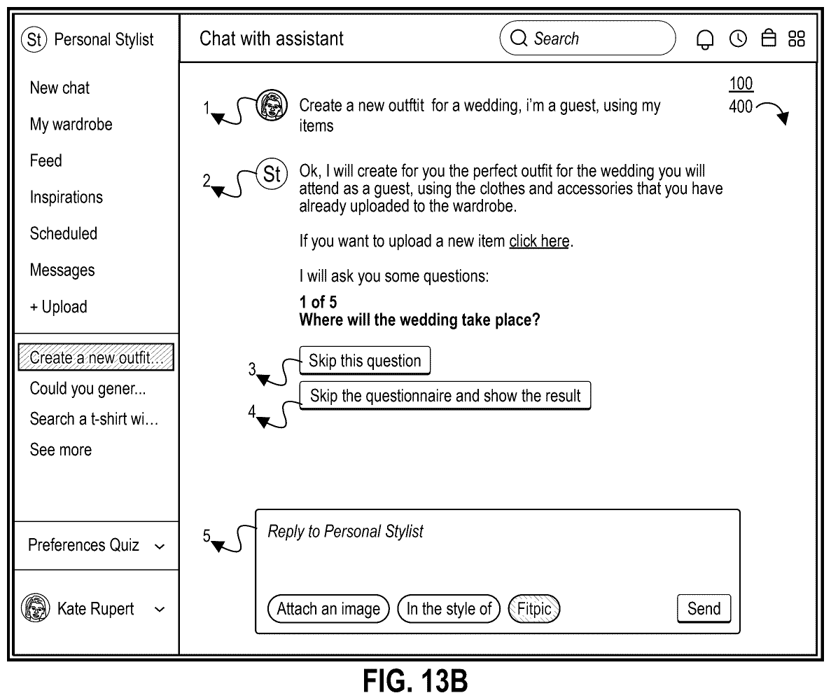

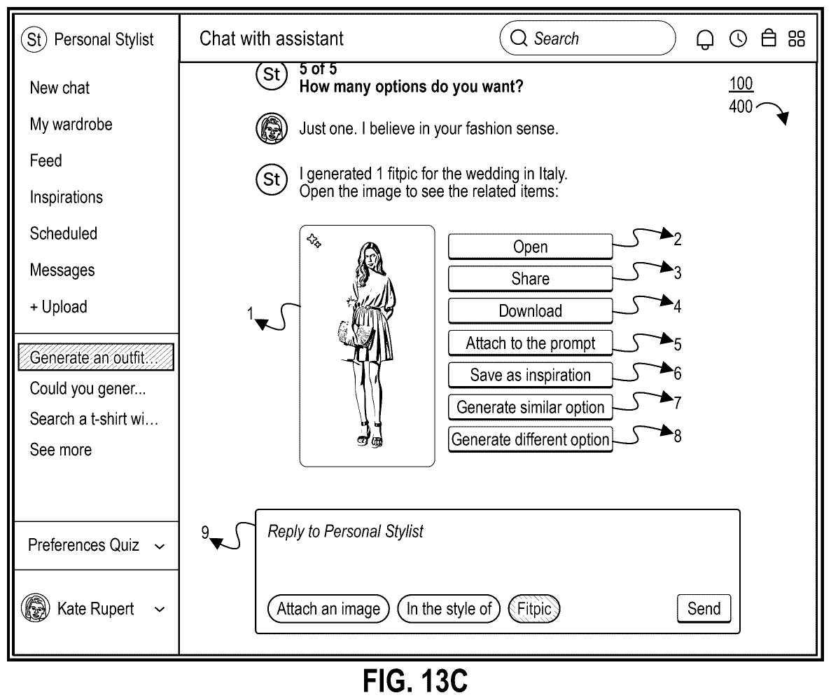

FIG. 13A The user accesses the Personal Stylist assistant to get recommendations by a more specialized agent to generate an outfit from personal wardrobe. Descriptions of arrows: (1) The user types in the prompt field ‘Create a new outfit for a wedding, I'm a guest, using my items’, (2) enable the option ‘Fitpic’ to ask the Personal Stylist to generate a Fitpic and related items to purchase. For best results, the agent invites the user to send a very specific prompt with some information, including the occasion or name of the event, location, date and time of the occasion, as well as styles, brands, colors and other details. (3) The user clicks the button ‘Send’ to send the prompt and start the chat with Personal Stylist.

FIG. 13B The figures show how the systems show the newly started chat. Descriptions of arrows: (1) The prompt of the user is not complete, some information is missed, the only information is that he wants an outfit, the occasion (wedding), the specific context (as guest), request (using my items in wardrobe). The Personal Stylist to create a result needs more information so it starts the little questionnaire. (2) Personal Stylist responds ‘Ok, I will create for you the perfect outfit for the wedding you will attend as a guest, using the clothes and accessories that you have already uploaded to the wardrobe. If you want to upload a new item click here. I will ask you some questions . . . ’. Showing the question and the number of the questions it is going to ask ‘1 of 5—Where will the wedding take place?’. (3) The user can skip the question or (4) skip the questionnaire and generate a result. (5) The user can answer in the prompt field. Other questions that can be included in the questionnaire about the items the Personal Stylist would like to include, like clothes (dresses, pants, shirts, t-shirts, skirts, etc.) or accessories (bags, jewels, shoes, etc . . . ).

It starts with general questions like:
What is the occasion or the context or the event for this outfit?
Where is this occasion located?
What is the date you will wear this outfit?
What is the time of day for the outfit you're looking for?
What colors would you like in general?
What style do you like in general?
Do you have any favorite brands in general?
Would you like to include accessories such as bags, jewelry, shoes?
What type of outfit would you like? (Shirt with shirt, dress, etc.)
At the end of the questions related to the specific items:
What kind of budget do you have? (Min. and Max.)
How many options do you want me to generate?

The user can also decide whether to create fitpics with their own avatar or a generic one. The user can skip the entire questionnaire or skip each question. The questions asked depend greatly on the main prompt submitted by the user, the choices he selects during the short questionnaire, and his preferences saved in the system. Personal Stylist will not necessarily ask questions about every item, but it may select certain items at its discretion even if not directly chosen by the user. The user can in that process add new items in the personal wardrobe.

FIG. 13C The Personal Stylist generates a result (Fitpic with related recommended items to purchase). Descriptions of arrows: (1) The Personal Stylist generates a fitpic (Image of the personal or generic avatar wearing an outfit) with the recommended outfit (real items the user can purchase) on the preferences and budget selected by the user. (2) The user clicks the button ‘Open’ to open the image and see the recommended items to purchase. As an alternative the user can directly click/tap on the generated image. (3) The user clicks the button ‘Share’ to share the generated content and related items in a private message, on social networks, on the personal wardrobe (then automatically shared on the feed). (4) The user clicks the button ‘Download’ to download the image. (5) The user clicks the button ‘Attach to the prompt’ to attach the image in the prompt field to ask the Personal Stylist something related to the image. (6) The user clicks the button ‘Save as inspiration’ to save the image and related items to purchase in the section ‘Saved’ of personal wardrobe. That section is totally private. (7) The user clicks the button ‘Generate similar option’ to generate an alternative fitpic very similar following other user's preferences that the user can manually set in a panel. (8) The user clicks the button ‘Generate different option’ to generate a totally different fitpic following other user's preferences that the user can manually set in a panel. (9) The user can prompt new requests replying to the Personal Stylist.

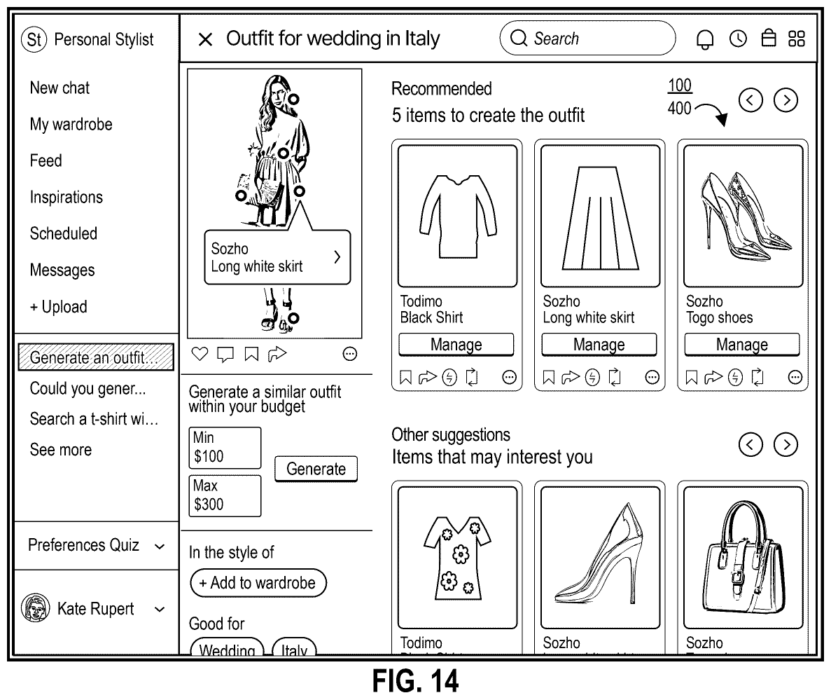

FIG. 14 The user opens the generated fitpic with related items to wear. The user in fact already owns these items. The system shows as suggested items below some similar items or alternate to purchase.

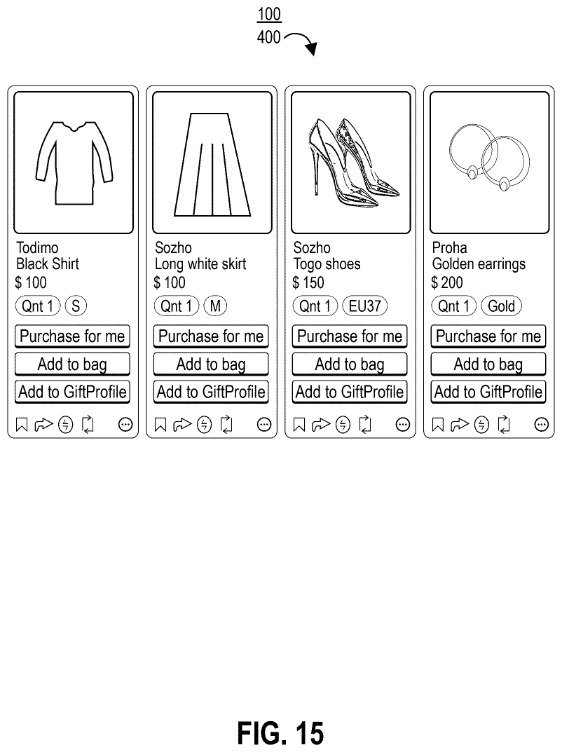

FIG. 15 The figure shows the recommended items to purchase to replicate the same outfit in the generated image (fitpic).

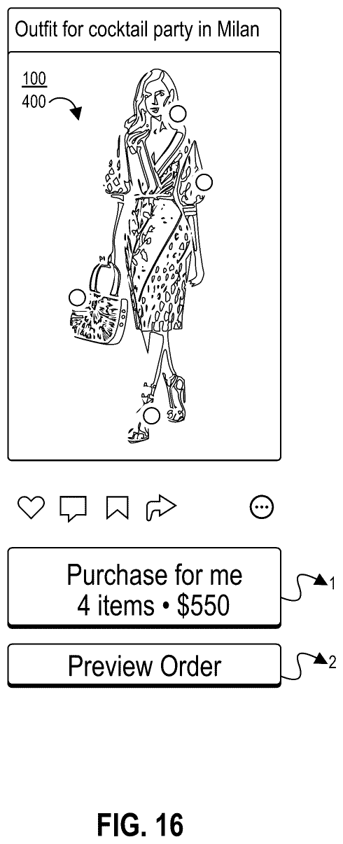

FIG. 16 The figures describe the feature ‘Purchase for me’ button. Related to a fitpic the system shows 2 ways to purchase the whole outfit (The purchase of all the items that create the outfit). Descriptions of arrows: (1) The user clicks the button ‘Purchase for me—4 items $550’ to instantly purchase the whole outfit represented in the generated image (fitpic). The user clicks the button ‘Preview order’ to visualize the complete list of items that create the outfit, select or unselect the items to purchase and proceed with the purchase.

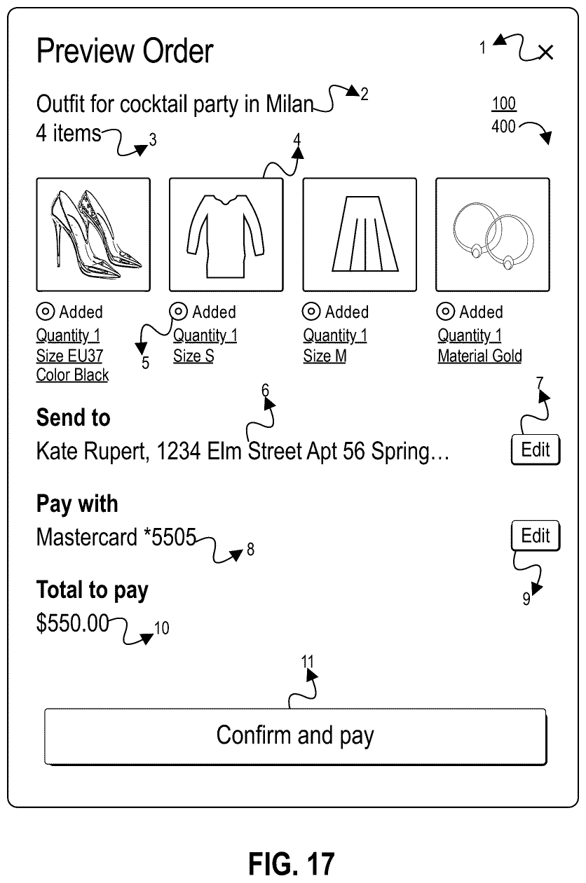

FIG. 17 The user clicks the button ‘Preview order’ (or could also be ‘Customize order’ or similar) and the system shows a popup to customize the order. Descriptions of arrows: (1) The client clicks the button ‘Close’ to close the popup and return back. (2) The system shows the name of the outfit ‘Outfit for cocktail party in Milan’ and (3) the number of items that make up the outfit—4 items are displayed in the outfit. (4) The system shows the list of the items with pic previews and (5) a button to select or deselect the item in the list, in fact the user can include or exclude one or more items in the purchase. The client can manage the items available variables like sizes, colors, quantity, material, etc. All variables are chosen by the system based on the user's preferences. The client is free to manage them and change them. (6) The system shows the pre-set shipping address of the client and (7) a button to edit it. (8) The system shows the pre-set payment method of the client and (9) a button to edit it. (10) The system shows the total price to pay and (11) the button ‘Confirm and pay’ to proceed the purchase of the selected items. This process is very similar to the ‘Buy the Outfit’ purchase process, except that in this case the client can manage the list of items to include or exclude and manage the shipping address and payment method.

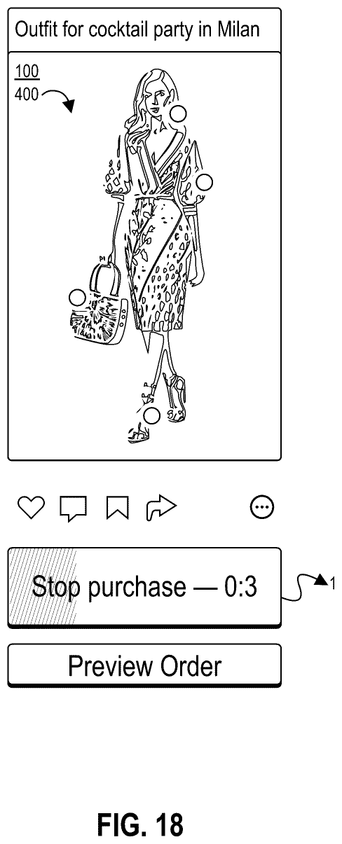

FIG. 18 The figures describe the instant purchase. Descriptions of arrows: (1) The system shows that the button ‘Purchase for me’ after the user clicks, becomes ‘Stop purchase—3 seconds). The user has 5 seconds to stop the instant purchase of the whole outfit. The button shows a progress status. After the last second, the button became ‘Manage the order’.

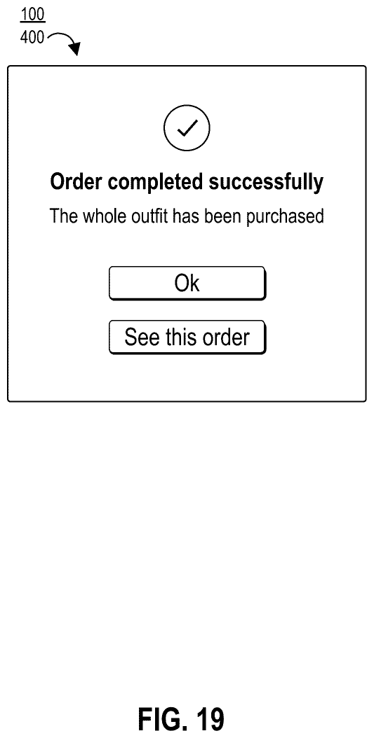

FIG. 19 The system shows a popup to confirm that the order is completed successfully.

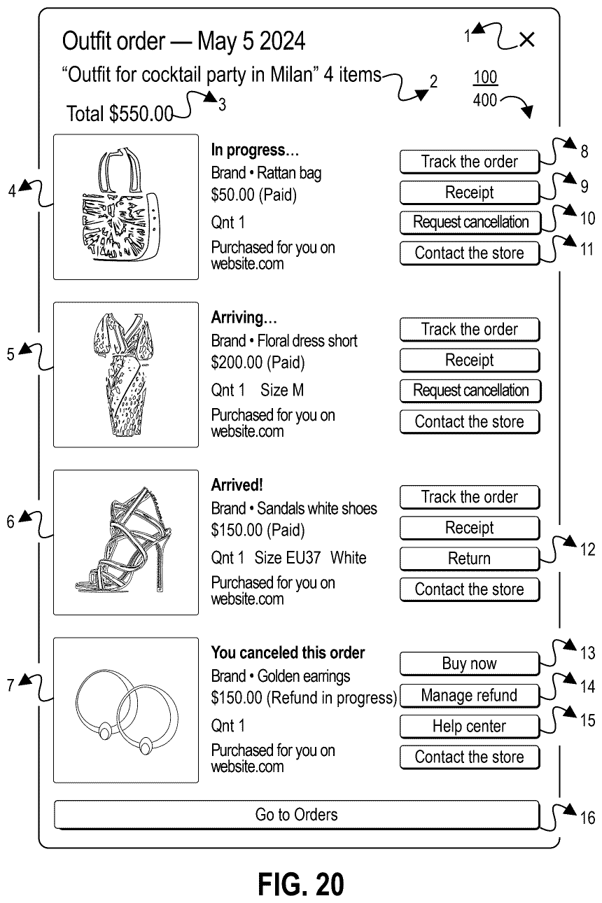

FIG. 20 The user clicks the button ‘See this order’ from the successful purchase feedback popup. It opens the outfit-order popup to manage the order of the outfit. Descriptions of arrows: (1) The user clicks the button ‘Close’ to close the outfit-order popup. (2) The system shows the purchase date, the name of the outfit and (3) the total price of the outfit already paid. The system shows the list of purchased items: (4) the bag, (5) the dress, (6) the high-heeled sandals and (7) the pair of earrings. All items have been purchased and a label is shown for each item, thus communicating the status, which can be ‘In progress’ if the seller store is working on shipping the item, ‘Arriving’ if the item has been shipped by the seller store, ‘Arrived’ if it has already arrived at the recipient, ‘You canceled this order’ if the user has canceled the order.

Depending on the type of progress status of the purchase process, management buttons will appear. The following buttons will then appear: (8) ‘Track the order’ to view the shipping status and delivery times, (9) ‘Receipt’ to view the invoice, (10) ‘Request cancellation’ to request the cancellation of the order and the related refund, (11) ‘Contact the store’ to contact the seller's store, (12) ‘Return’ to start the return and related refund process, (13) ‘Buy now’ to purchase the canceled item, (14) ‘Manage refund’ to manage the refund process, (15) ‘Help center’ to get support from the system, (16) ‘Go to Orders’ to access the management page of all purchases made through this system.

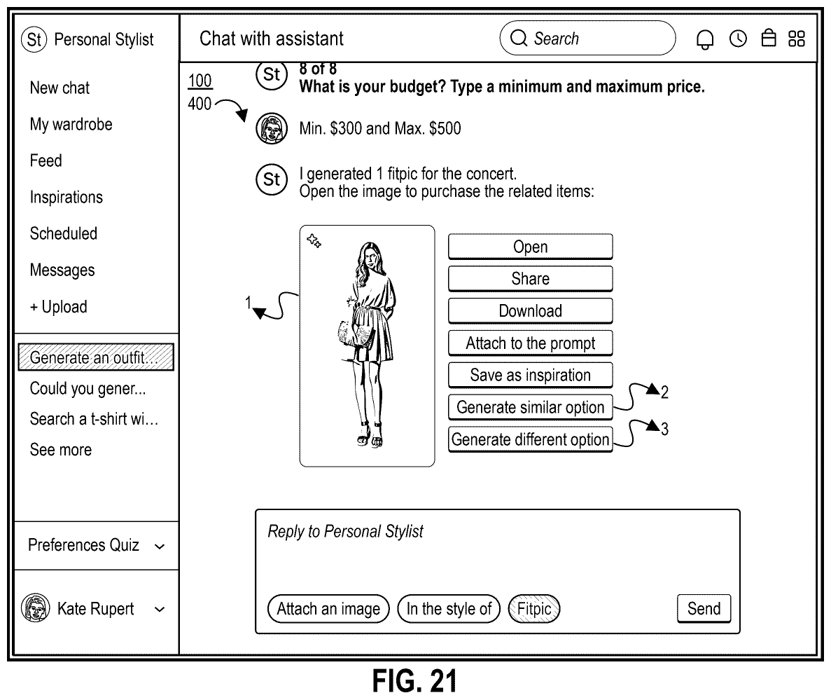

FIG. 21 The figure describes the process through which the user asks the Personal Stylist to generate a fitpic with related items to purchase. Descriptions of arrows: (1) The Personal Stylist generated a topic showing some possible actions. (2) The user clicks the button ‘Generate similar option’ to generate an alternative fitpic very similar following other user's preferences that the user can manually set in a panel. (3) The user clicks the button ‘Generate different option’ to generate a totally different fitpic following other user's preferences that the user can manually set in a panel.

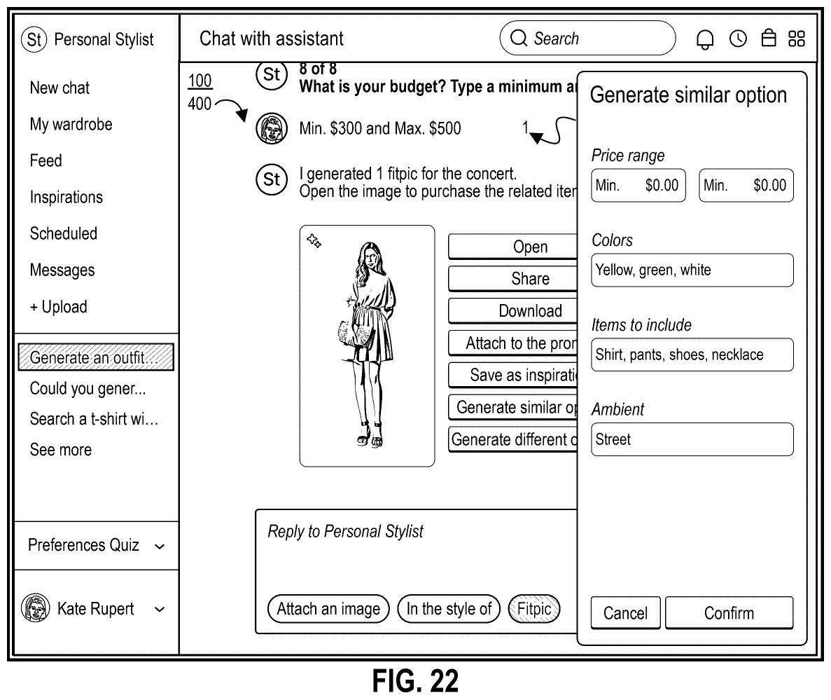

FIG. 22 The figure shows the panel that the system shows if the user clicks the button ‘Generate similar option’. (1) The panel is opened and the Personal Stylist asks to fill some request to better understand the user's needs, asking for the budget, colors, items to include, ambient. The user clicking on confirm will send a prompt to generate the new similar fitpic.

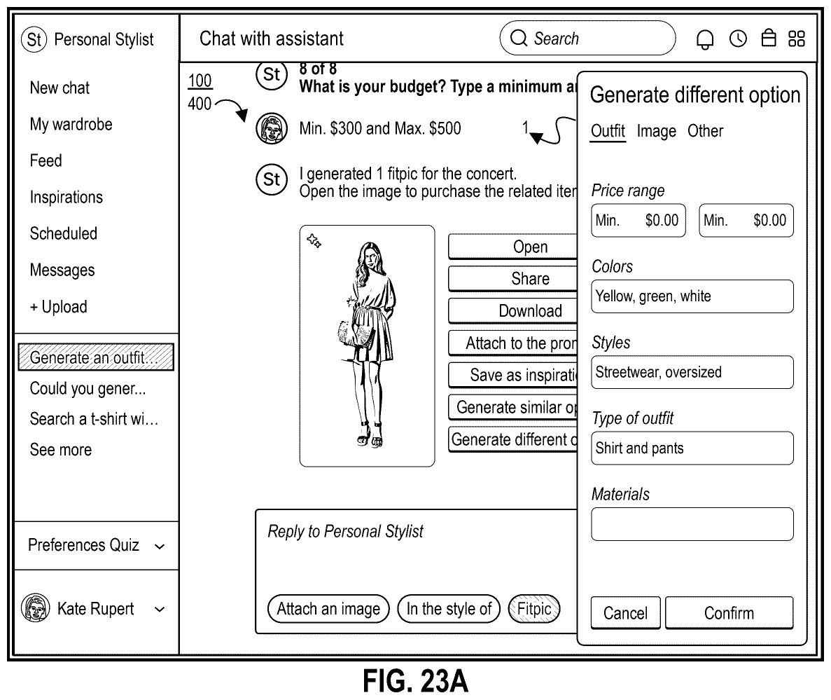

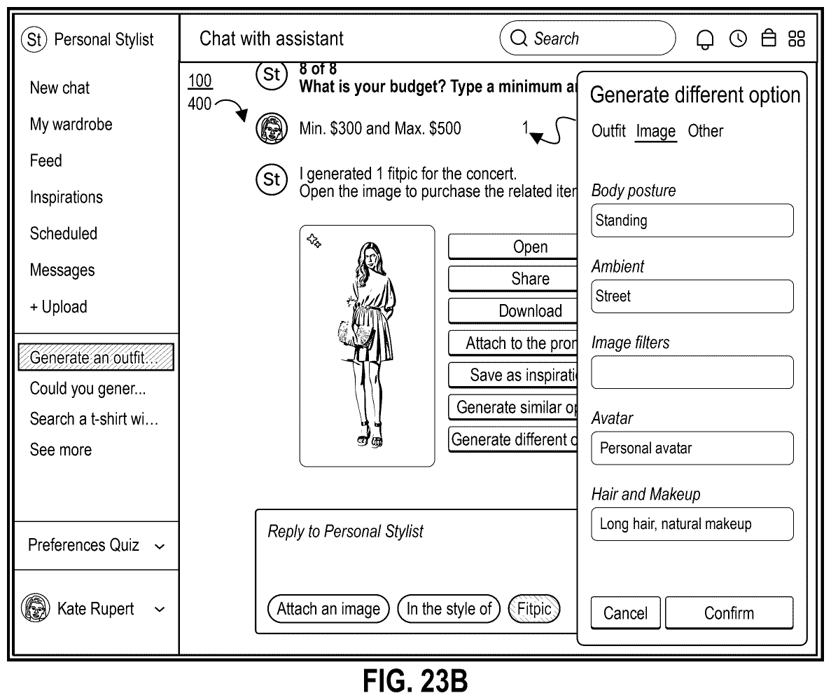

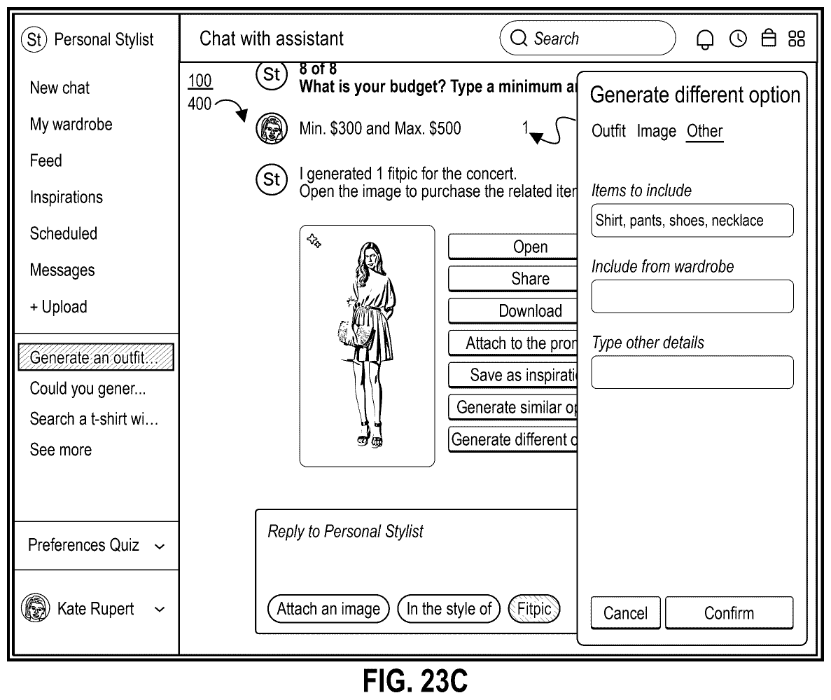

FIG. 23A The figure shows the panel that the system shows if the user clicks the button ‘Generate different option’. The figure shows the panel section ‘Outfit’ as selected. Descriptions of arrows: (1) The panel is opened and the Personal Stylist asks to fill some requests to better understand the user's needs, asking for the budget, colors, styles, type of outfit, materials. The user clicking on confirm will send a prompt to generate the new fitpic.

FIG. 23B The figure shows the panel section ‘Image’ as selected. Descriptions of arrows: (1) The panel in the section ‘Image’ asks for the body posture of the avatar that will wear the outfit, ambient, image filters, avatar to use (Personal or a generic avatar) and hair and makeup. The user clicking on confirm will send a prompt to generate the new fitpic.

FIG. 23C The figure shows the panel section ‘Other’ as selected. Descriptions of arrows: (1) The panel in the section ‘Other’ asks for the items to include, include from wardrobe, other details. The user clicking on confirm will close the panel and send a prompt to generate the new fitpic.

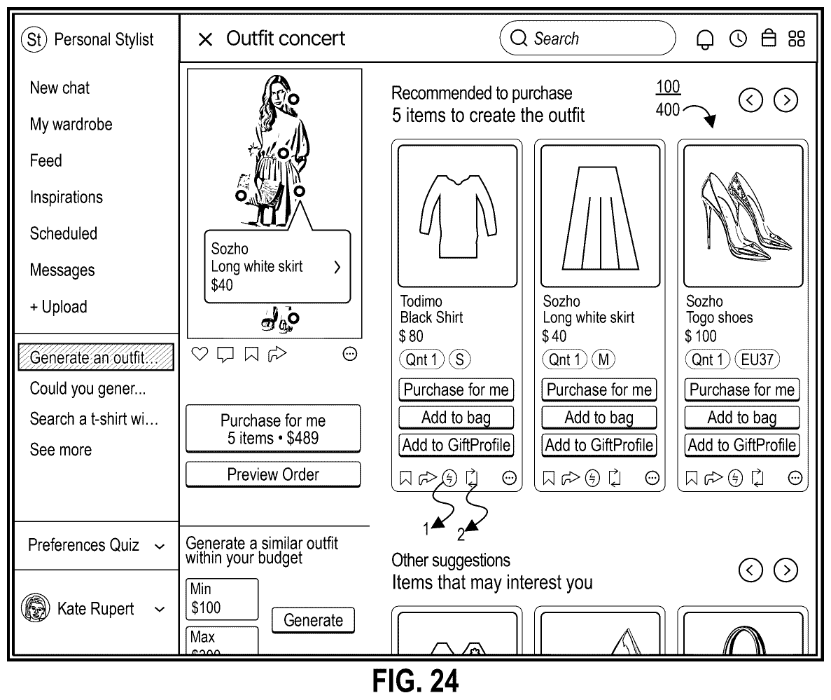

FIG. 24 When the Personal Stylist generates a fitpic and the user opens the image to see the related recommended items to purchase, it will be possible to see the list of items on the right side. Each item has some possible actions. Descriptions of arrows: (1) That figure makes a focus on the actions ‘Find another similar item’ and (2) ‘Find a different item’.

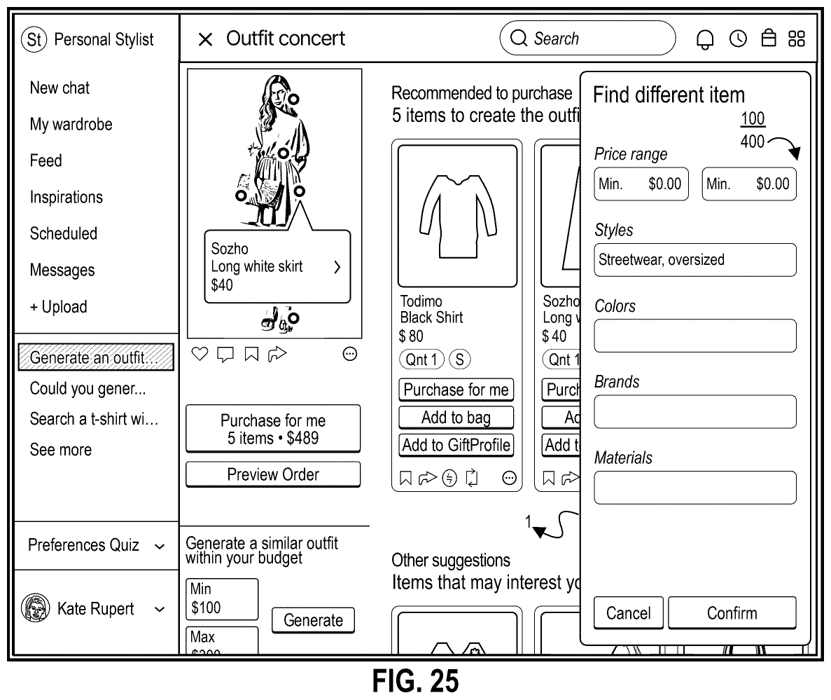

FIG. 25 If the user clicks on the button ‘Find a different item’ the system opens a panel to set a price range (also named budget), styles, colors, brands, materials (or other possible settings based on the type of the item). Confirming the panel will be closed and the Personal Stylist will find a different item that will replace the current item.

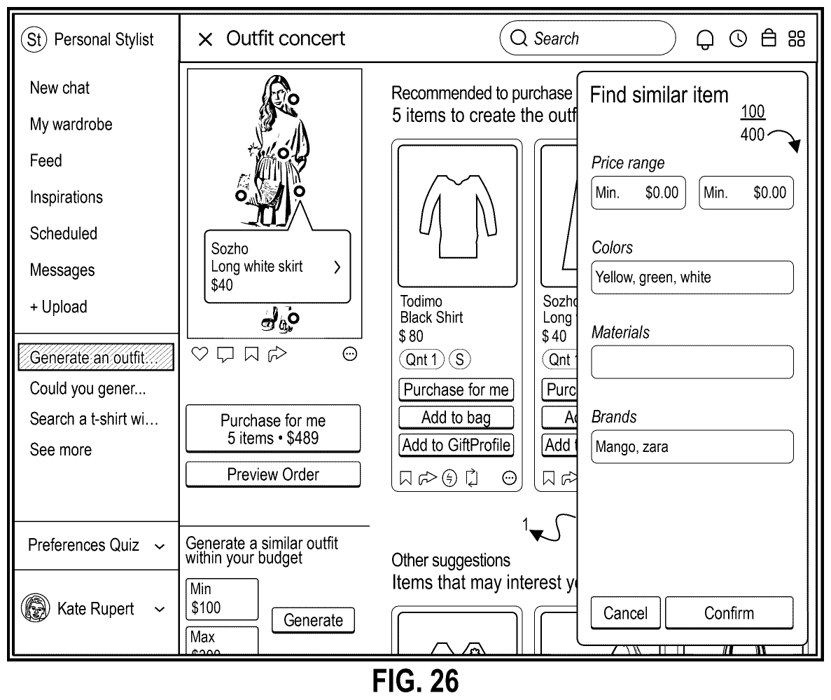

FIG. 26 If the user clicks on the button ‘Find a similar item’ the system opens a panel to set a price range (also named budget), colors, brands, materials (or other possible settings based on the type of the item). Confirming the panel will be closed and the Personal Stylist will find a similar item that will replace the current item.

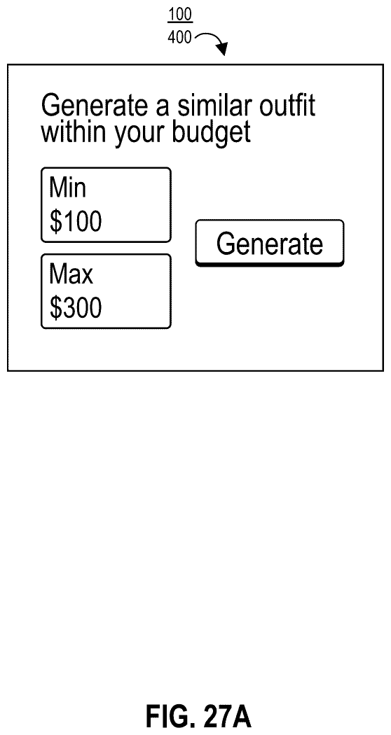

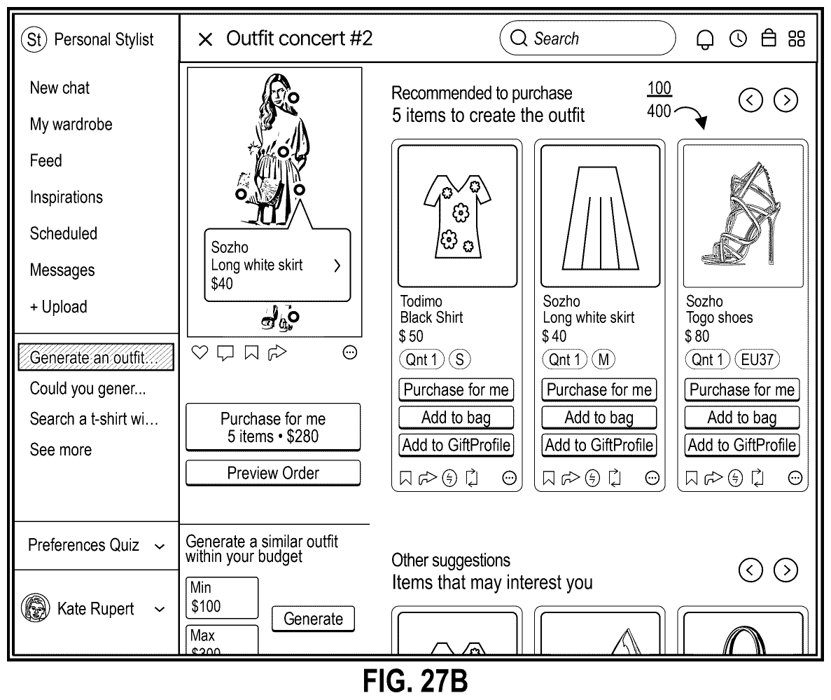

FIG. 27A The figure describes the process through which the user asks the Personal Stylist to generate a different fitpic with related items to purchase, within a specific budget. When the user visits the wardrobe of someone and there opens a fitpic, it will be possible for him to generate a new similar fitpic within a specific budget. The figures show a field for the minimum amount, the second field for the maximum amount. Then clicking on the button ‘Generate’ the Personal Stylist will generate a similar outfit but within the user budget.

FIG. 27B The figure shows a new outfit generated by the Personal Stylist. It's similar to the previous outfit but respects the user's budget.

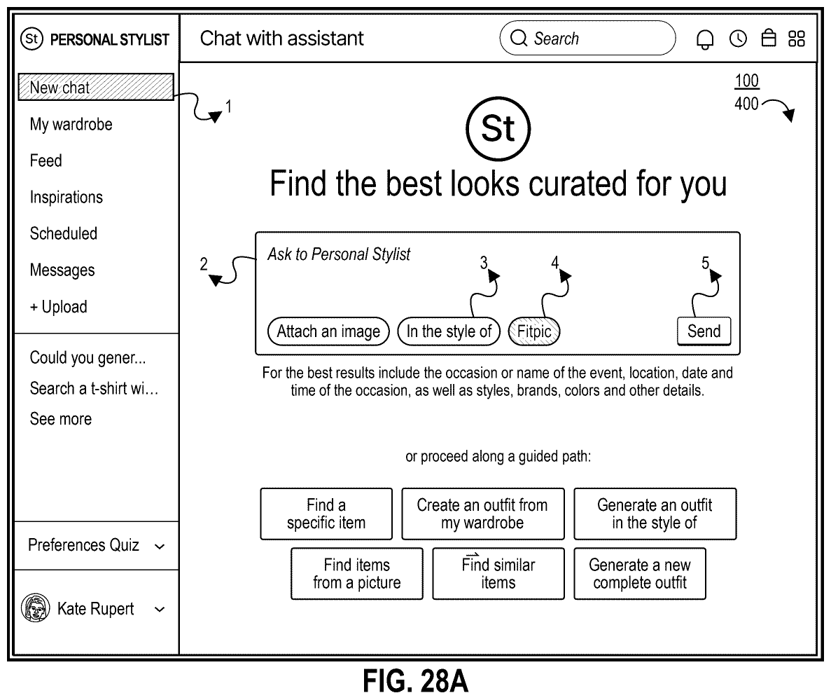

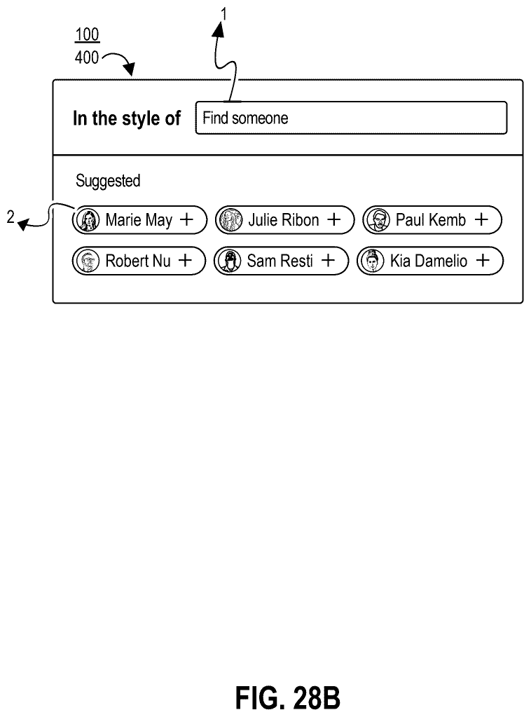

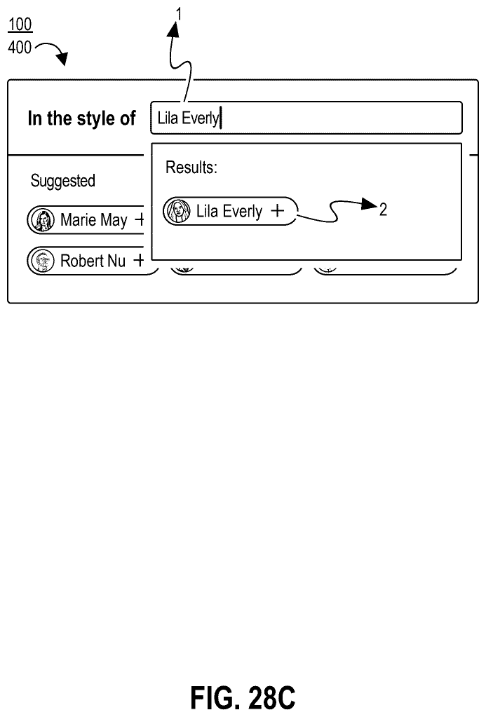

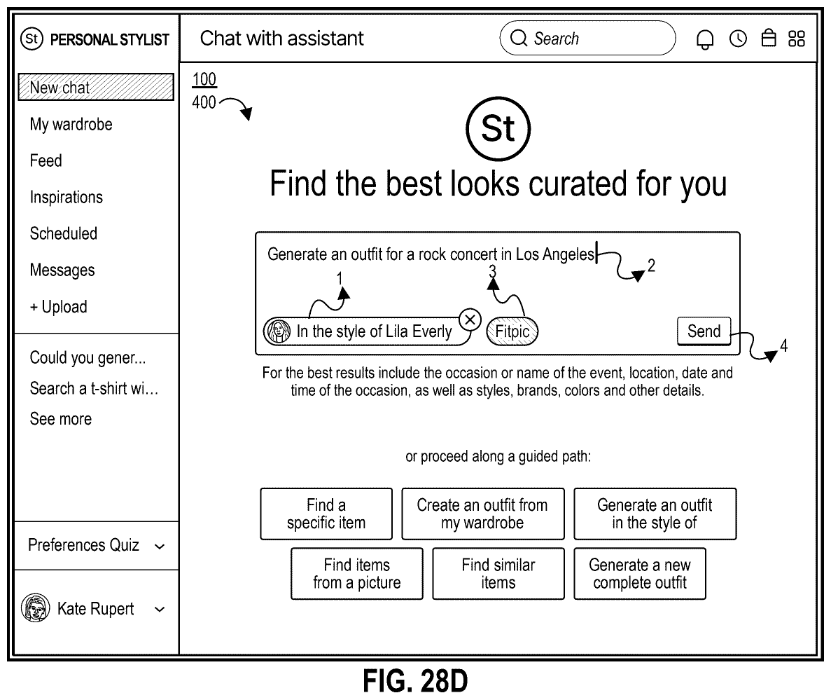

FIG. 28A The figure describes the access to the service. The user selecting the assistant ‘Personal Stylist’ through the nav bar, starts a new chat. The figures shows the possibility for the user to generate a fitpics and related items to purchase, selecting the option ‘In the style of’ through the prompt field. The user will select a profile and then ask the Personal Stylist to replicate a specific user-style. Descriptions of arrows: (1) The user selects on the sidebar to the left of the web page the option ‘New chat’ to start a new conversation. (2) The system shows a prompt field where the user can interact with the virtual assistant. (3) Inside the prompt field will appear some possible options to select, like the option ‘In the style of’. (4) The user selects the model ‘Personal Stylist’ to generate images of outfits (Fitpics) and related items that the user can purchase. (5) The user clicks the button ‘Send’ to send his request.

FIG. 28B The figure describes the process through which the user, clicking the option ‘In the style of’, can find the name of someone and generate an outfit or find one or multiple items in the style of the selected user. As consumers seek to emulate the styles of their favorite celebrities, movie characters, and influencers, there is a growing demand for tools that can provide tailored fashion recommendations that align with individual tastes and preferences. Users who want to emulate the styles of their favorite celebrities, movie characters, influencers, or not famous users can use this tool to find clothes or accessories that are in the style of these people. Each user will have their own ‘In the Style of’ button in their wardrobe profile and anyone can click on this button to generate an outfit or find one or more items in that style. The system is able in fact to analyze the style of each user and, when requested, to replicate the same style when generating a fitpic or recommending items to an user.

The main user clicking on the button ‘Generate in the style of’ or similar, asks the Personal Stylist to replicate the exact same style of the chosen user. There will appear a popup to find a profile, select it and then a prompt field with a selected filter option ‘In the style of [Full name of selected user]’ to type a prompt or just send the request. The Personal Stylist will start a questionnaire to better analyze the user needs (Name of the occasion, date and time, location, budget, etc.) that the user can skip. The questions depend on the user's prompt, if the prompt already includes this info Personal Stylist will directly generate the fitpic. Personal Stylist will take under consideration also the user's Preferences, expressed in the registration process (Sizes, body measurements, etc.) and during the Preferences Quiz (Favorite brands, favorite brands, favorite materials, etc.). Personal Stylist will be able to generate fitpics and recommend items to purchase based on the main user's preferences and the style of the person chosen by the main user. Descriptions of arrows: (1) The user clicks on the button ‘In the style of’ (FIG. 3A arrow 3). The system shows a popup where it will be possible to type the name of the user whose style he wants to replicate. The user can type a username of a wardrobe or simply the full name of someone. (2) The system suggests some user-profile (also named ‘Wardrobes’) to choose to replicate their style.

FIG. 28C The figure describes the process through which the user finds the name of a user whose style he would like to replicate. Descriptions of arrows: (1) The user types the name of a person. (2) The system shows a result. The user can click on the profile ‘Lila Everly’ to replicate the style of Lila Everly.

FIG. 28D The figure shows how the chosen profile is added inside the prompt field. In the prompt field the user adds an additional request typing a prompt. The Personal Stylist will generate a result based on the selected option ‘In the style of Lila Everly’, the prompt written manually by the user, any answers to questions that will be asked to the user in the conversation with the Personal Stylist and the user's general preferences. Descriptions of arrows: (1) The system shows the selected option ‘In the style of Lila Everly’ inside the prompt field. (2) The user types a prompt ‘Generate an outfit for a rock concert in Los Angeles’. (3) The user selects the model ‘Personal Stylist’ to generate one or multiple fitpics (image of outfit and related items to purchase). The alternative will be ‘Personal Stylist only items more simple, which does not generate images but directly recommends, after a conversation with the user, one or a group of items to purchase to create an outfit. (4) The user clicks the button ‘Send’ to send his request to Personal Stylist.

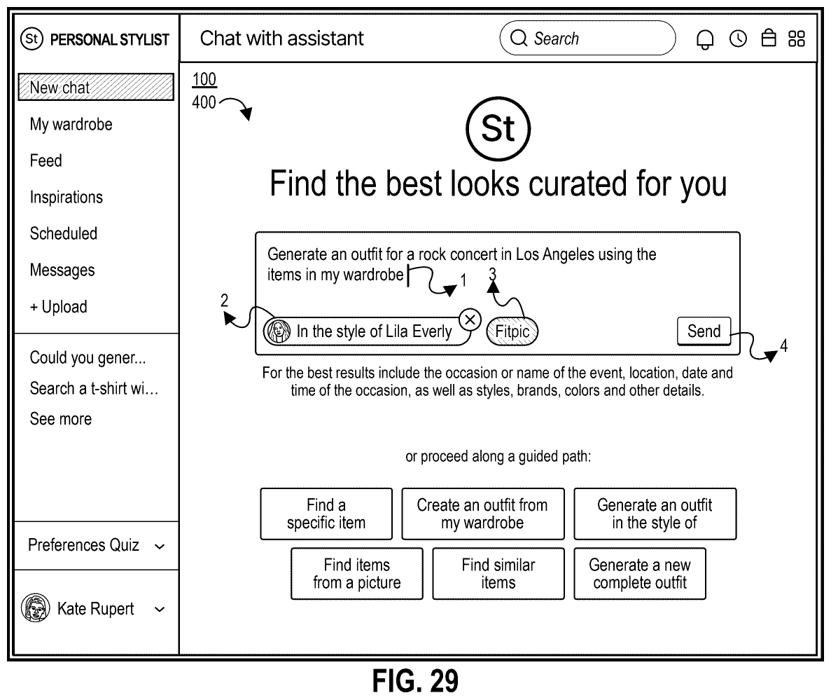

FIG. 29 The figure shows how the user instead of creating a new fitpic with related items to purchase, asks the Personal Stylist to create a fitpic using his items (Items uploaded to his profile-wardrobe that he already owns in real life, already purchased). The user can ask to generate a new outfit with new items to purchase, with items he already owns or a mix of owned items and items to be purchased. Descriptions of arrows: (1) The user type the prompt ‘Generate an outfit for a rock concert in Los Angeles using the items in my wardrobe’. (2) The user adds the option ‘In the style of Lila Everly’. (3) The user selected the model ‘Personal Stylist’ to generate one or more fit pics with related items (Items the user already owns). (4) The user clicks the button ‘Send’ to send the request. The Personal Stylist in that case doesn't have some information like ‘Occasion’, ‘Location of the occasion’, ‘Date and time of the occasion’, etc. so will start a conversation asking some questions related to the missed information. The user can skip the questions or the entire questionnaire to directly generate the fitpic and related items.

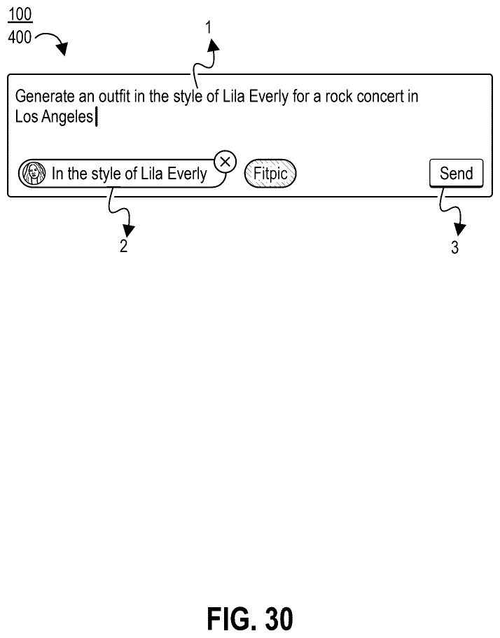

FIG. 30 The figure shows another way for the user to communicate to the Personal Stylist that he would like to generate an outfit in the style of someone. In this specific figure the main user manually wrote in the prompt the word ‘in the style of [Full name of the user]’ and the system will automatically select the option on the bottom. Just typing in a natural language the user is able to communicate to the Personal Stylist his intentions. Descriptions of arrows: (1) The user types the prompt ‘Generate an outfit in the style of Lila Everly for a rock concert in Los Angeles’. (2) The system automatically shows the option ‘In the style of Lila Everly’ as selected. (3) The user clicks the button ‘Send’ to send his request to Personal Stylist.

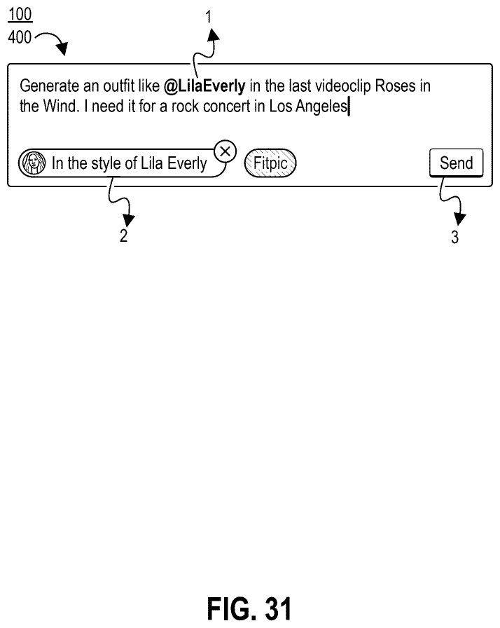

FIG. 31 The figure shows another way for the user to communicate to the Personal Stylist that he would like to generate an outfit in the style of someone. In this specific figure the main user manually tagged the wardrobe of an user, typing the symbol ‘@’ and typing the name or username of the user whose style he wanted to replicate, in that case ‘@LilaEverly’, without mentioning the word ‘Style’ or ‘In the style of’. The user also mentions in the prompt a more specific context of use of a certain very specific style ‘last video clip Roses in the Wind’. The system will be able to recognize the user's intentions and automatically select the option on the bottom ‘In the style of Lila Everly’. The system will be able to recognize the context where a specific style is used to replicate exactly the same style and ambient in the fitpic. Just tagging someone in a natural language and mentioning a context where a style is used, the user is able to communicate to the Personal Stylist his intentions. Descriptions of arrows: (1) The user types the prompt ‘Generate an outfit like @LilaEverly in the last videoclip Roses in the Wind. I need it for a rock concert in Los Angeles’. (2) The system automatically shows the option ‘In the style of Lila Everly’ as selected. (3) The user clicks the button ‘Send’ to send his request to Personal Stylist.

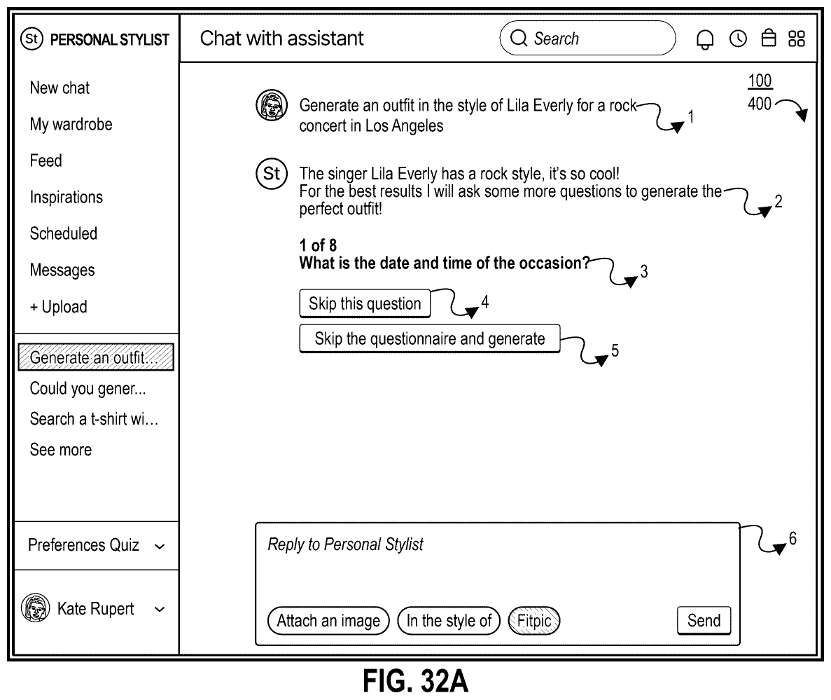

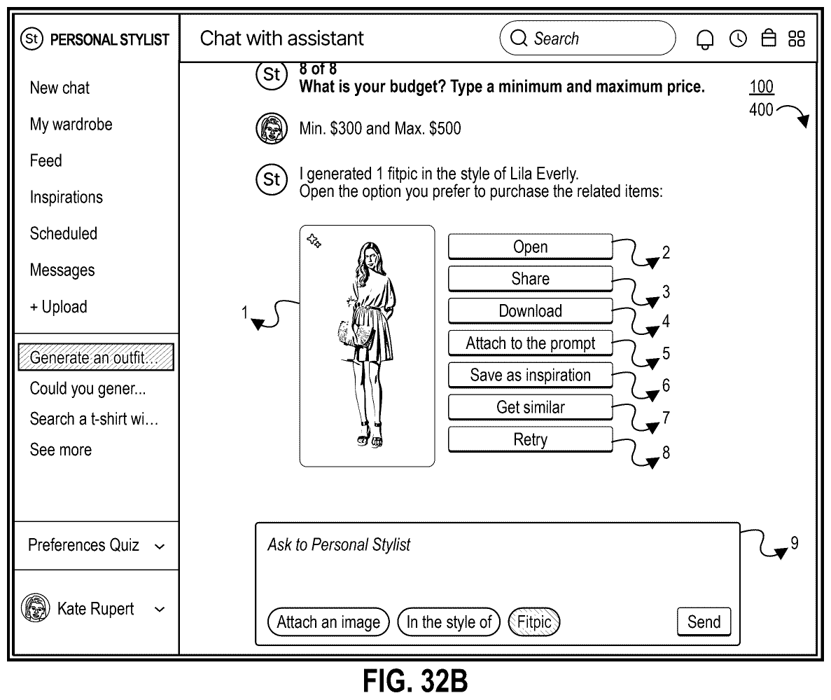

FIG. 32A The figure shows the conversation started after the user clicks the button ‘Send’ in the prompt field. The system will automatically update, in the panel to the left side, the chat history with the new prompt. The Personal Stylist will generate an outfit in the style of the selected user but it still needs some more extra info, starting with a questionnaire the user can answer or skip. Descriptions of arrows: (1) The user sent the prompt ‘Generate an outfit in the style of Lila Everly for a rock concert in Los Angeles’. (2) Personal Stylist responds ‘The singer Lila Everly has a rock style, it's so cool! For the best results I will ask some more questions to generate the perfect outfit!’. (3) The Personal Stylist starts the questionnaire based on missed info of the user's prompt. In that case the occasion is clear (Rock concert) and the location too (Los Angeles). The Personal Stylist shows the number of the questions and asks ‘1 of 8—What is the date and time of the occasion?’. (4) The user clicks the button ‘Skip this question’ to skip this specific question. (5) The user clicks the button ‘Skip the questionnaire and generate’ to skip the entire questionnaire and generate the fitpic. (6) The user replies by typing the answers in the prompt field.

FIG. 32B The figure shows the result. Descriptions of arrows: (1) Personal Stylist generated a fitpic. (2) The user clicks the button ‘Open’ to open the fitpic to see the related items to purchase, tagged inside the picture, (3) ‘Share’ to share it to someone, in the feed, or on social networks, (4) ‘Download’ to download the image, (5) ‘Attach to the prompt’ to attach the generated image in the prompt and ask more, (6) ‘Save as inspiration’ to save the image and related items in the personal saved inspirations, (7) ‘Get similar’ to generate a new similar fitpic with other items maybe in a different budget and (8) ‘Retry’ to generate a new different option. (9) The user is able to start a new request by typing a new prompt in the field.

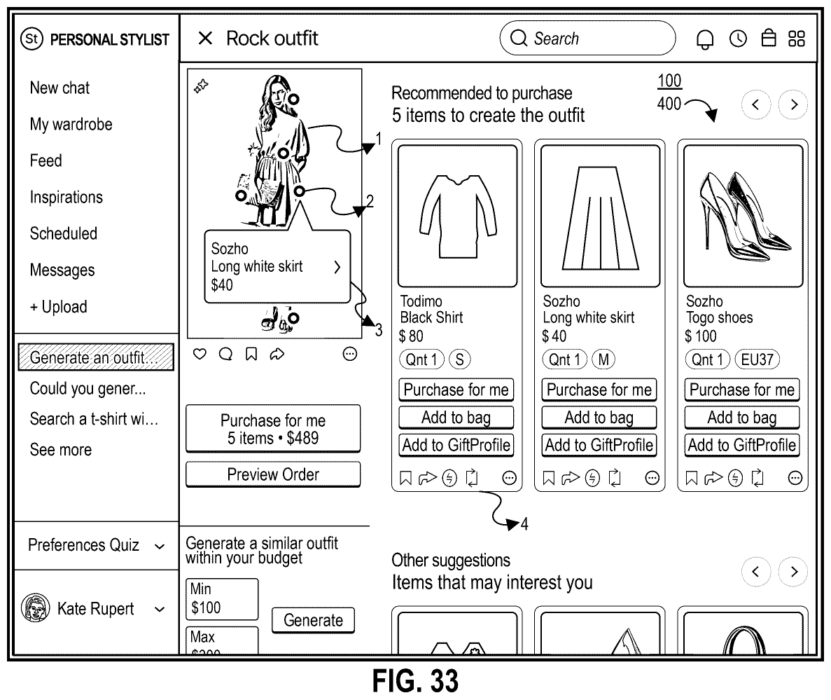

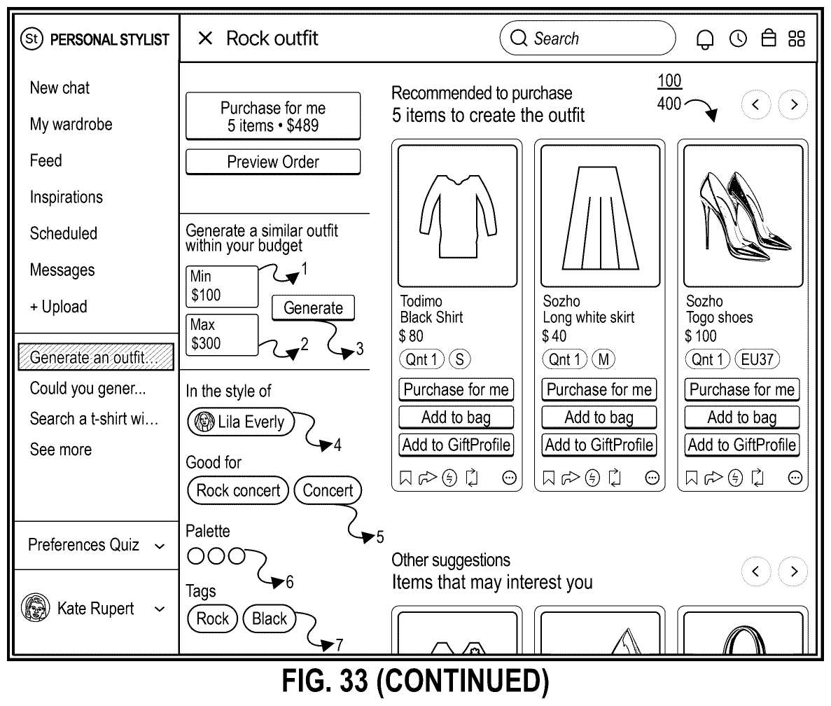

FIG. 33 The figure shows the opened fitpic in a dedicated webpage. It's the page where the user can see more info about the generated fitpic, it shows the avatar of the user wearing the outfit or a generic model and see the list of related items to purchase to create the same outfit. Descriptions of arrows: (1) The system shows the generated Fitpic, (2) shoppable tags (Item links) (3) and the popup with the item preview (Brand, item name and price). It's a link to the item the user can also see on the right side (List of related items). (4) The page shows the list of related items, they are the items the Personal Stylist recommends to purchase to recreate the same outfit of the generated image.

FIG. 33 (Continued) The figure shows the scrolling of the page, showing the information about the generated fitpic in the style of a specific user. Descriptions of arrows: (1) The user scrolling the page is able to generate a similar outfit in a different budget, just typing a minimum value, (2) a maxim value, and (3) clicking the button ‘Generate’. In that case a new picture will be generated and other related items list will be created, in the chosen different budget, but with the same user's preferences previously expressed in the conversation with the Personal Stylist (Little questionnaire). In fact also the new outfit will be ‘In the style of [Chosen user]. (4) The system shows that the generated fitpic is in the style of ‘Lila Everly’ (5) showing some more info like ‘Good for’, (6) palette with all outfit colors (7) and other tags.

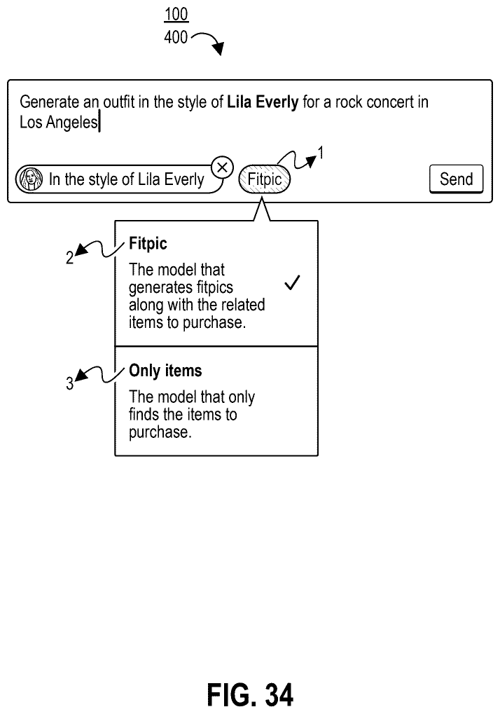

FIG. 34 The figure shows in detail the prompt field with the selection of a different Personal Stylist model. Descriptions of arrows: (1) The user clicks the selected model in the prompt field. (2) The system shows two options that the user can select. The first option is ‘Personal Stylist—The model that generates fitpics along with the related items to purchase’, it is the model to generate one or more fitpics (image) and the related recommended items list. (3) The second option is ‘Personal Stylist only items—The model that only finds the items to purchase’, it is the model to generate just one or more items, directly the recommended items to purchase without any image.

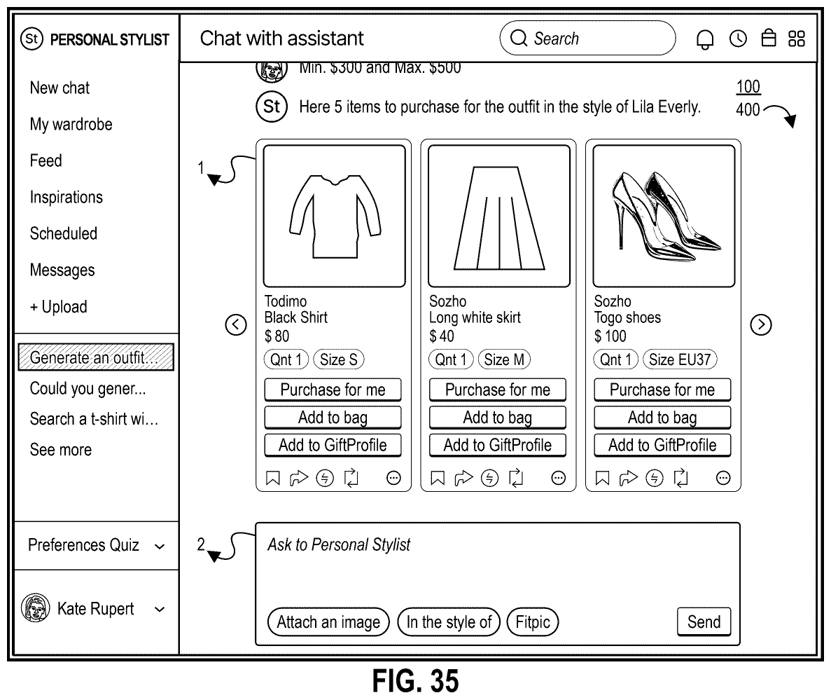

FIG. 35 The figure shows the conversation with Personal Stylist Only items (in that case the user selected the model to only have the list of items without any images). Descriptions of arrows: (1) Personal Stylist Only items model generates the list of items to purchase for a new outfit in the style of ‘Lila Evely’ directly in the conversation, without generating fitpics. (2) The user can start a new conversation just typing a new prompt. Generating ‘in the style of’ means for the Personal Stylist to recommend a list of items that are in the style of a specific person.

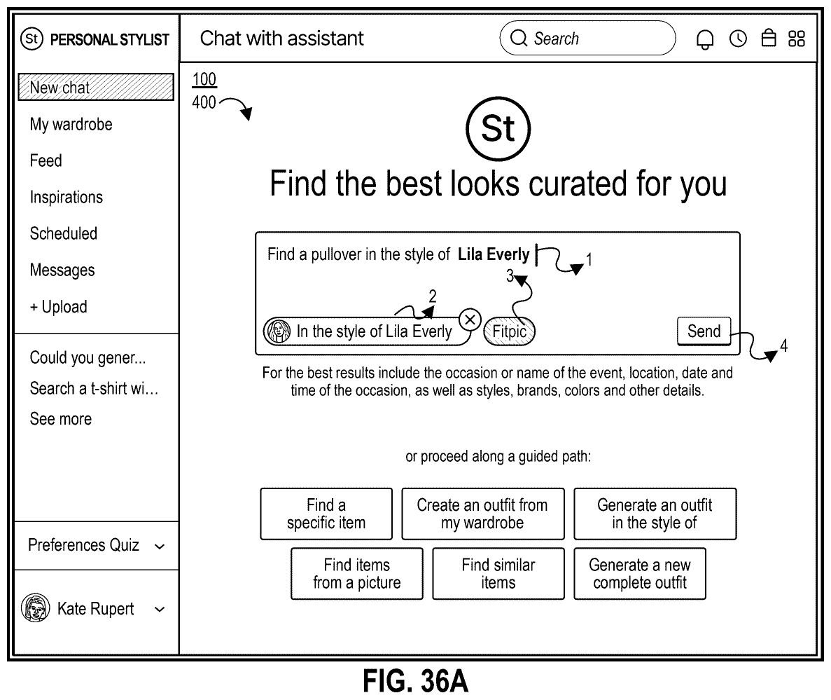

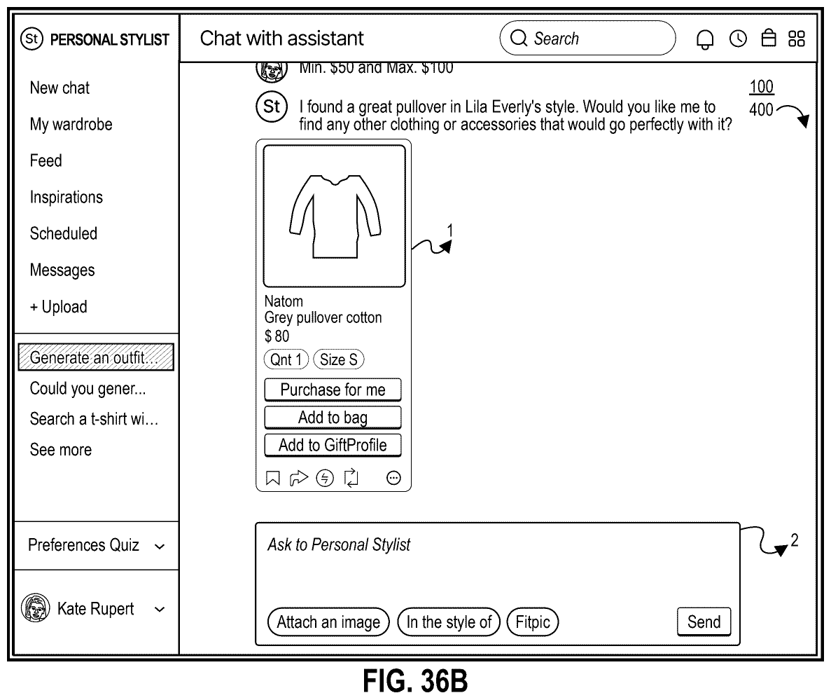

FIG. 36A The figure shows the user to find a specific item but ‘In the style of a specific person’. Descriptions of arrows: (1) The user types the prompt ‘Find a pullover in the style of Lila Everly’ manually mentioning an user. (2) The system automatically selects the option ‘In the style of Lila Everly’. (3) The user selects the model ‘Personal Stylist Only items’ to directly receive the list of recommended items to purchase in the style of, without any fitpics. (4) The user clicks the button ‘Send’ to send the request and start the conversation with Personal Stylist.

FIG. 36B The figure shows the conversation with Personal Stylist Only items who is recommending an item in the style of Lila Everly. Descriptions of arrows: (1) Personal Stylist recommend in the conversation the item that the user can purchase. (2) The user can start a new conversation by typing a new prompt.

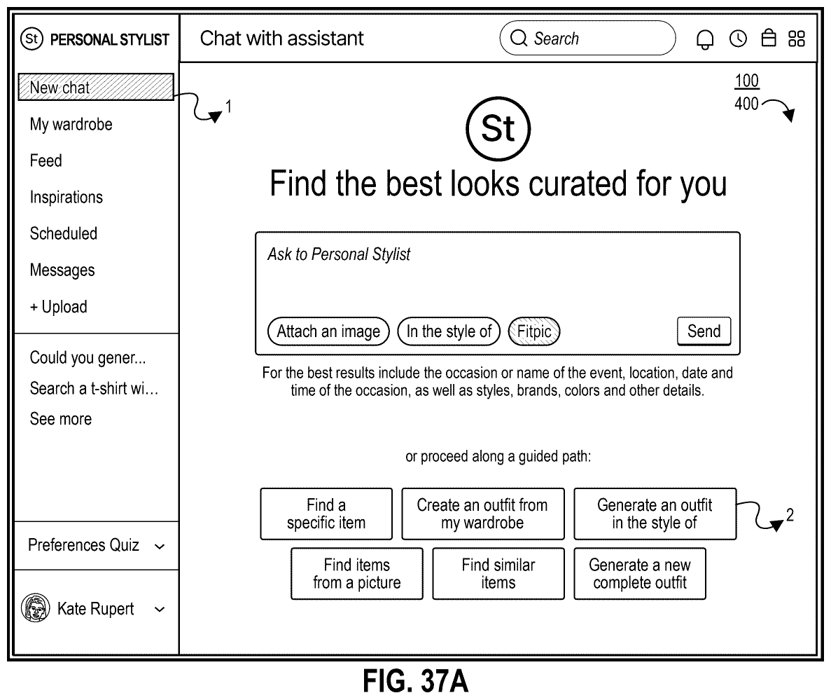

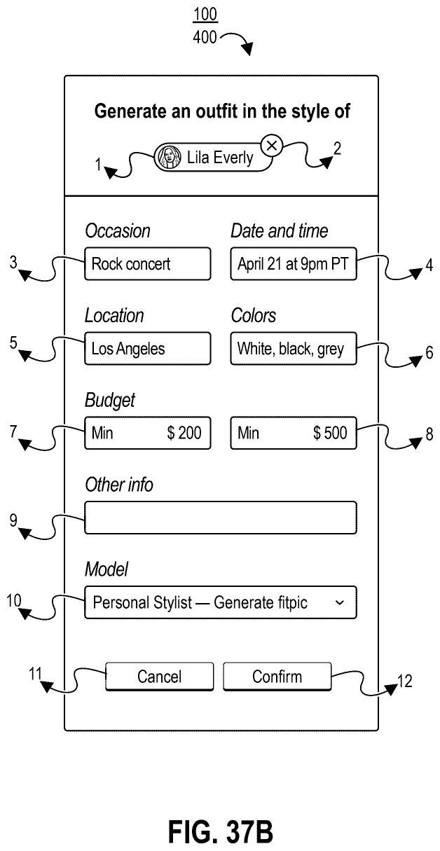

FIG. 37A The figure describes the process through which the user uses a gadget (Guided path) to generate an outfit ‘In the style of someone’. Descriptions of arrows: (1) The user visits the page related to Personal Stylist assistant, clicking to the option ‘New chat’ in the panel on the left side. (2) The user clicks the button ‘Generate an outfit in the style of’.

FIG. 37B The figure describes the process through which the user chooses an user and completes all the info to generate an outfit in the style of someone. Descriptions of arrows: (1) The user selected an user. (2) The user clicks the button ‘Delete’ to delete the added user and return back. (3) The user completes all the requests with no prompts to type. It's a faster way to communicate personal needs with the Personal Stylist. The user completed the fields about ‘Occasion’, (4) ‘Date and time of the occasion’, (5) ‘Location’, (6) ‘Colors’, (7) Budget with a minimum value and (8) maximum value, (9) other info to share, (10) type of model. (11) The user clicks the button ‘Cancel’ to close the popup. (12) The user clicks the button ‘Confirm’ to send the request and starts a conversation with Personal Stylist that will automatically generate an outfit or just recommends the items.

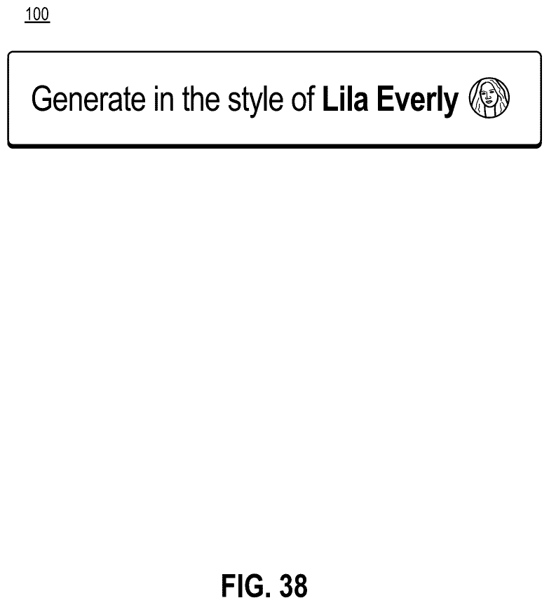

FIG. 38 The figure shows in detail the button ‘Generate in the style of Lila Everly’ which may appear in Lila Everly's wardrobe-profile or under any of her published content that appears in general feed. The button has a fixed part with the text ‘Generate in the style of’ and a variable part consisting of the user's name with his/her wardrobe profile image.

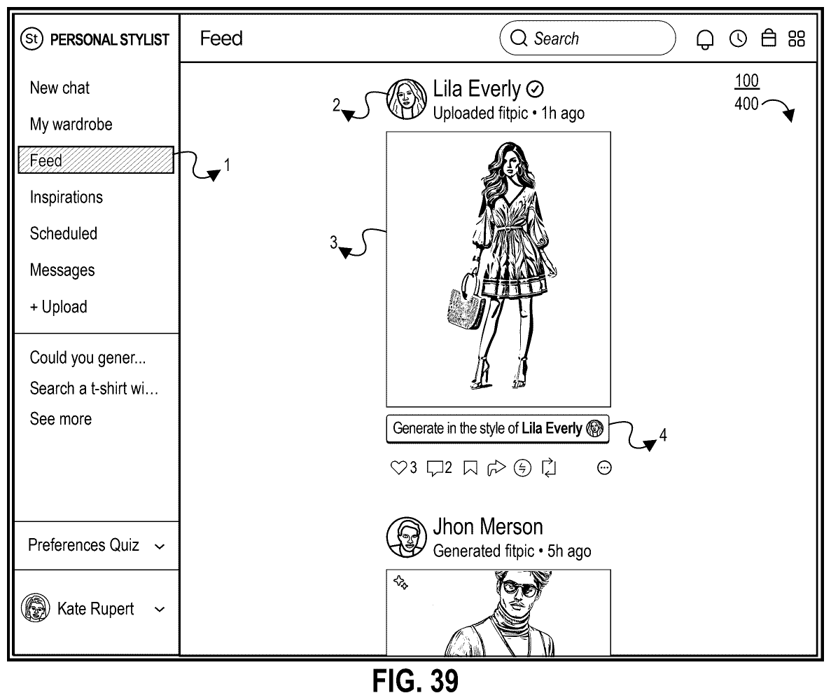

FIG. 39 The figure shows how the button ‘Generate in the style of’ will appear in Feed. Descriptions of arrows: (1) The user visits the page ‘Feed’. (2) In the feed will appear all contents published by the following users. The posts show the full name Lila Everly and wardrobe profile picture, (3) fitpic, item or other content, (4) the button ‘Generate in the style of Lila Everly’ the user can directly click to instantly generate a new outfit.

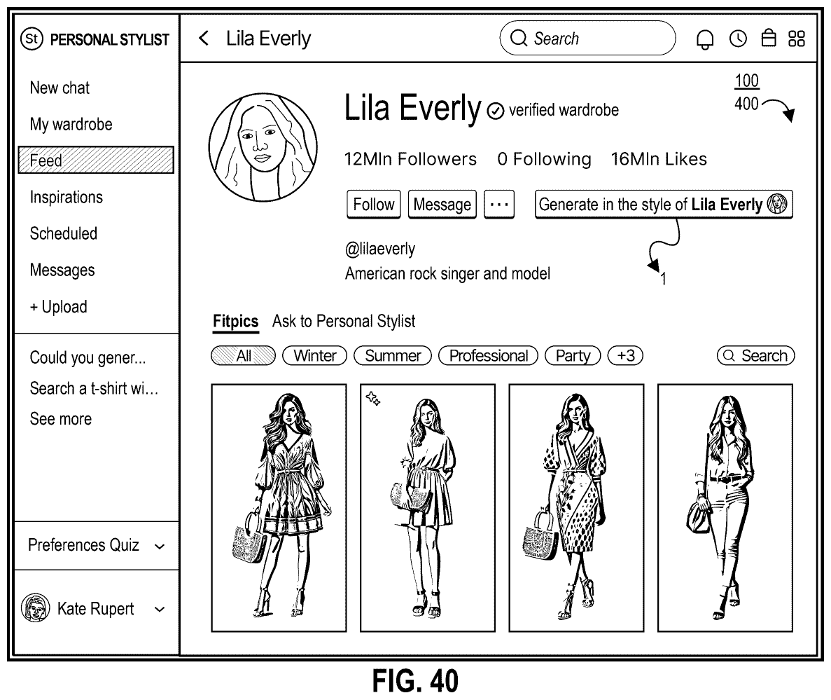

FIG. 40 The figure shows how the button ‘Generate in the style of’ will appear in the user wardrobe-profile. Descriptions of arrows: (1) The user visiting the wardrobe profile of Lila Everly can find the button ‘Generate in the style of Lila Everly’ to instantly generate a new outfit.

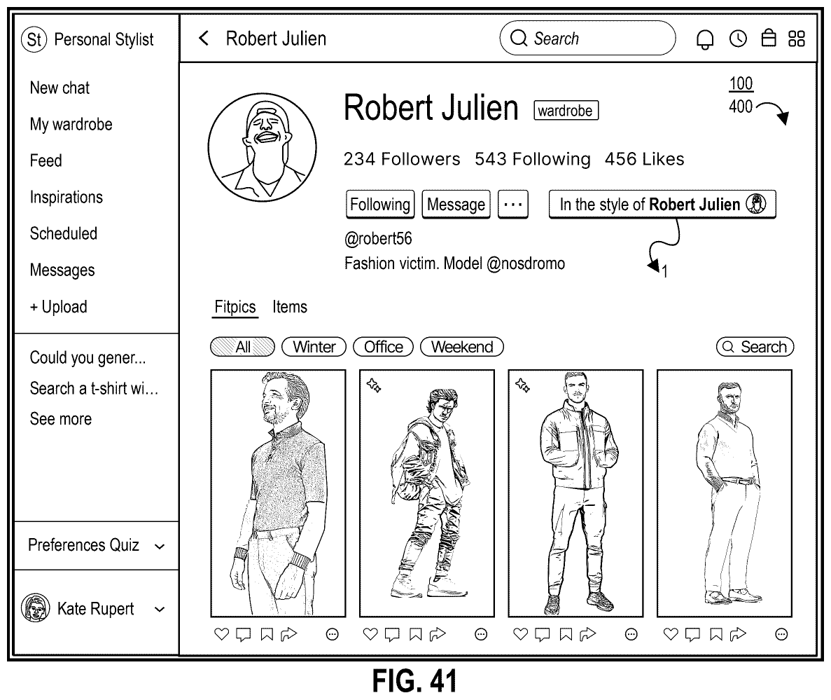

FIG. 41 The figure describes the scenario where a female user tries to generate an outfit in the style of someone with male gender (someone of the opposite gender). Descriptions of arrows: (1) The user visits a male user's wardrobe and clicks on the button ‘Generate an outfit in the style of [Name Surname or Username of the male user]’.

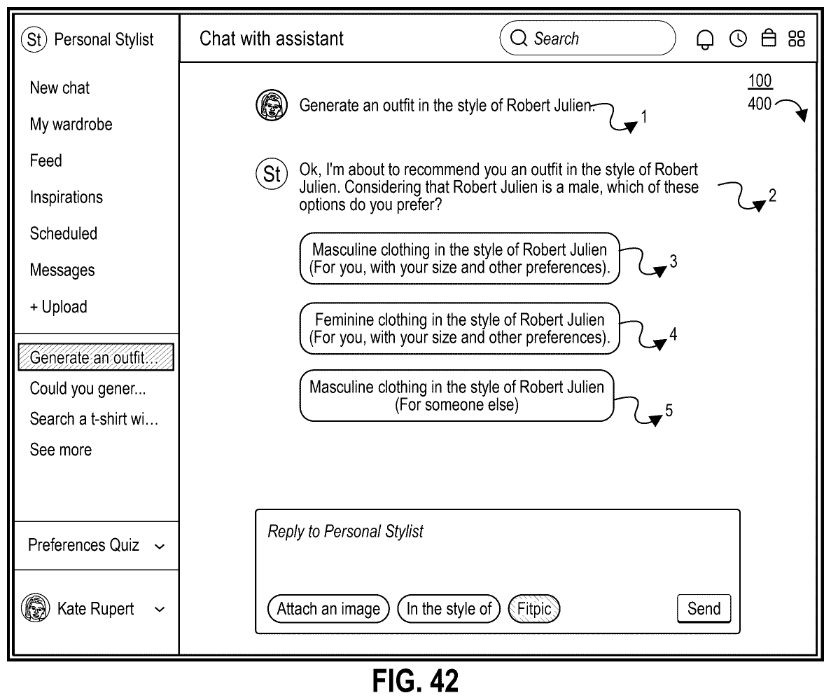

FIG. 42 The figure describes the chat between user and Personal Stylist. The female user asked to generate an outfit in the style of someone of the opposite gender. Personal Stylist will ask to choose an option to continue. Descriptions of arrows: (1) The user asks to ‘Generate an outfit in the style of Robert Julien.’ The main user is a female person, Robert Julien is male. (2) The personal Stylist replied saying: ‘Ok, I'm about to recommend you an outfit in the style of Robert Julien. Considering that Robert Julien is a male, which of these options do you prefer? ’ Personal Stylist shows three options: (3) Masculine clothing in the style of Robert Julien (For you, with your size and other preferences), (4) Feminine clothing in the style of Robert Julien (For you, with your size and other preferences) and (5) Masculine clothing in the style of Robert Julien (For someone else). By choosing one of the three options, the user continues the chat with the assistant to generate the desired outfit.

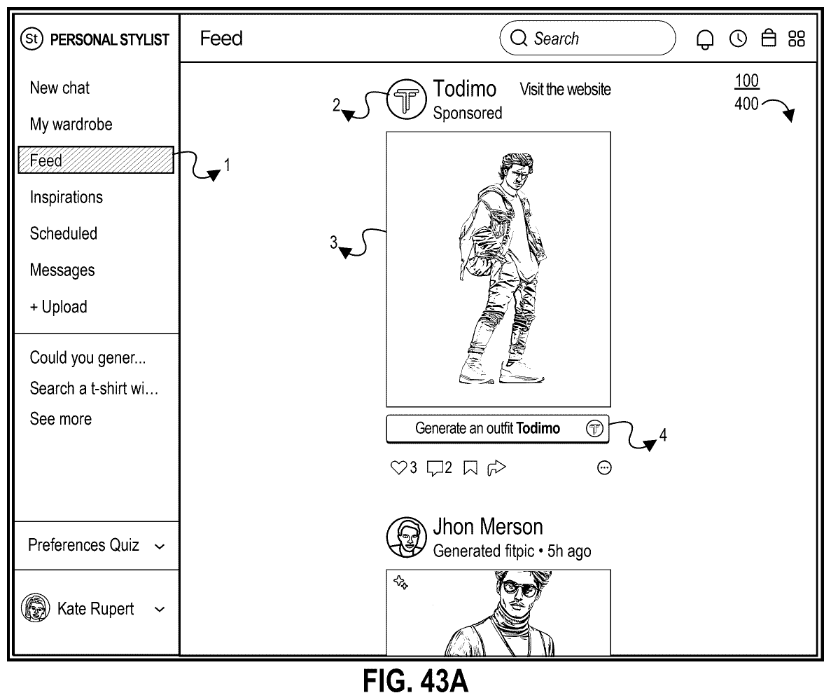

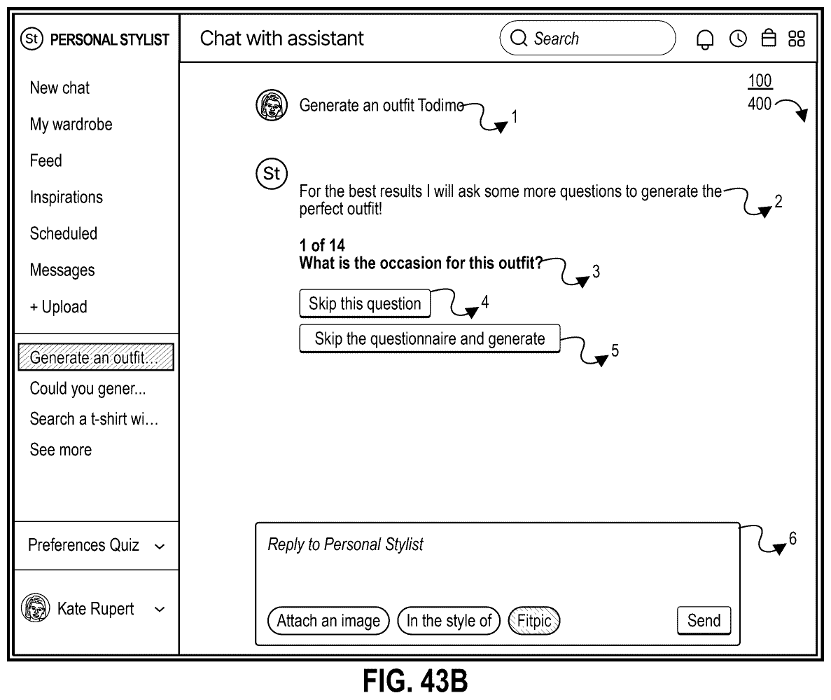

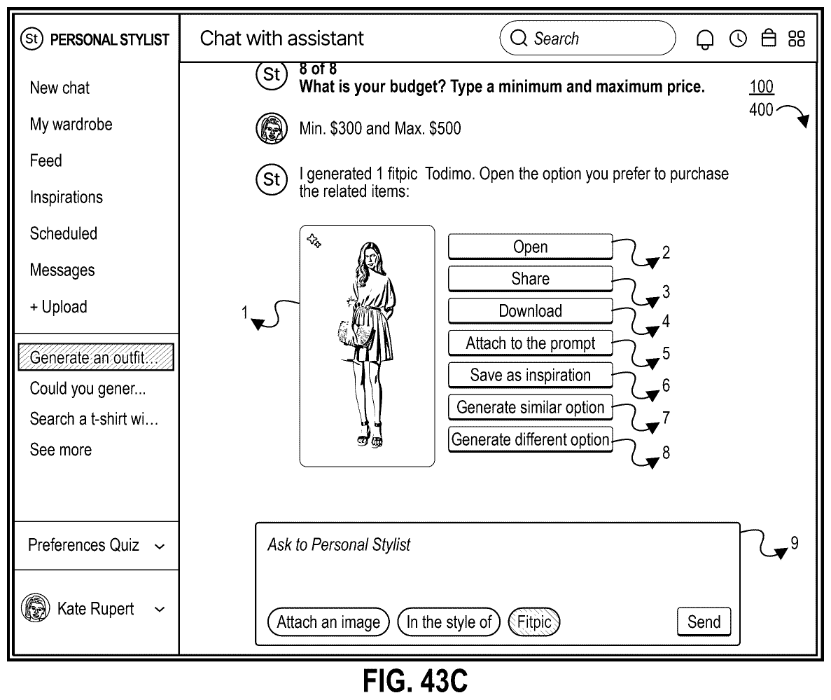

FIG. 43A The figure describes the process through which the user in the feed finds content published by a brand and interacts with the button ‘Generate an outfit [Brand name]’. Wardrobes of brands in fact don't have the button ‘In the style’ but they have this different button, thanks to that button users can generate outfits only with items of that brand. Descriptions of arrows: (1) The user selects ‘Feed’ in the sidebar to the left. (2) The brand Todino publishes content in its wardrobe and it appears also in the feed for other users. (3) The brand Todino publishes a fitpic. (4) The button ‘Generate an outfit Todino’ is available related to the brand ‘Todino’.

FIG. 43B The figure shows the chat between the user and the Personal Stylist after clicking on the button “Generate an outfit Todino’. Descriptions of arrows: (1) The user prompts ‘Generate an outfit Todimo’. (2) The Personal Stylist replies ‘For the best results I will ask some more questions to generate the perfect outfit! ’ and (3) Personal Stylist shows the number of questions that will be asked to the user ‘1 of 14—What is the occasion for this outfit? ’. (4) The user can skip the question or (5) skip the questionnaire and generate the fitpic. (6) The user can answer the questions by typing in the prompt field.

FIG. 43C The Personal Stylist generates a result (Fitpic with related recommended items to purchase). Descriptions of arrows: (1) The Personal Stylist generates the fitpic (Image of the personal or generic avatar wearing an outfit) with the recommended outfit (real items the user can purchase) on the preferences and budget selected by the user. (2) The user clicks the button ‘Open’ to open the image and see the recommended items to purchase. As an alternative the user can directly click/tap on the generated image. (3) The user clicks the button ‘Share’ to share the generated content and related items in a private message, on social networks, on the personal wardrobe (then automatically shared on the feed). (4) The user clicks the button ‘Download’ to download the image. (5) The user clicks the button ‘Attach to the prompt’ to attach the image in the prompt field to ask the Personal Stylist something related to the image. (6) The user clicks the button ‘Save as inspiration’ to save the image and related items to purchase in the section ‘Saved’ of personal wardrobe. That section is totally private. (7) The user clicks the button ‘Generate similar option’ to generate an alternative fitpic very similar following other user's preferences that the user can manually set in a panel. (8) The user clicks the button ‘Generate different option’ to generate a totally different fitpic following other user's preferences that the user can manually set in a panel. (9) The user can prompt new requests replying to the Personal Stylist.

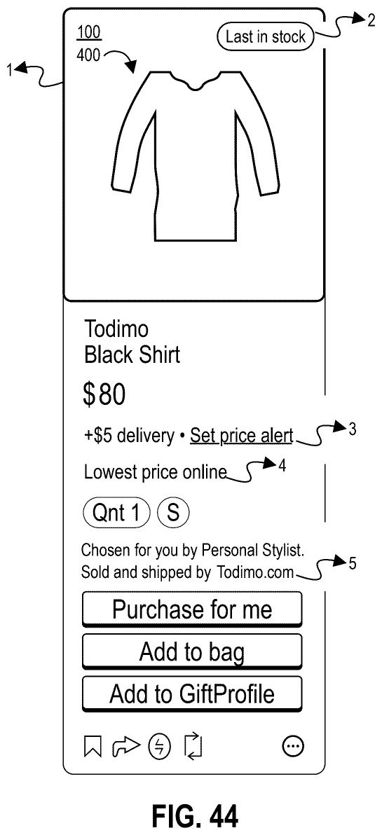

FIG. 44 The figure describes the process through which the user visualizes a recommended item. Descriptions of arrows: (1) The Personal Stylist recommends a list or one item (based on the request of the user). (2) The system could show the label ‘Last in stock’ to indicate that it is the last item sold by the selected seller. (3) The system shows the button ‘Set price alert’ thanks to which a user can visualize the price history related to the selected seller and other sellers, and receive notifications if the price reaches a certain threshold specified by the user. When the price reaches a certain threshold the system offers the possibility of setting the automatic purchase of the product at that specific price with the feature ‘Purchase for me’. (4) The label ‘Lower price online’ appears to indicate that the item has the lowest price online, no other sellers have that price. (5) The system shows the label ‘Sold and shipped by . . .’ with the possibility to read about shipping and returns policies offered by the seller (store online).

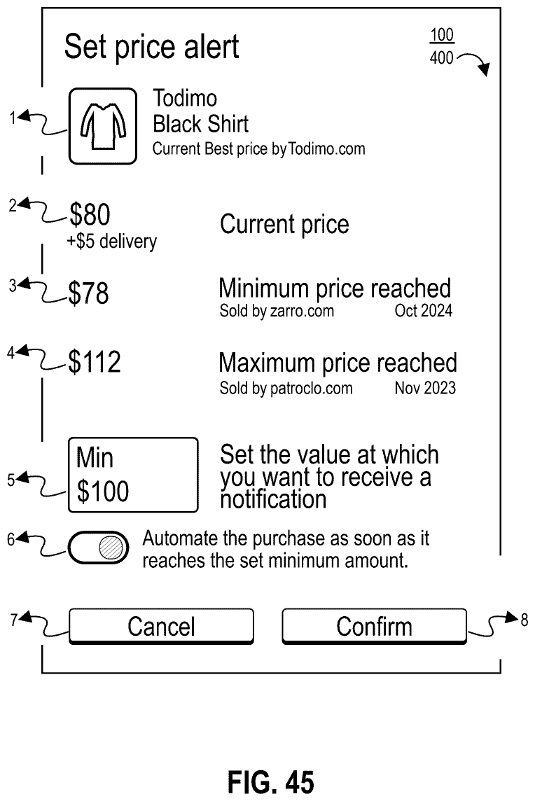

FIG. 45 The figure describes the process through which the user visualizes the ‘Set price alert’ view. Descriptions of arrows: (1) The item is visible on the top with the text ‘Current best price by [Seller name]’. (2) The system shows the price history related to the selected seller (Current price). (3) The system shows the ‘Minimum price reached online’, (4) the ‘Maximum price reached online’, (5) the possibility to ‘Set the value at which you want to receive a notification. It is the price for which the customer would like to purchase that item. And set the Price alert to be notified when that particular item at that specific price. (5) The user can enable the feature to ‘Automate the purchase as soon as it reaches the set minimum amount’. The system that is aware of the user's preferences, the payment method previously set and the user's shipping address to the possibility of automatically purchasing the product at that price is set with the feature purchase for me. (7) The user clicks the ‘Cancel’ button to close the process or (8) clicks the ‘Confirm’ button to confirm the changes.

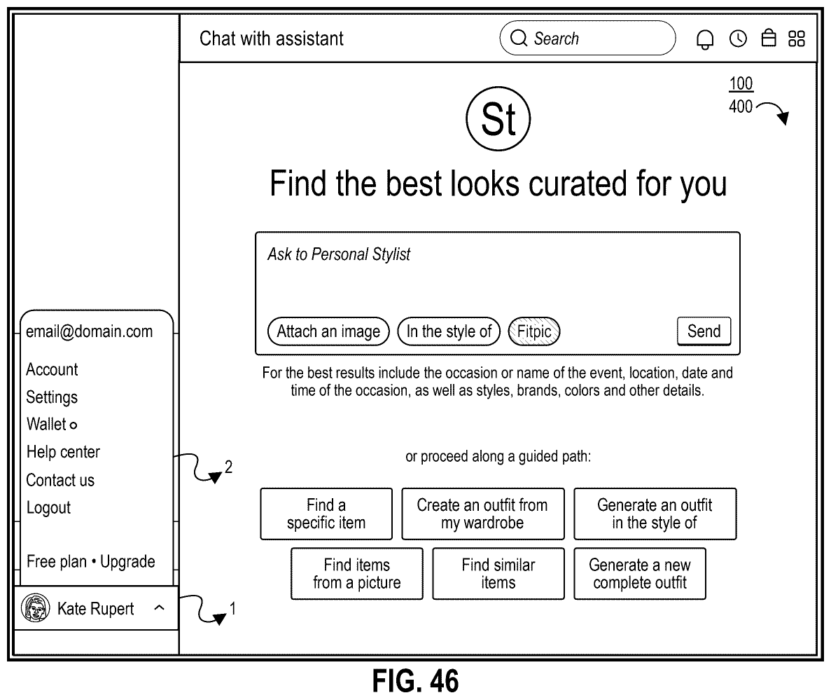

FIG. 46 The figure describes the process through which the user visualizes a view, clicking on the personal image and full name on the sidebar, it opens the view to see more actions to access: account management, settings, wallet, help center, contact support, logout and plan management. Descriptions of arrows: (1) The user clicks on his name on the sidebar to the left and (2) opens a view to access more features.

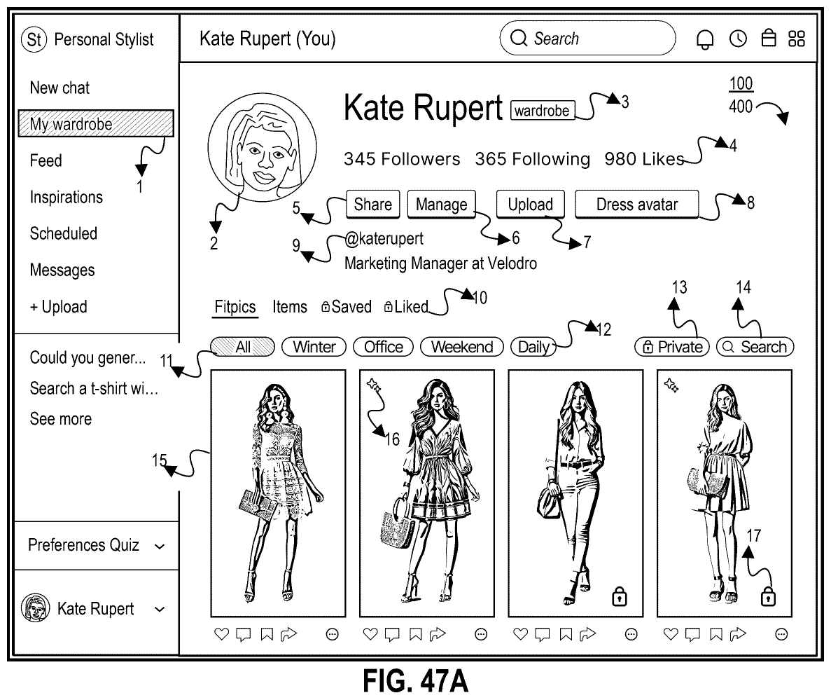

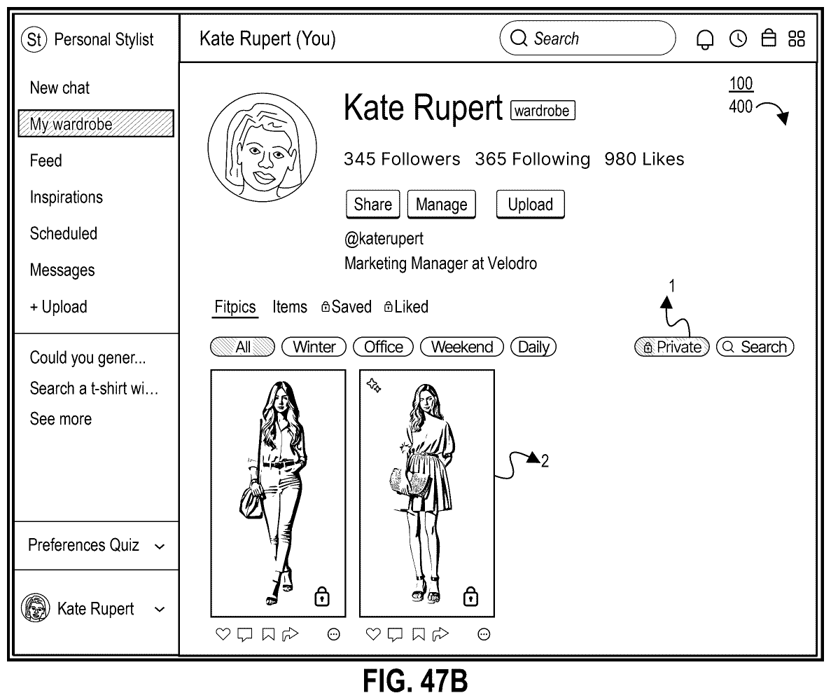

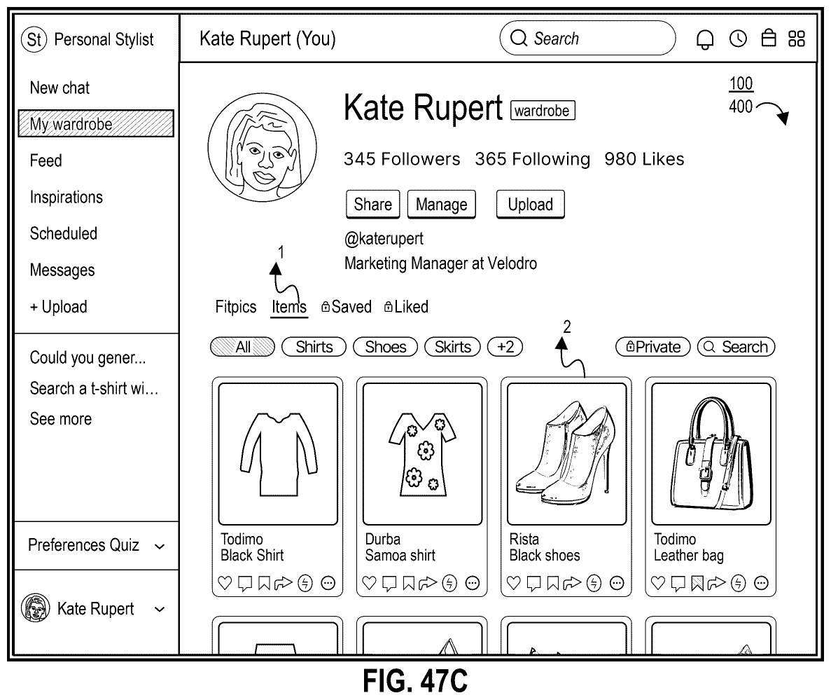

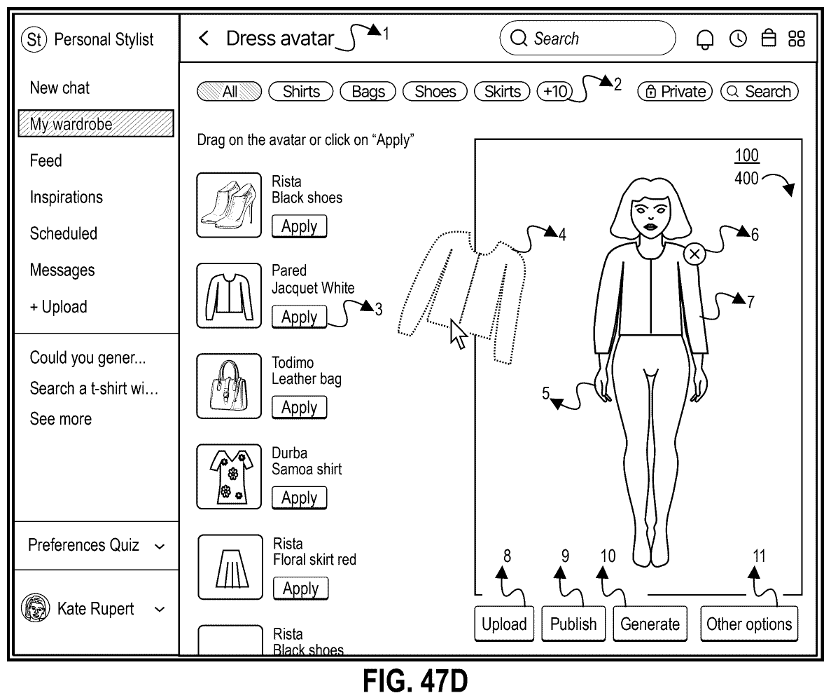

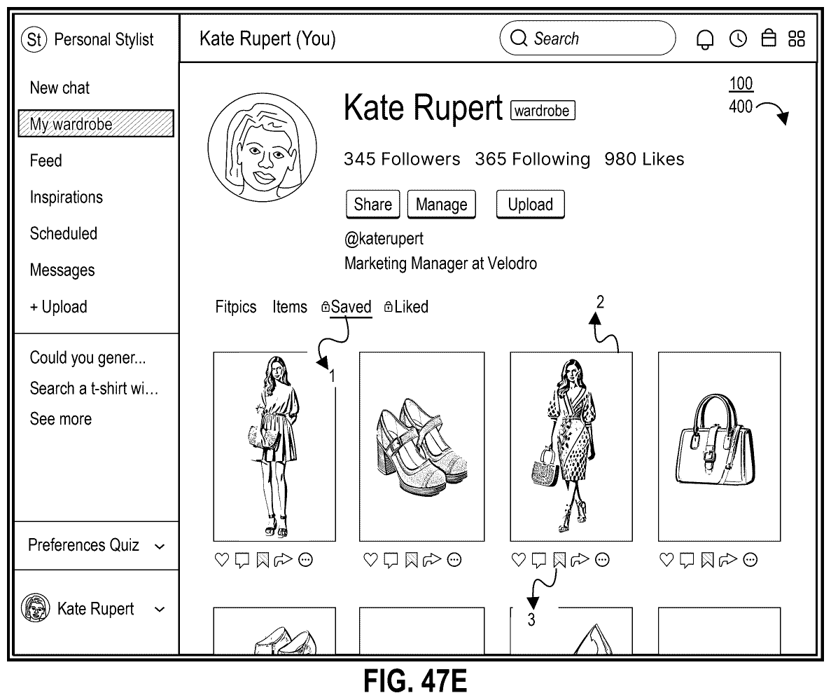

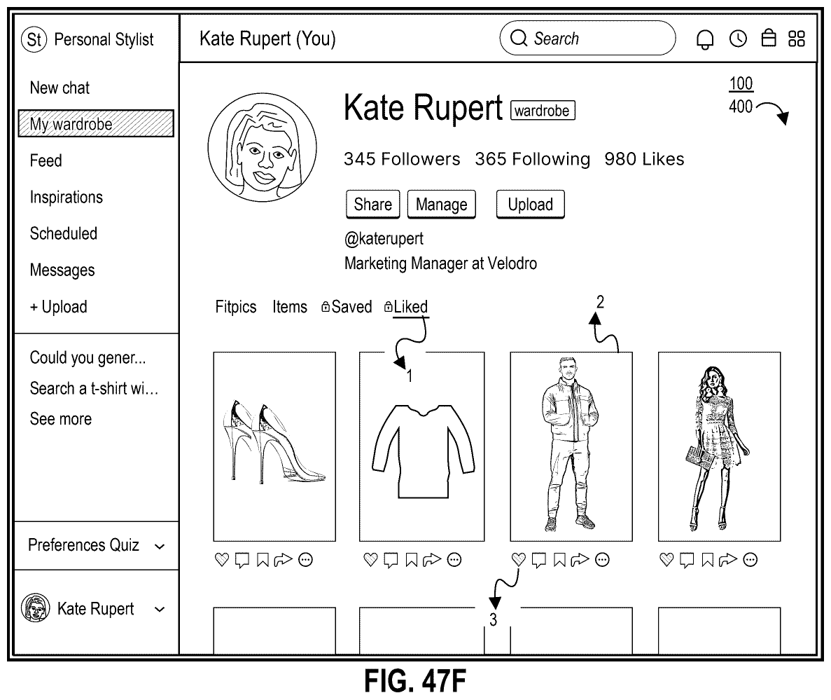

FIG. 47A The figure describes the process through which the user visits his personal wardrobe. Wardrobe is a sort of profile related to the assistant Personal Stylist. When the user selects Personal Stylist as assistant to interact with, the sidebar shows the possibility to access ‘My wardrobe’. When the user creates an account on PersonalX and accesses the Personal Stylist service for the first time, the system will automatically create the user's wardrobe, using the same full name, username and profile picture uploaded by the user in the registration process. Wardrobe is the place where users can upload their fitpics and items, visible in public or private. Organize fitpics and items in categories (Or named folders). The wardrobes also offer others features such as the possibility to dress manually the personal avatar (or a generic one) with personal items. Descriptions of arrows: (1) The user clicks on the option ‘My wardrobe’ on the sidebar to the left to visit personal wardrobe. (2) The wardrobe shows the personal profile picture, full name with a badge ‘Wardrobe’, some counters like ‘Nr. of followers’, ‘Nr. of following’ and ‘Nr. of received likes’. The personal wardrobe shows some buttons like (5) ‘Share’ to share the wardrobe on social networks, via text message or other messaging app, via private message on PersonalX or to copy the wardrobe URL, (6) ‘Manage’ to manage the wardrobe settings, (7) ‘Upload’ to upload a new fitpic or a new item, (8) ‘Dress avatar’ to manually dress personal or generic avatar with personal uploaded items. (9) The wardrobe shows the user's username and a description added by the user. (10) The wardrobe has some sections: ‘Fitpic’ to see the list of uploaded fitpics, ‘Items’ to see the list of uploaded items, ‘Saved’ to see the list of saved contents, ‘Liked’ to see the list of liked contents. (11) The user can better visualize contents in the wardrobe selecting some filters (also named Categories or Folders), selecting ‘All’ the user visualizes all contents, (12) selecting ‘Daily’ the user apply a filter to visualize only items or fitpics that have this tag (or is added in that category or folder). (13) The user can also filter clicking on ‘Private’ to visualize only private contents or (14) search something. (15) contents appear below. (16) Contents that are generated by an assistant have the icon ‘AI generated’. (17) Private contents have the ‘Private’ icon. Private content can only be viewed by you and not by other users. The ‘Private’ filter will therefore not be visible publicly.

FIG. 47B The user visualizes only private fitpics. Descriptions of arrows: (1) The user clicks the filter ‘Private’ (2) and the system shows only fitpics that are private.

FIG. 47C The user visualizes personal upload items. Descriptions of arrows: (1) The user selects the section ‘Items’ (2) and visualizes personal uploaded items.

FIG. 47D The user visits the page ‘Dress avatar’ to manually dress a personal or generic avatar with personal uploaded items, simply dragging and dropping an item on the avatar or clicking on ‘Apply’. Descriptions of arrows: (1) The user from the personal wardrobe clicks the button ‘Dress avatar’ and access the page of the service. (2) The user applies some filters to visualize specific items Categories to apply as filters could be: All items, shirt, bag, shoe, skirt, jewel, etc. Filtering the list selecting the category ‘Dress’ the system will show only items inside the category ‘Dress’. (3) The user clicks the button ‘Apply’ to apply an item on the avatar. (4) The user drag and drop manually an item on the avatar. (5) The avatar could be personal or generic. Personal avatar replicates the same face and the same body of the user. The user uploaded his face and body picture during the registration process. (6) The user clicks the button ‘Delete’ on an item on the avatar to delete it. (7) An item applied on the avatar is applied in a very realistic way. (8) The user clicks the button ‘Upload’ to upload a new item. (9) The user clicks the button ‘Publish’ to publish the dressed avatar in wardrobe as fitpic. (10) The user clicks the button ‘Generate’ to ask Personal Stylist to automatically generate an outfit with personal items. (11) The user accesses other options (management of the avatar and more).

FIG. 47E The user visits the wardrobe section ‘Saved’. Descriptions of arrows: (1) The user clicks on the section ‘Saved’. (2) The system shows the fitpics and/or items saved from feed, inspiration or other wardrobes pages. (3) The button ‘Saved’ is selected.

FIG. 47F The user visits the wardrobe section ‘Liked’. Descriptions of arrows: (1) The user clicks on the section ‘Liked’. (2) The system shows the fitpics and/or items liked from feed, inspiration or other wardrobes pages. (3) The button ‘Liked’ is selected.

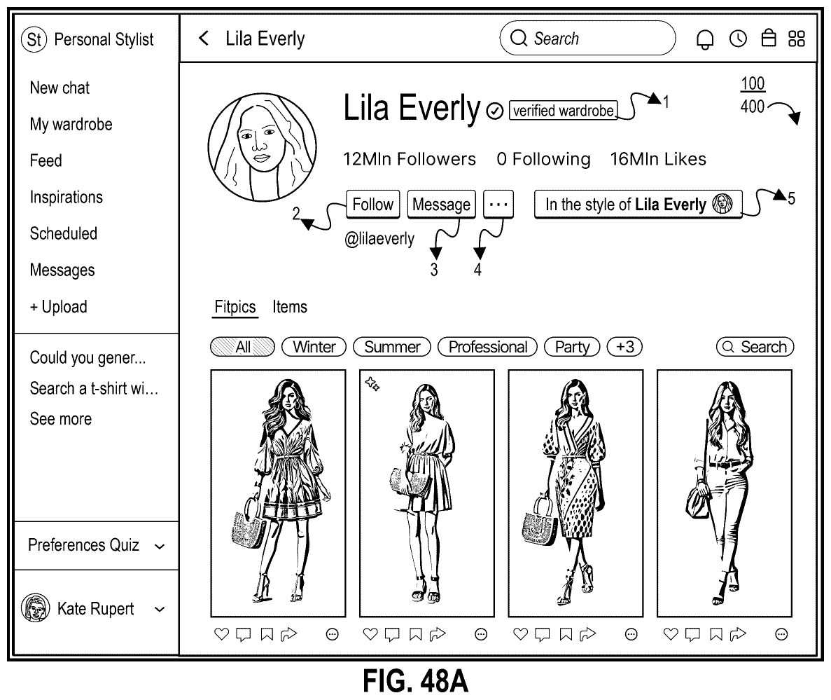

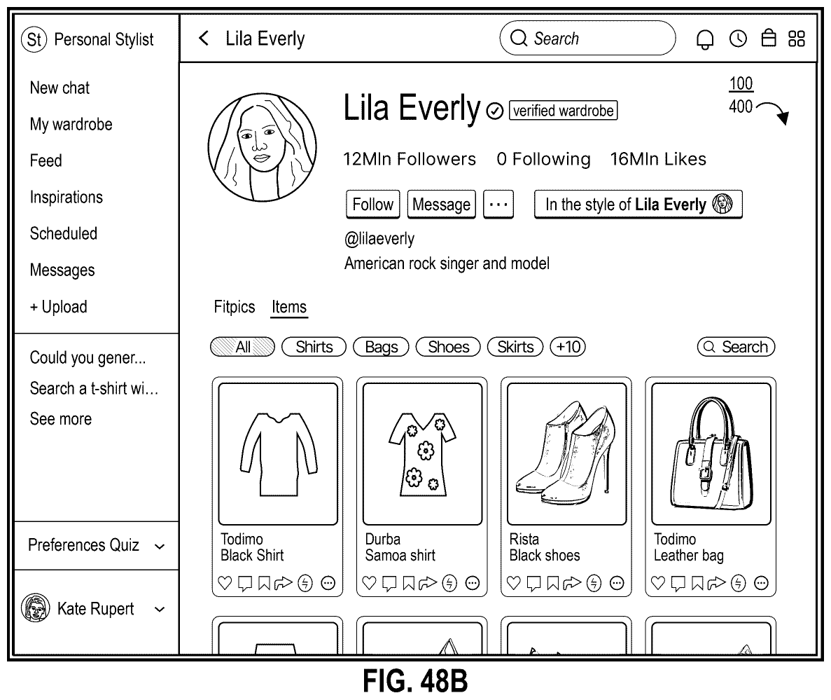

FIG. 48A The user visits the wardrobe of someone. It's a verified wardrobe. Descriptions of arrows: (1) The user visits a verified wardrobe with the badge ‘Verified wardrobe’. (2) The user clicks the button ‘Follow’ to follow the wardrobe. (3) The user clicks the button ‘Message’ to start a chat with the user. (4) The user clicks the button ‘Other options’ (5) The user clicks the button ‘Generate an outfit in the style of [Full name]’ to generate a new outfit in the style of the selected wardrobe.

FIG. 48B The user visualizes the items added in that wardrobe.

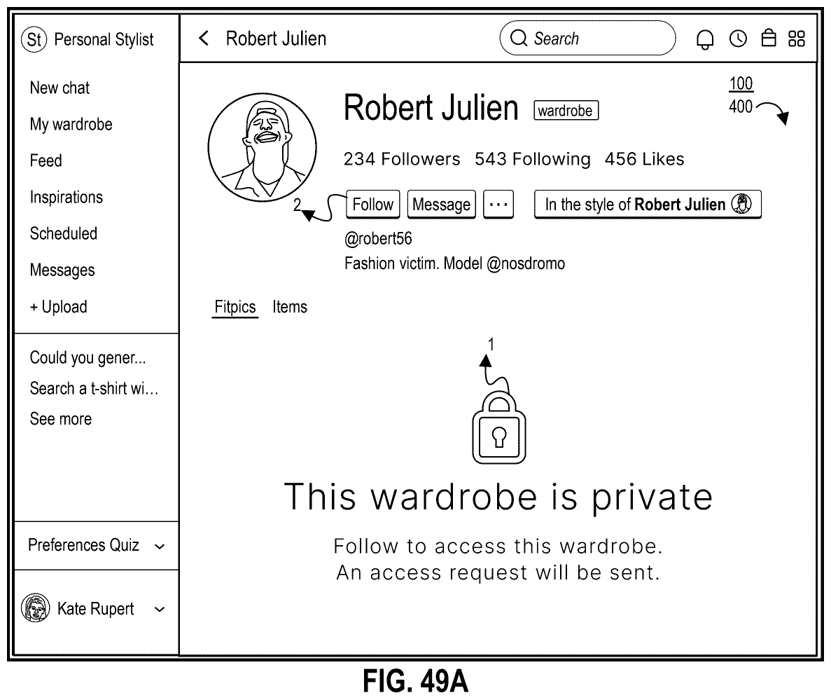

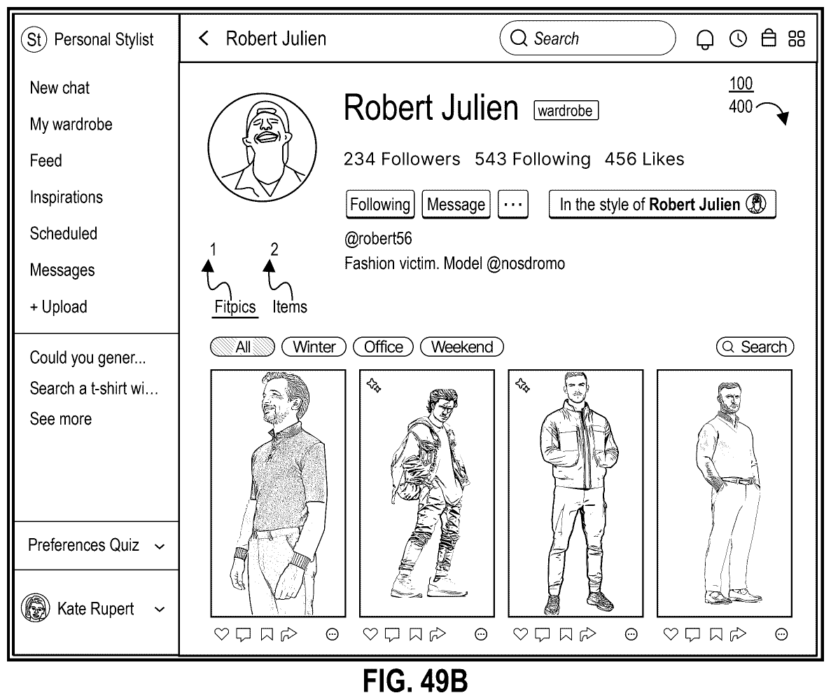

FIG. 49A The user visits a private wardrobe. Descriptions of arrows: (1) The user visiting a private wardrobe visualizes the message ‘This wardrobe is private—Follow to access this wardrobe. An access request will be sent’. In a private wardrobe no contents are visible to other users. (2) The user clicks the button ‘Follow’ to request access to the wardrobe. The user who has the private wardrobe will then receive a request message. The user can approve or reject the request. If the other user tries, he will have access to his wardrobe. Allowing the access to the personal private wardrobe you allow to show your contents to the user that sent you the access request.

FIG. 49B The user has access to a wardrobe before private. Descriptions of arrows: (1) The user is approved and now has access to the wardrobe and can see the list of fitpics (2) and items.

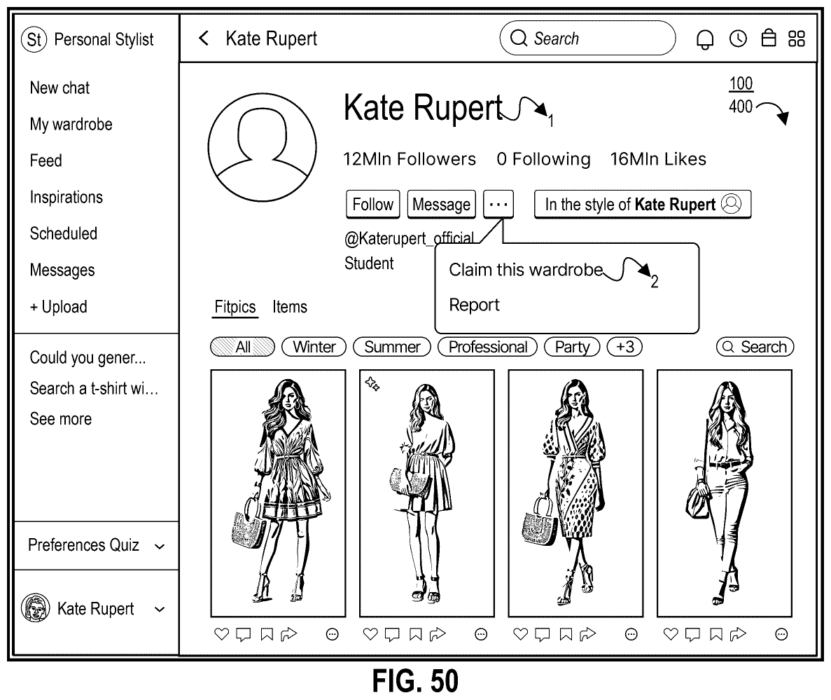

FIG. 50 The figure describes the process through which the user finds a wardrobe that can be claimed as personal. Descriptions of arrows: (1) The user visits a wardrobe with his full name. (2) The user clicks the button ‘Claim this wardrobe’.

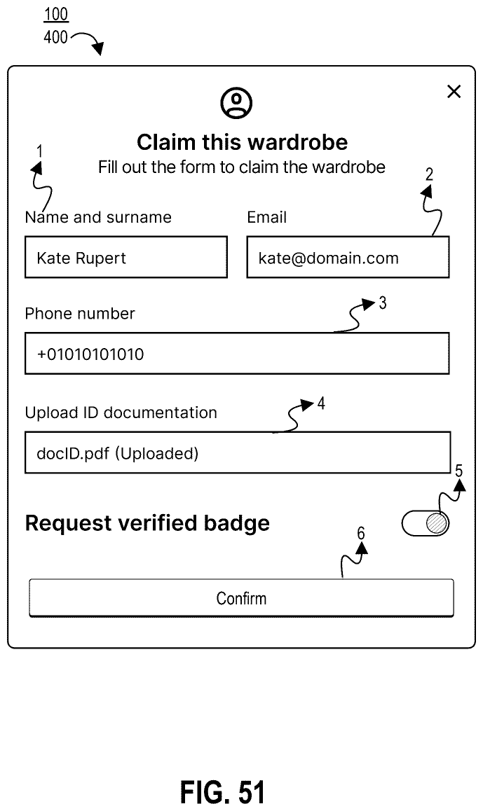

FIG. 51 The figure shows the view to claim the wardrobe. Descriptions of arrows: (1) The user enters his full name, (2) email, (3) phone number, (4) upload ID documentation, (5) set he wants to verify the wardrobe and receive the verified badge, (6) the user clicks the button ‘Confirm’ to send the request.

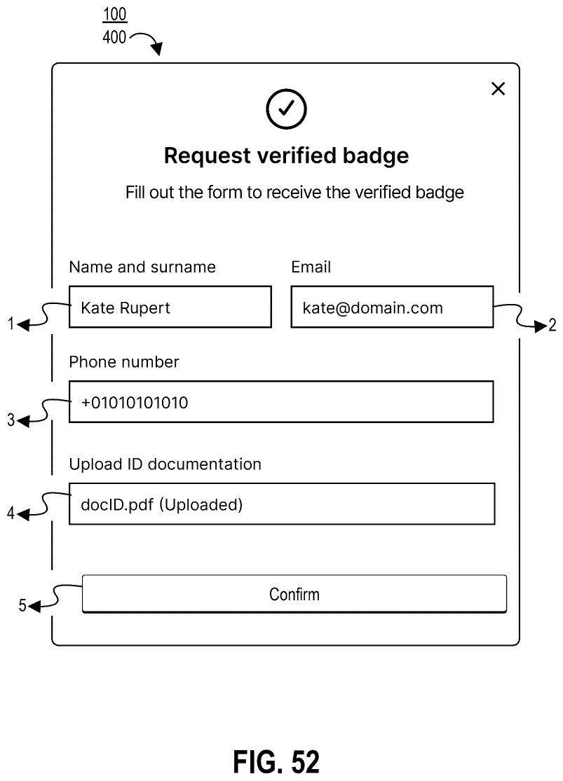

FIG. 52 The figure shows the view to ask for the verified badge. Descriptions of arrows: (1) The user enters his full name, (2) email, (3) phone number, (4) upload ID documentation, (5) the user clicks the button ‘Confirm’ to send the request.

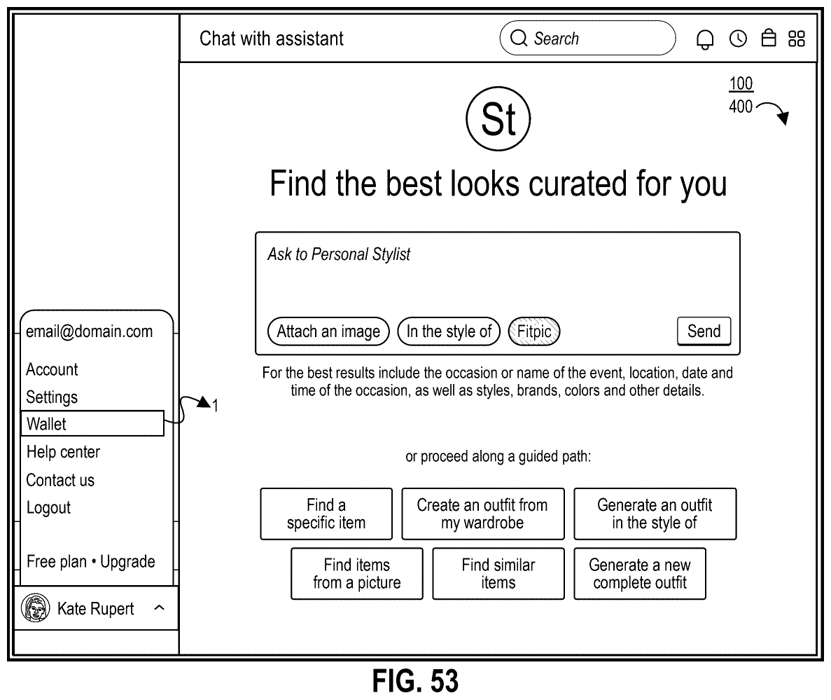

FIG. 53 The figure shows the wallet feature. Wallet is the service to be paid by the platform. The feature concerns the internal monetization system of the platform. When someone buys an item through a wardrobe or through the contents that a user has published such as fitpics, the publisher can earn money. Publishing items in a personal wardrobe can open up the advantage of monetization. If a userX buys an item from the wardrobe of userY, the latter monetizes by earning a percentage of the sale as an affiliate, receiving a payment from the platform PersonalX on the sales of that particular product purchased through their wardrobe. Even when userX generates a new outfit in the style of userY, the latter receives a percentage of the product sales. Wallet is the place where these payments are credited. The credit accumulated on the personal wallet can be used to complete purchases and make other payments (send money to someone, pay plans, etc.) Descriptions of arrows: (1) The user chooses the option ‘Wallet’ in the view.

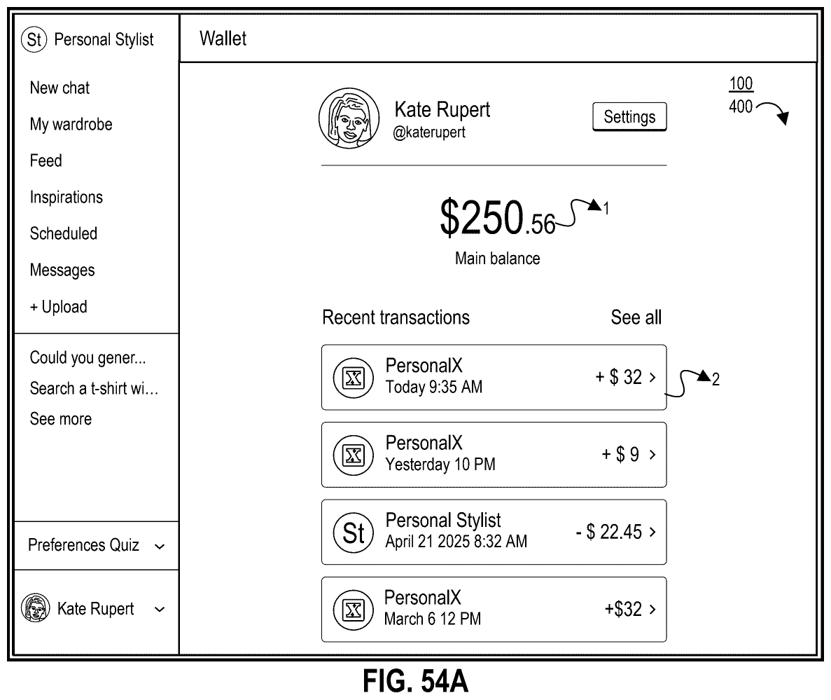

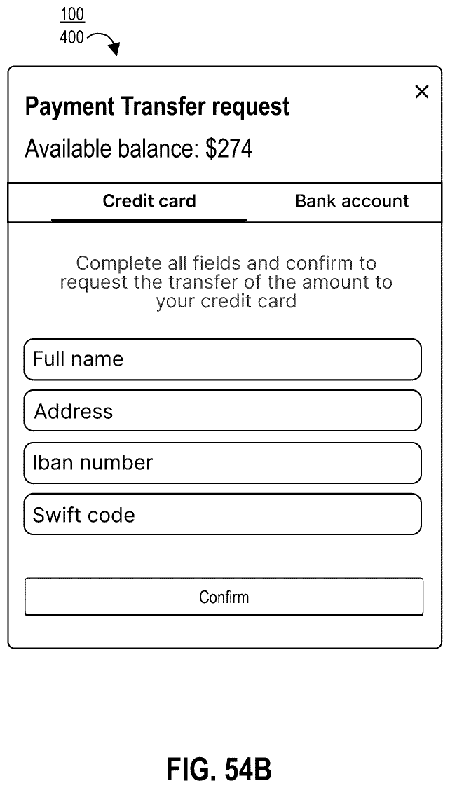

FIG. 54A The figure shows the wallet page. Descriptions of arrows: (1) The user visits his wallet and visualizes the main balance amount. (2) The user visualizes the list of all transactions.

FIG. 54B The figure shows the view through which the user can request a transfer of this credit accumulated in the wallet to a personal credit card or other bank account.

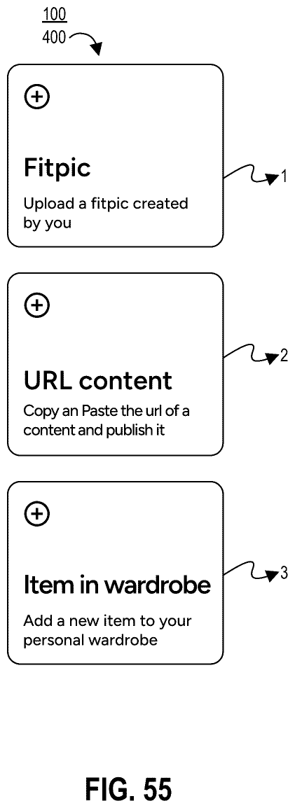

FIG. 55 The user clicks the button ‘Upload’ in the wardrobe and accesses the possibility to upload contents. Descriptions of arrows: (1) The user clicks the option ‘Fitpic’ to upload a fitpic (image of an outfit). (2) The user clicks the option ‘URL content’ to paste a link of a fitpic published on a social network. (3) The user clicks the option ‘Item’ to upload an item in the wardrobe.

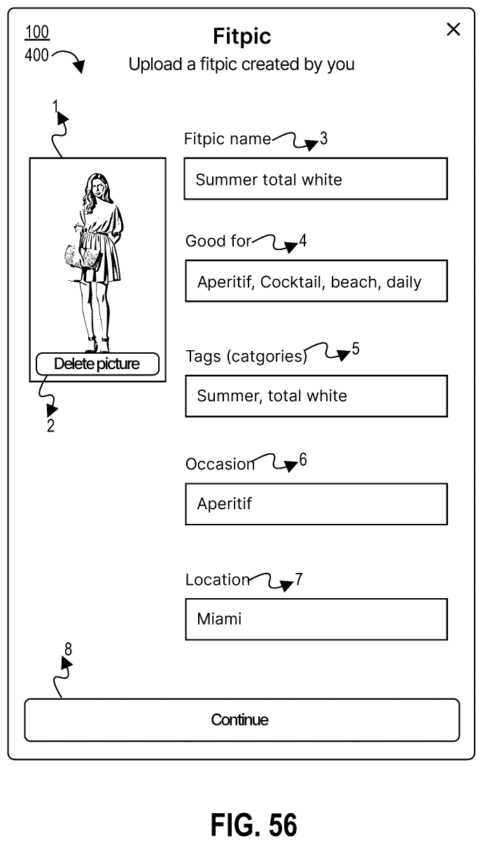

FIG. 56 The user adds a fitpic. Descriptions of arrows: (1) The user uploads a fitpic (image of a person wearing an outfit). (2) The user clicks the button ‘Delete’ to delete the uploaded picture. (3) The user enters the fitpic name, (4) adds occasions, context or other words which describe the image as ‘Good for’, (5) adds tags, (6) adds the occasions that is perfect to wear that outfit, (7) location and (8) clicks the button ‘Continue’ to proceed.

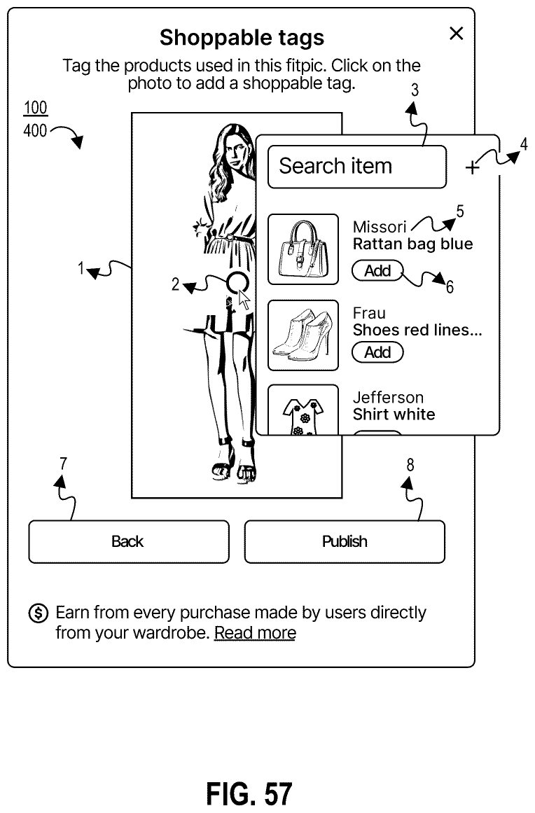

FIG. 57 The system shows a view to add shoppable tags on the fitpic the user uploaded. Descriptions of arrows: (1) The fitpic appears on the screen. (2) The user clicks on an item on the image and a popup to add an item is opened. (3) The user can search for an item to tag. (4) The user can add a new item in the wardrobe. (5) The user visualizes the item and (6) clicks the button ‘Add’ to tag it on the fitpic. (7) The user clicks the button ‘Back’ to return back. (8) The user clicks the button ‘Publish’ to publish the fitpic. Thanks to those tags the user can earn from every purchase made by users directly from his wardrobe (Monetization feature).

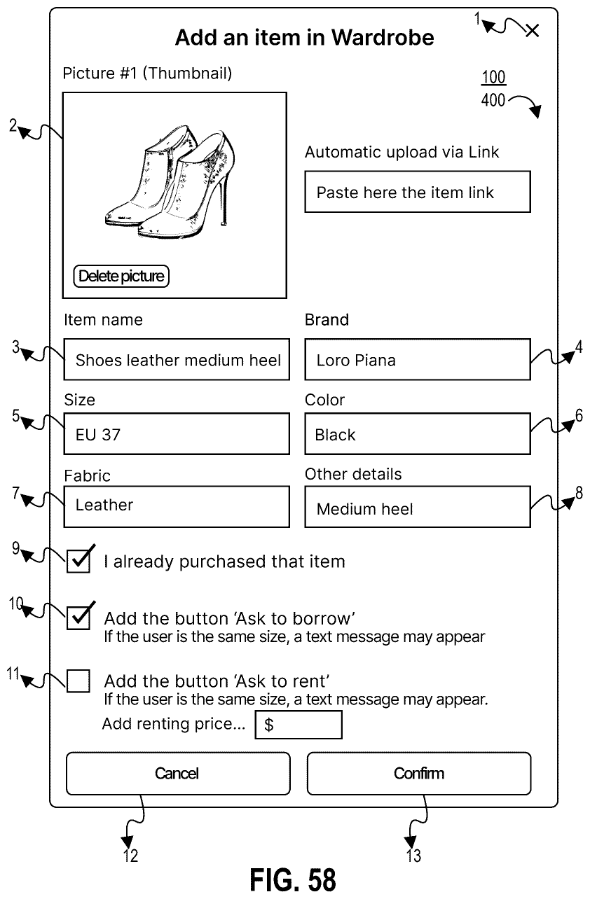

FIG. 58 The figure shows the view to add a new item in the wardrobe. Descriptions of arrows: (1) The user can click on the button ‘Close’ to close the view and return back. (2) The user uploads the item picture. (3) The user enters the item name, (4) the brand, (5) size, (6) color, (7) fabric, (8) other details. The Personal Stylist will be able to extract data from this and understand the user's sizes and preferences. The Personal Stylist will never suggest the purchase of the items the user already has in the wardrobe. (9) The user confirms that the item is already purchased. (10) The user enables the possibility to borrow this item for the other users that will visit his wardrobe. Other users visiting this user's wardrobe will be able to borrow that item. The size and other more sensitive information will not be shown to other users. However, if that user has the same size as the user posting the item, then a message communicating this information may appear to the user requesting to borrow the item. (11) Similar feature to the previous one but it is a request to rent the item. The user adds an amount for which he rents it. (12) The user clicks the button ‘Cancel’ to close the view and delete everything. (13) The user clicks the button ‘Confirm’ to confirm the item and publish it in the wardrobe. All the users who follow this wardrobe will be able to see the contents published at the moment also in their feed.

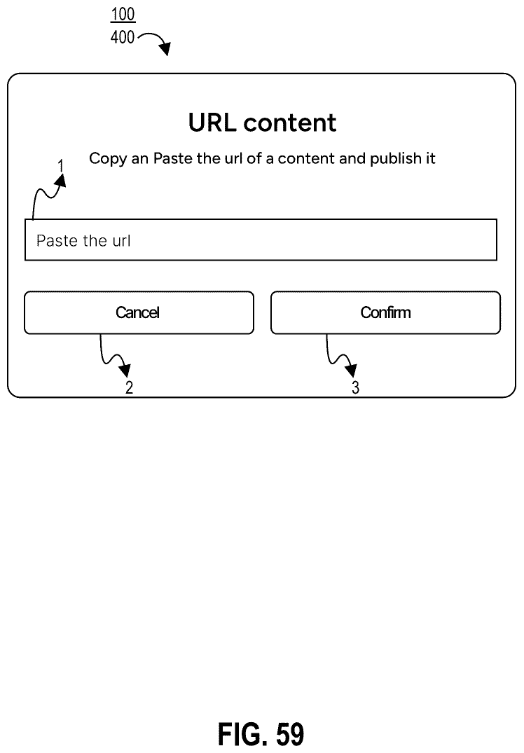

FIG. 59 The figure shows the view to upload content from social networks thanks to the URL. Descriptions of arrows: (1) The user pastes a url of a fitpic published on social networks. (2) The user clicks the button ‘Cancel’ to close the view and delete everything. (3) The user clicks the button ‘Confirm’ to proceed and publish it.

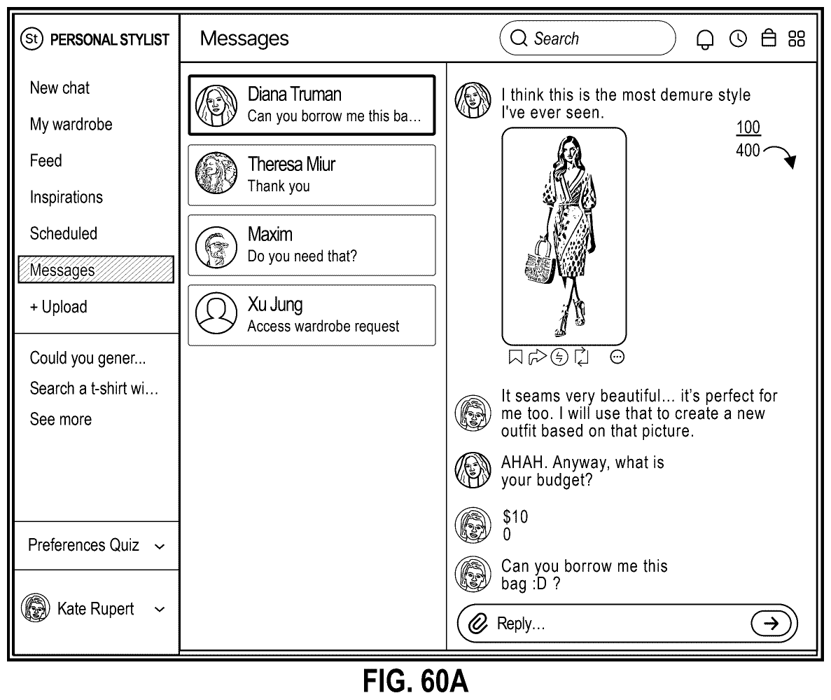

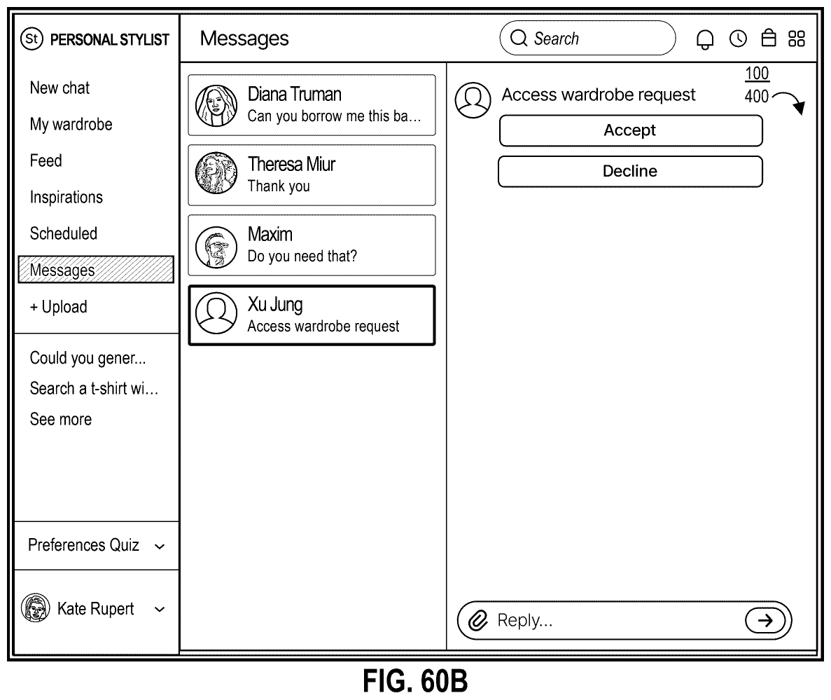

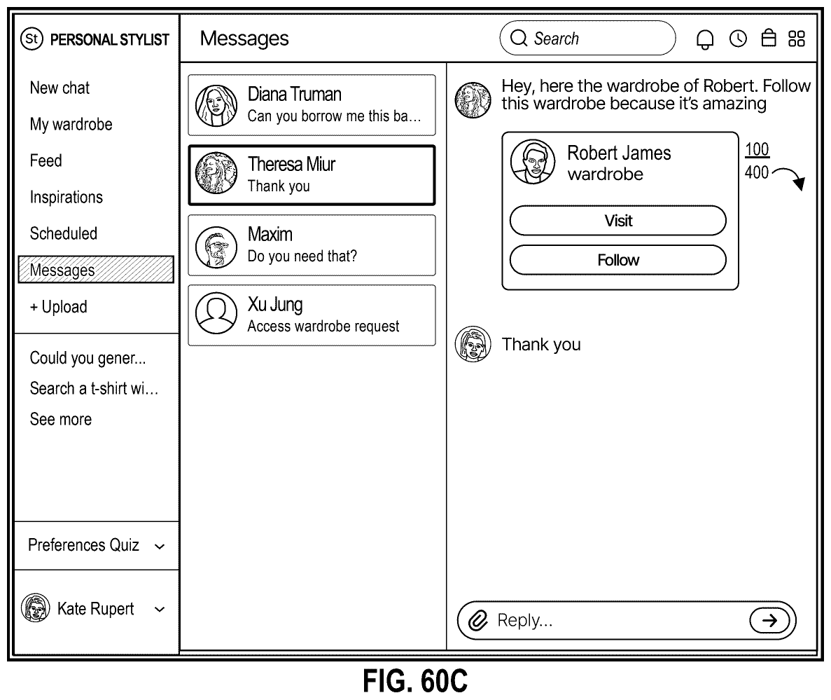

FIG. 60A The figure shows the messaging feature. The user is asking to borrow an item from another user's wardrobe.

FIG. 60B The figure shows the messaging feature. The user is asking to follow a wardrobe. The user that receives the request can accept or decline. If the user accepts, the other user will have access to the wardrobe and view all published content. If the user declines, the other user will not have access to the wardrobe and it will remain private.

FIG. 60C The figure shows the messaging feature. The user is sharing a wardrobe of someone with another user.

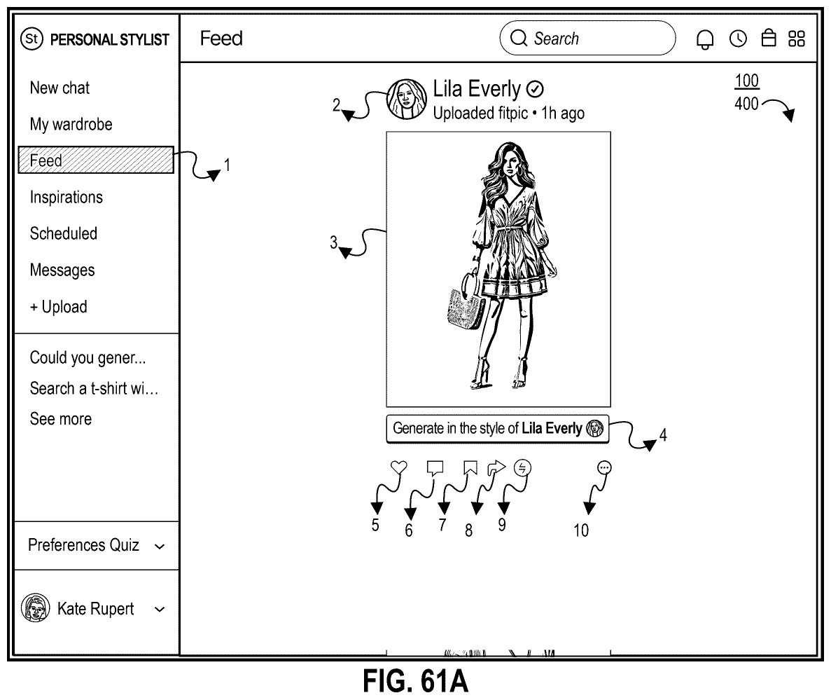

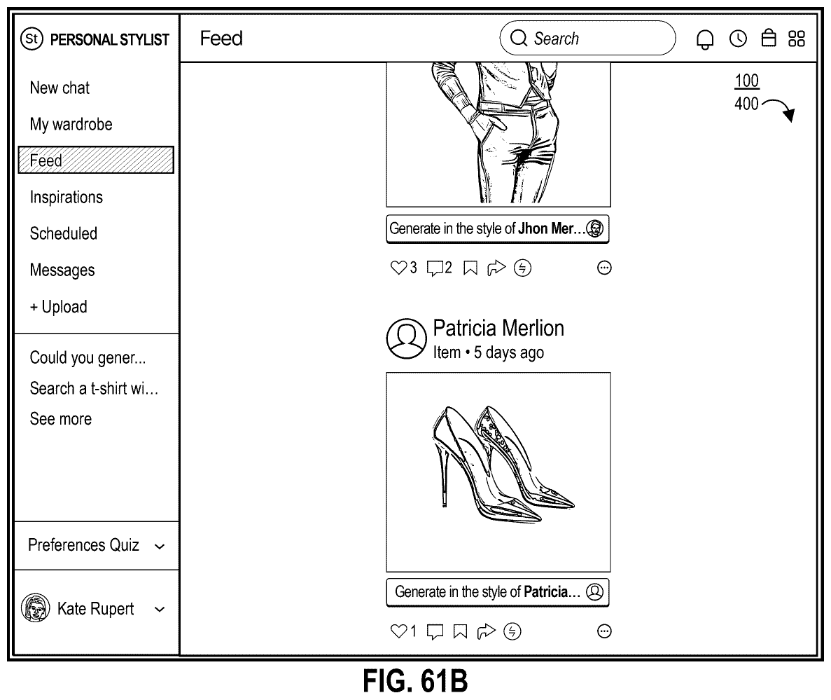

FIG. 61A The figure shows the feed feature. The feed is a scrolling page. The feed shows the profile picture, name of the publisher, type of published content, date and time, content as image, the button ‘Generate in the style of’, and some buttons to interact with. In the feed may also appear items published in the wardrobes. Descriptions of arrows: (1) The user selects the option ‘Feed’ on the sidebar. (2) The feed is a flux of published fitpics or items, sponsored contents (fitpics, items, images, wardrobes) and general platform suggestions. The feed essentially shows the contents published by the wardrobes the user is following or is interested in. (3) The feed shows a fitpic published by someone the user is following. (4) The button ‘Generate in the style of . . . ’ basically in the style of the person publishing the content. (5) The user clicks the button ‘Like’ to like the content, (6) the button ‘Comment’ to comment it or reply other comments so interacting with other users, (7) the button ‘Save’ to save it, (8) the button ‘Share’, (9) the button ‘Generate similar outfit’ that opens a panel to set the prompt and (10) other options.

FIG. 61B The feed can also show published items.

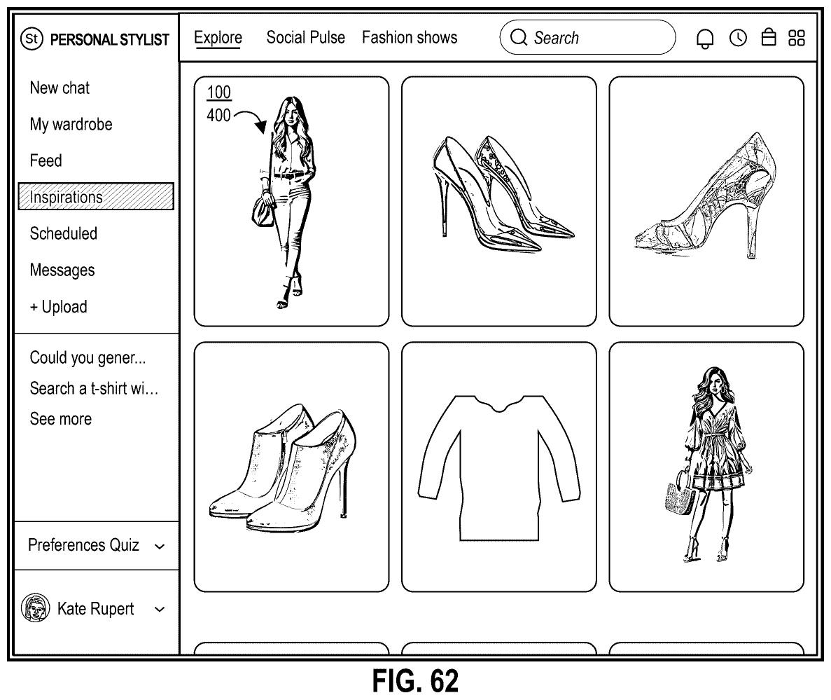

FIG. 62 The figure shows the page ‘Inspirations’ page, section ‘Explore’. The user visiting the page inspiration can click the ‘Explore’ section and he will see a stream of content including fitpics or items that can inspire him. Similar actions that appear under the contents in the feed will appear also on contents visualized in the inspiration page.

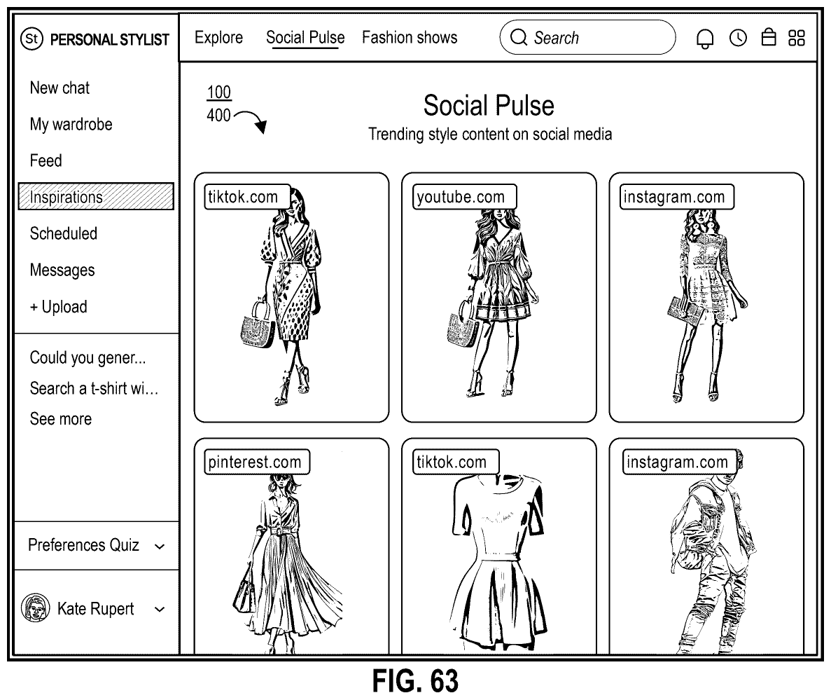

FIG. 63 The figure shows the ‘Inspirations’ page, section ‘Social pulse’. The page shows all contents published from social networks (Contents URL's).

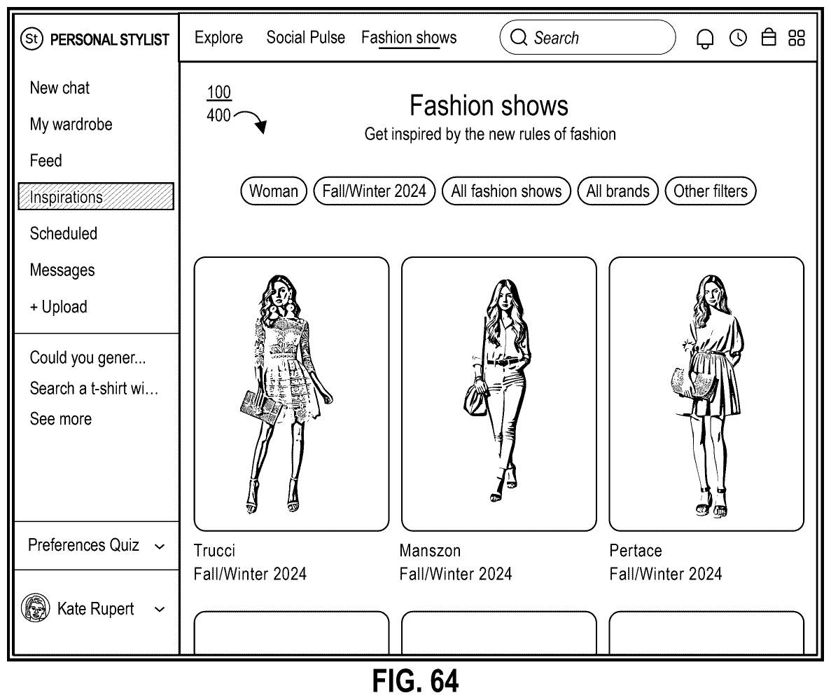

FIG. 64 The figure shows the ‘Inspirations’ page, section ‘Fashion shows’. The page shows live or recorded videos of fashion shows. The user can filter these contents with filters like: Gender, season of fashion show and year, brands and other possible filters.

The drawings show the processes by which the user can find a wardrobe or contents (Fitpics and/or items to purchase) just searching for a specific style (Casual, Business casual, Elegant, etc.). Wardrobe is a profile where the user collects personal items and uploaded or AI generated fitpics. Personal Stylist is able to generate fitpics and recommend to the user the related items to purchase to create the exact outfit. Personal Stylist is able to generate fitpics with the items that the user already has added in wardrobe (Items that the user does not have to purchase but already owns).

Prompt field is the field where the user can select options (attach images, select a profile whose style the user wants to replicate), select a type of AI model (to generate fitpics or a more basic model that only recommends items without generating images), write more or less specific requests, click on the ‘Send’ button to send the request or response to the assistant. In the case that the user's prompt is not complete, the Personal Stylist could start to ask for some more info about the occasion, date and time and location, budget, etc. (Little questionnaire). In case a user wants to replicate another user's style but with a different gender, the Personal Stylist will be able to adjust that style to the user's gender. Example: If the primary user is male and wants to replicate a female person's style, the assistant will be able to adjust that style to the male gender. In case the user wants exactly that style but with female clothes, he/she can request it from the assistant. Personal Stylist is also able to adjust a certain style based on specific budgets, primary user's age, availability of items and more. Users can use the service without registering or logging in. However, it may be required in certain contexts or to complete certain actions. The registration of an account is essential to share with the service information such as personal shipping addresses or payment methods, as well as to share personal preferences such as brands, colors, sizes, etc.

Feed is the page where the system brings together all the content and content publishers. The feed is a web page where the user can see and interact with the fitpics or articles published or generated by users they follow or might be interested in. The specific feed shown when searching for a specific style is a web page where the user can see and interact with the fitpics or articles published or generated by users who have that specific style. The articles and fitpics generated or directly uploaded are linked to that specific style. The user who searches for a style can visit a feed with content that has that specific style. From the feed the user can visit and follow the wardrobe-profiles they are interested in and generate new fitpics by clicking on the ‘IN the style of’ button or similar found in each wardrobe profile, to generate a new fitpic and related items to buy on that style of the chosen user.

Search is a feature available to search specific profile wardrobes (Username, phone number, email, full name) or just styles (name of the style). By searching for a style the system will show a specific feed with content and wardrobes related to that style, a section of only easily scrollable content published by those wardrobe profiles and also a section with only the list of wardrobes related to that style. The intent is to make it easier for the user to find fitpics and wardrobes to follow or to generate new fitpics in that specific style.

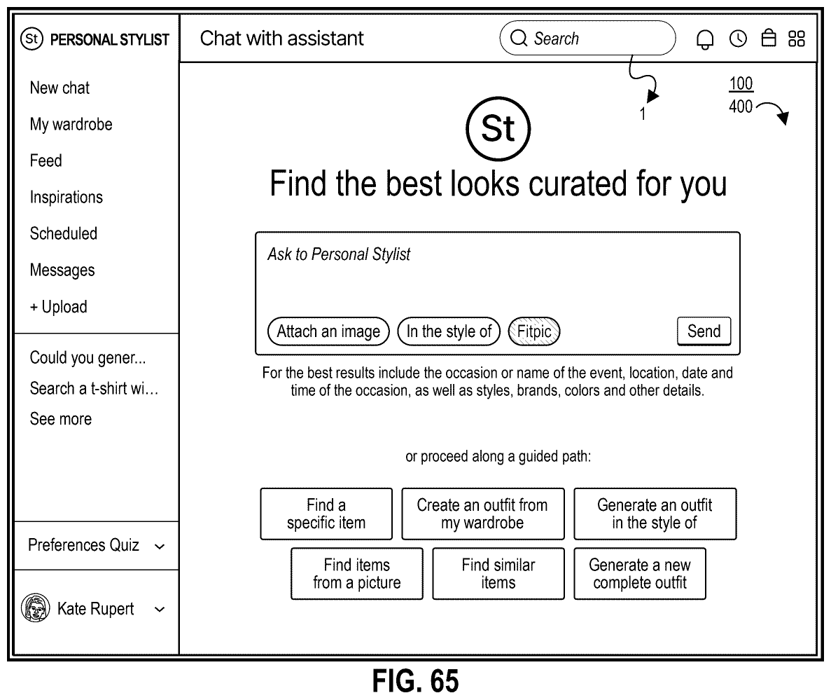

FIG. 65 The figure describes the web page where the system shows a search field in the nav bar on the top. Descriptions of arrows: (1) The system shows the search field in the nav bar. The user can search everything, just typing letters or complete words.

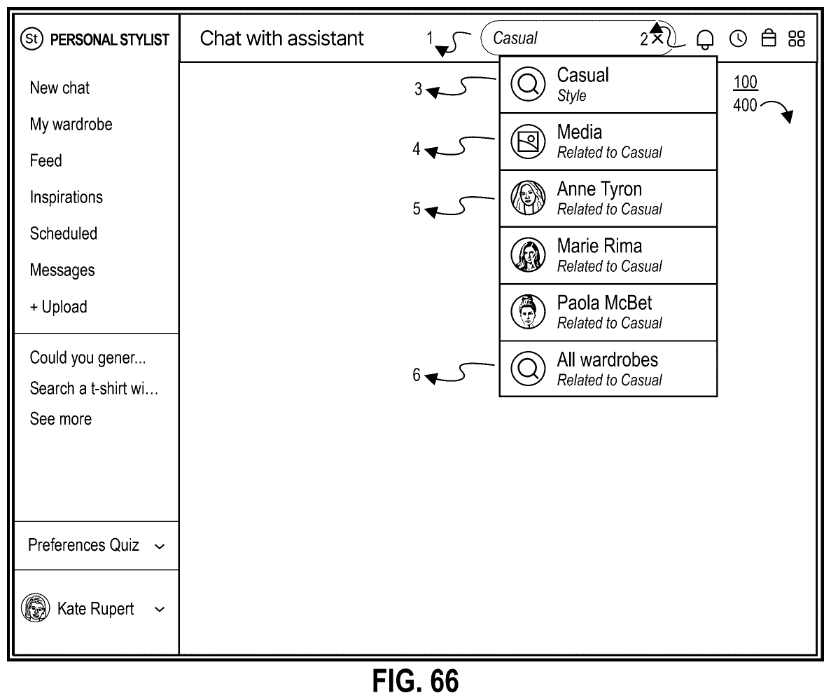

FIG. 66 The figure describes the process through which the user searches for a specific style ‘Casual’ with the intention of finding everything there is on the platform related to that word ‘Casual’ identified by the platform as a ‘Style’. The system shows a dropdown where the user can select the result he wants to visit. Descriptions of arrows: (1) The user types in the search field the word ‘Casual’. (2) The user clicks the button ‘Close’ represented by a X to close the search. (3) The user searches the word ‘Casual’ and the system shows a dropdown with some options to choose. The first option is ‘Casual-Style’ and it opens a feed with only contents and wardrobes related to that specific style. (4) The second option is ‘Media Related to Casual’ and it opens a page with contents related to that style, generated or uploaded and published by other users through their wardrobe profiles. (5) The third option is ‘Anne Tyron-Related to Casual’ and it's a wardrobe suggested to visit related to that style. The system will show some other wardrobes too as a suggestion to visit. (6) The fourth and last option is ‘All wardrobes-Related to Casual’ and it's the option to open a page with the list of all wardrobes related to the style ‘Casual’.

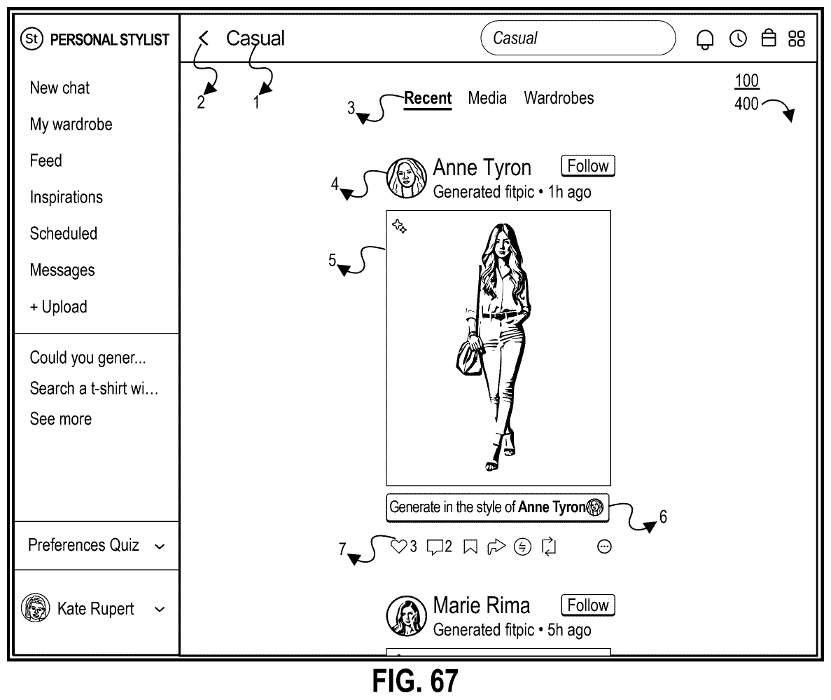

FIG. 67 The figure describes the process through which the user, clicking the first option in the dropdown ‘Casual-Style’, visits the feed with a flux of contents related to the style ‘Casual’. Descriptions of arrows: (1) The user visits the Casual Feed. (2) The user clicks the button ‘Back’ represented by an arrow to return to the previous page. (3) The user visiting the Feed related the style ‘Casual’ see the recent contents published by other users. (4) The system shows for each content the publisher profile picture and full name, the button ‘Follow’ or ‘Following’, (5) the published fitpic or item related to the style ‘Casual’, (6) the button ‘Generate in the style of . . . ’ to generate a new fitpic and related items to purchase in the style of the specific user, (7) and some actions to interact with the fitpic. The actions represented by symbol in order of representation: Like, comment, save as inspiration, share, attach the image to the prompt, generate similar fitpic, and other actions.

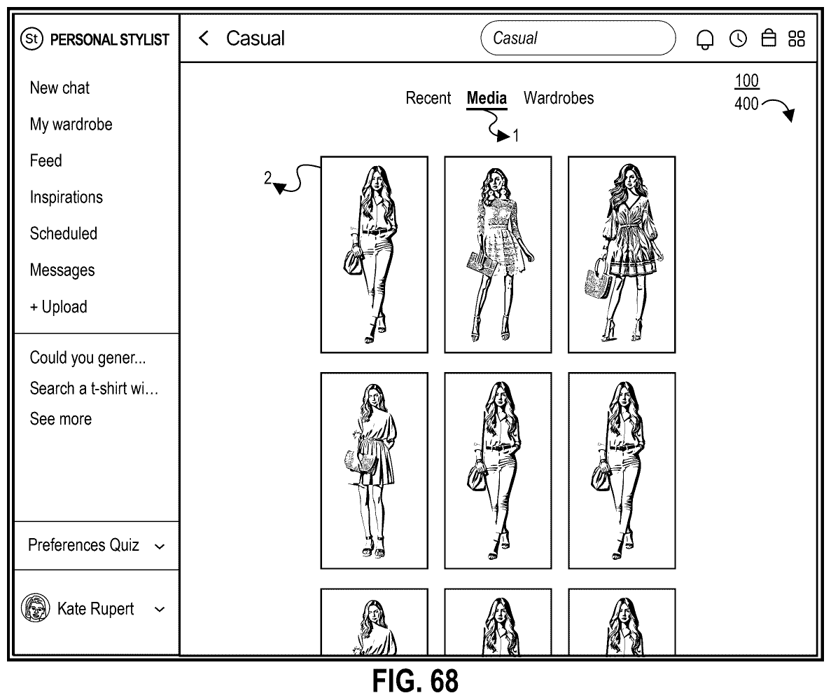

FIG. 68 The figure describes the process through which the user, clicking the second option in the feed ‘Media’, visits the page with a flux of fitpics related to the style ‘Casual’ published by other users through their wardrobe. Descriptions of arrows: (1) The user selects the option ‘Media’. (2) The system shows a list of contents related to the style ‘Casual’.

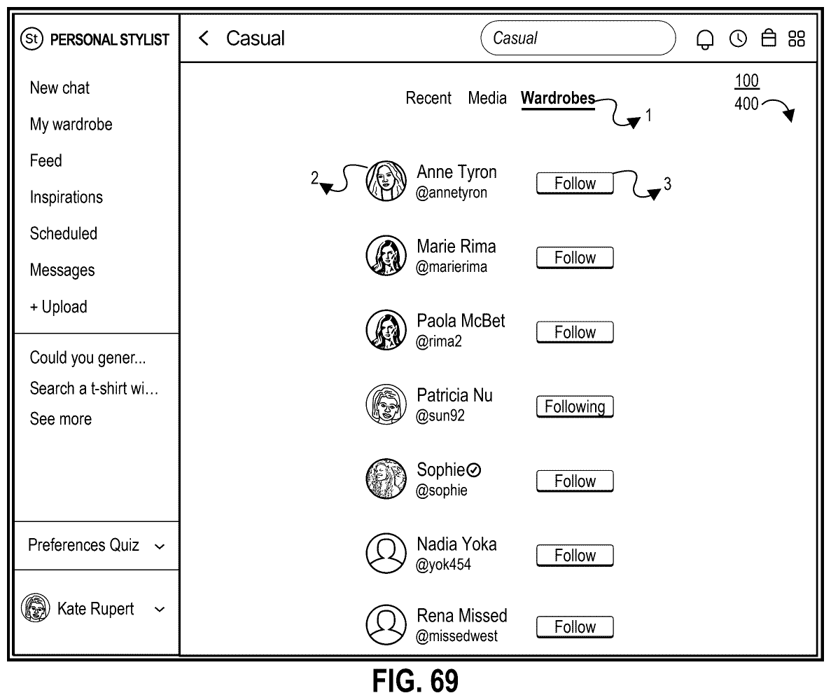

FIG. 69 The figure describes the process through which the user, clicking the third option in the feed ‘Wardrobes’, visits the page with a list of profiles-wardrobes related to the style ‘Casual’ Descriptions of arrows: (1) The user selects the option ‘Wardrobes’. (2) The system shows a list of wardrobes (Profile picture, full name and username) related to the style ‘Casual’. (3) The system shows for each wardrobes a button ‘Follow’ to start to following the wardrobe or ‘Following’. Clicking ‘Following’ the user unfollows the wardrobe.

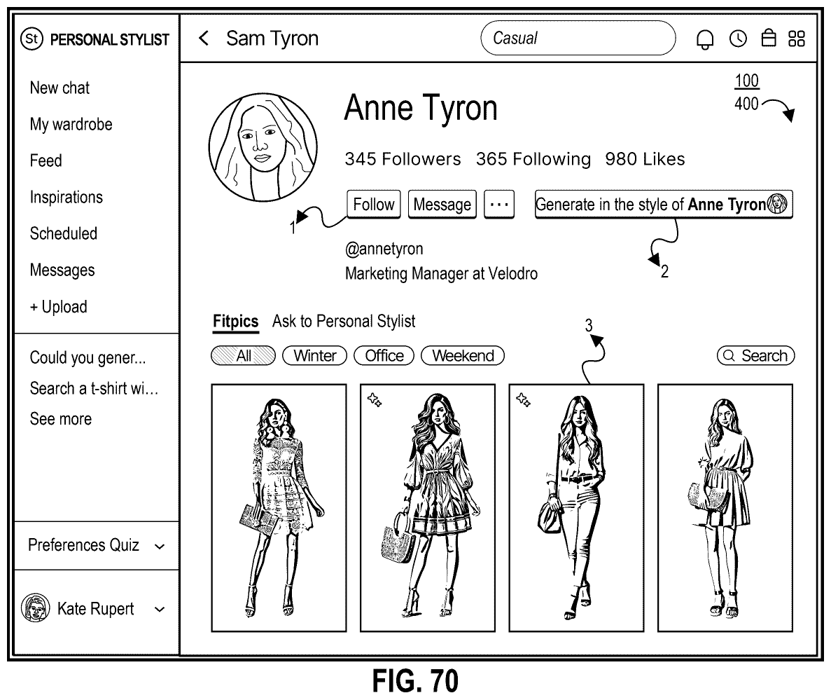

FIG. 70 The figure describes the process through which the user visits a wardrobe-profile. Descriptions of arrows: (1) The user visits the wardrobe of a user, related to the style ‘Casual’ visiting the feed (See FIG. 2A). The system shows for that wardrobe some buttons like ‘Follow’ to start following that wardrobe and (2) the button ‘Generate in the style of Anne Tyron’ that the user can click to ask the Personal Stylist to generate one or more fitpics in the style of that specific person. (3) The user visiting the wardrobe can see the list of published Fitpics.

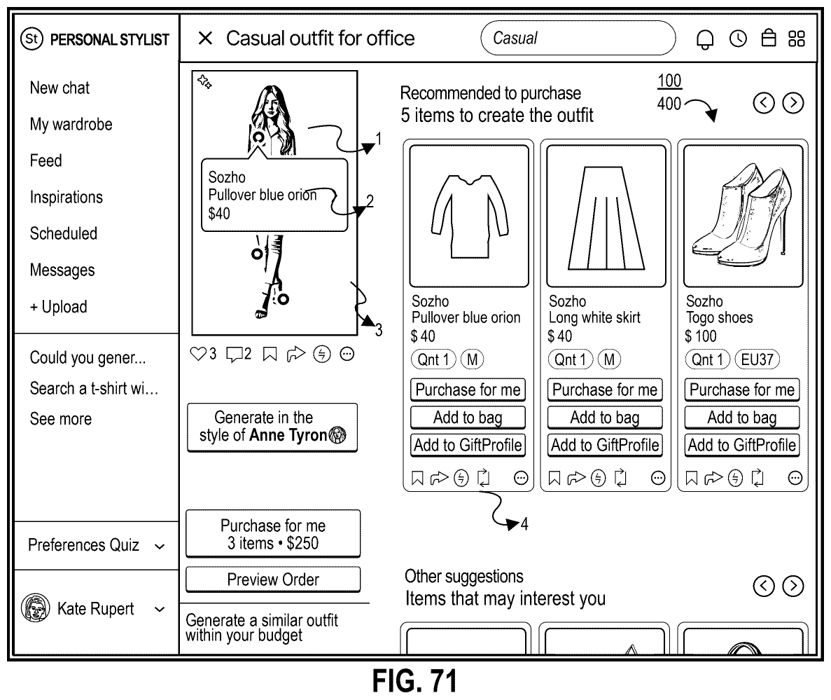

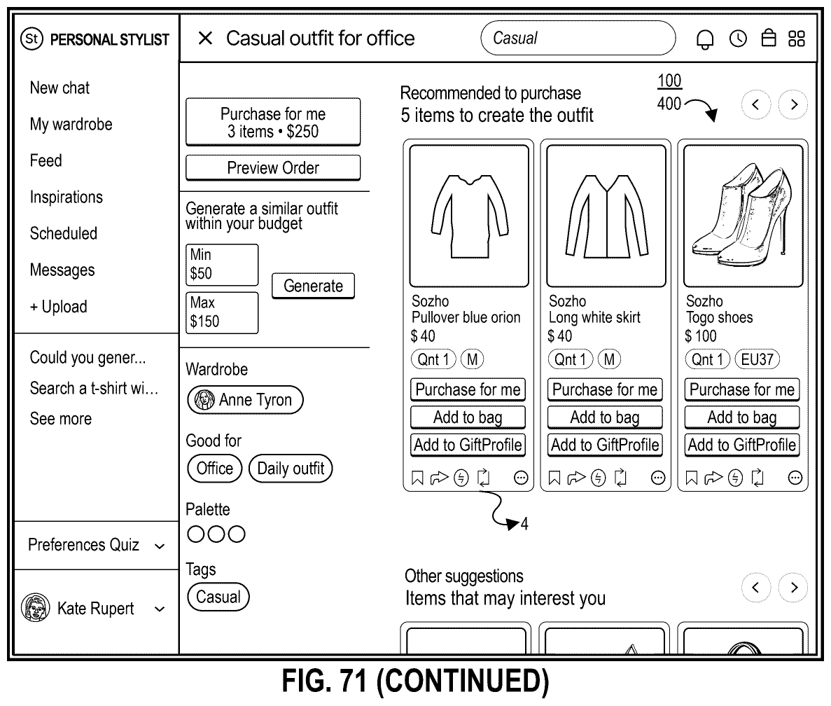

FIG. 71 The figure describes the process through which the user opens a fitpic from the wardrobe was visiting. Descriptions of arrows: (1) The system shows the opened fitpic and related shoppable links, represented by dots, placed on each item in the image (example Shoppable tag to buy the trousers via direct link, a circle appears on the trousers on the image). (2) Clicking on a shoppable tag, the system shows a popup with the brand, name of the item and price. The popup is clickable and it is a link to purchase the item. (3) the button ‘Generate in the style of Anne Tyron’ that the user can click to ask the Personal Stylist to generate one or more fitpics in the style of that specific person. (4) A list of recommended items related to the fitpic on the left side, appears on the right side. The user can purchase these items to create the same outfit in the fitpic.

FIG. 71 (Continued) The user scrolls the page to see other information about the fitpic.

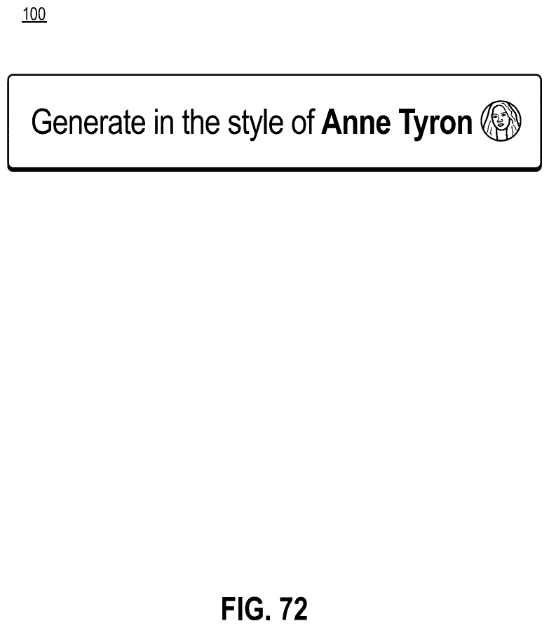

FIG. 72 The figures show a button the main user can find visiting wardrobes or can find visiting the feed. For each publisher in the feed will be presented the button ‘Generate in the style of . . . ’ with the name and the profile picture of the person whose style he wants to reproduce.

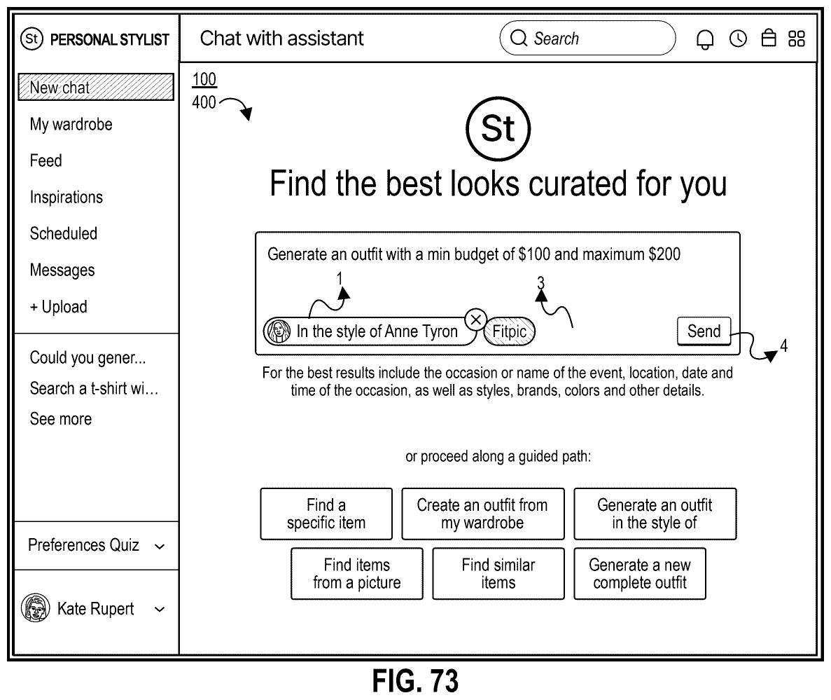

FIG. 73 The figure describes the process through which the user clicks on the button ‘Generate in the style of Anne Tyron’ from a wardrobe of another user and the option ‘In the style of’ is added in the prompt field where the user type the prompt to generate the new outfit ‘In the style of’ the selected user. Descriptions of arrows: (1) The system shows the added option ‘In the style of Anne Tyron’ in the prompt field, (2) where the user types a prompt ‘Generate an outfit with a min budget of $100 and maximum $200’. (3) The user selects a type of AI model (to generate fitpics or a more basic model that only recommends items without generating images), in that case ‘Personal Stylist’ to generate fitpics and related items to purchase. (4) The user clicks the button ‘Send’ to send his request.

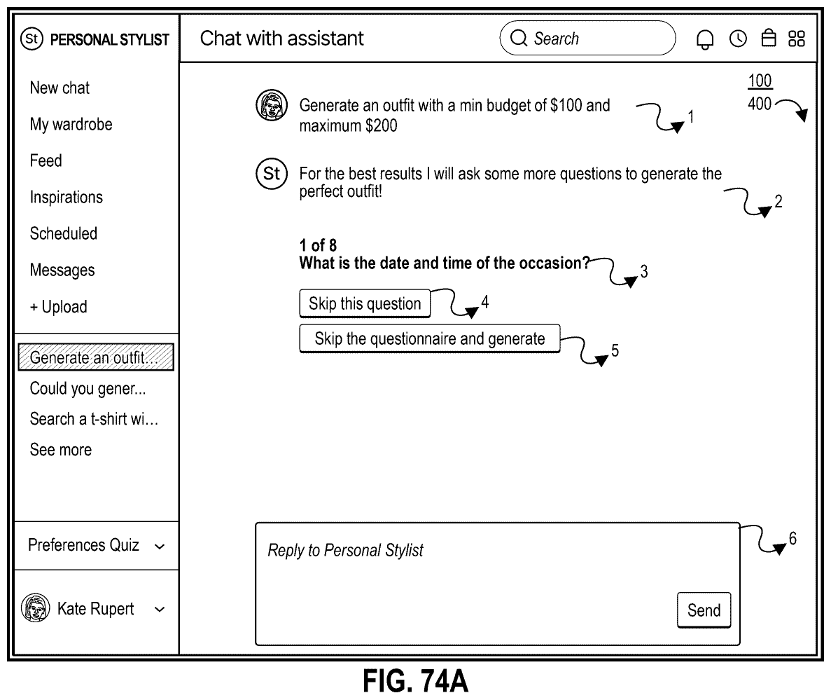

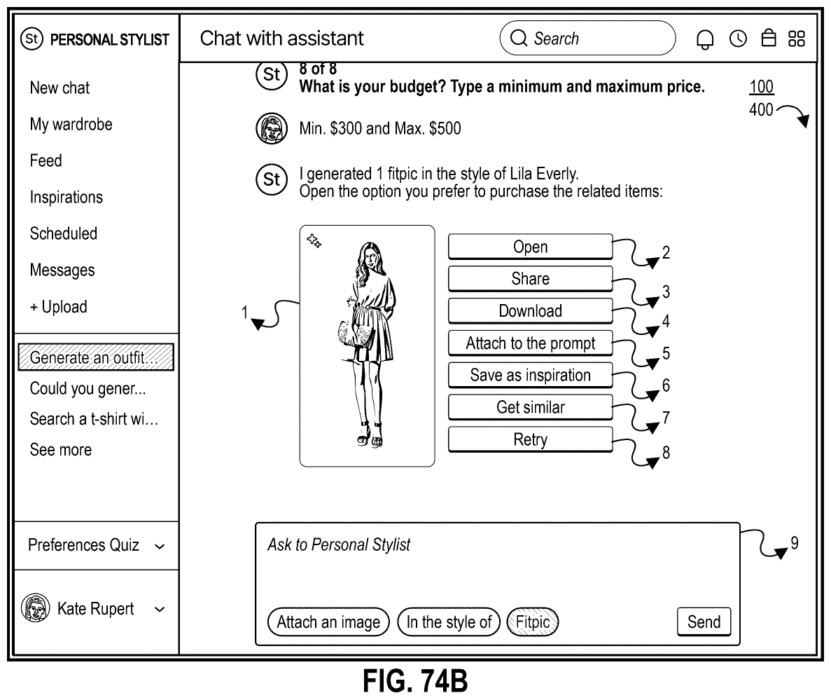

FIG. 74A The figure shows the conversation started after the user clicks the button ‘Send’ in the prompt field. The system will automatically update, in the panel to the left side, the chat history with the new prompt. The Personal Stylist will generate an outfit in the style of the selected user but it still needs some more extra info, starting with a questionnaire the user can answer or skip. Descriptions of arrows: (1) The user sent the prompt ‘Generate an outfit with a min budget of $100 and maximum $200’ in the style of Anne Tyron”. (2) Personal Stylist responds ‘For the best results I will ask some more questions to generate the perfect outfit!’. The Personal Stylist starts the questionnaire based on missed info of the user's prompt. In that case the occasion is missed but the budget is already shared. The Personal Stylist shows the number of the questions and asks ‘1 of 8—What is the occasion for this outfit? ’. (3) The user clicks the button ‘Skip this question’ to skip this specific question. (4) The user clicks the button ‘Skip the questionnaire and generate’ to skip the entire questionnaire and generate the fitpic. (5) The user replies by typing the answers in the prompt field.

FIG. 74B The figure shows the result. Descriptions of arrows: (1) Personal Stylist generated a fitpic. (2) The user clicks the button ‘Open’ to open the fitpic to see the related items to purchase, tagged inside the picture, (3) ‘Share’ to share it to someone, in the feed, or on social networks, (4) ‘Download’ to download the image, (5) ‘Attach to the prompt’ to attach the generated image in the prompt and ask more, (6) ‘Save as inspiration’ to save the image and related items in the personal saved inspirations, (7) ‘Get similar’ to generate a new similar fitpic with other items maybe in a different budget and (8) ‘Retry’ to generate a new different option. (9) The user is able to start a new request by typing a new prompt in the field.

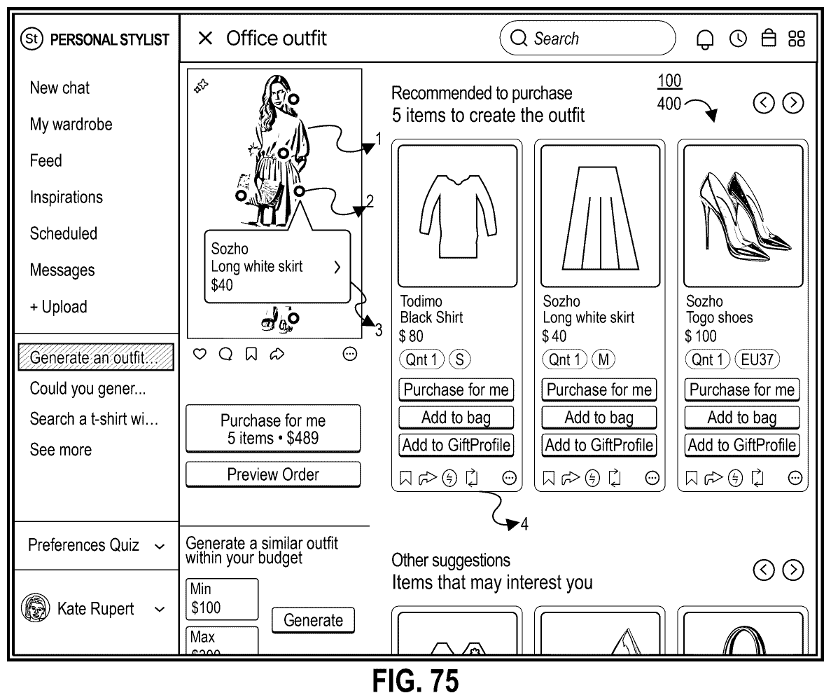

FIG. 75 The figure shows the opened fitpic in a dedicated webpage. It's the page where the user can see more info about the generated fitpic, it shows the realistic avatar of the user wearing the outfit or a generic model and see the list of related items to purchase to create the same outfit. Descriptions of arrows: (1) The system shows the generated Fitpic, (2) shoppable tags (Item links) (3) and the popup with the item preview (Brand, item name and price). It's a link to purchase the item. (4) The page shows the list of related items, they are the items the Personal Stylist recommends to purchase to recreate the same outfit of the generated image.

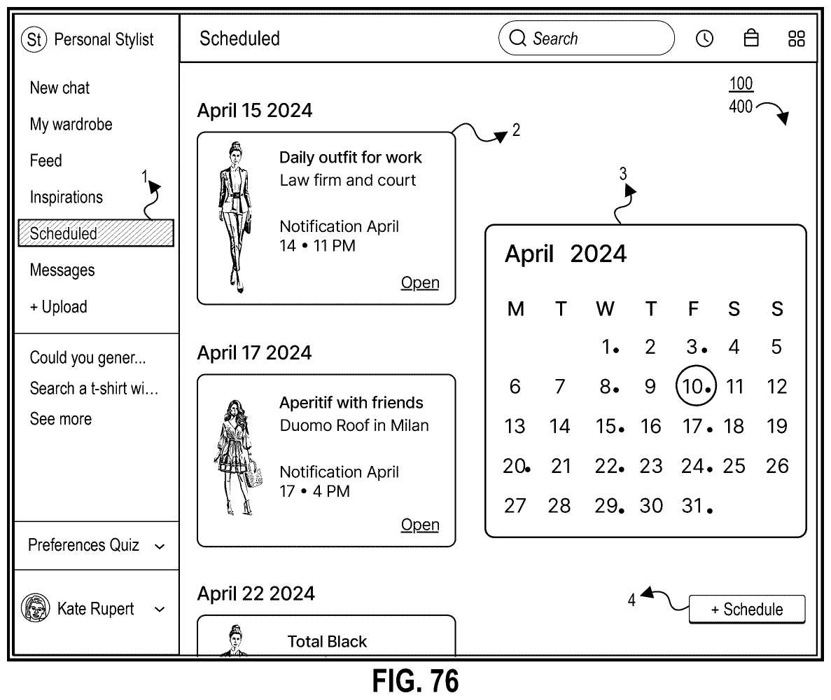

FIG. 76 The figures describe the feature ‘Scheduled’ to schedule outfits for some specific occasions or specific days and receive reminders notifications. Descriptions of arrows: (1) The user selects the option ‘Scheduled’ on the sidebar to the left. (2) Scheduled outfits appear in a list with outfit picture (fitpic), fitpic name, notification set in a date and time. (3) A calendar appears with the scheduled fitpic recognizable on the calendar with a dot (or other symbol). (4) The user clicks the button ‘Schedule’ to schedule a new outfit reminder.

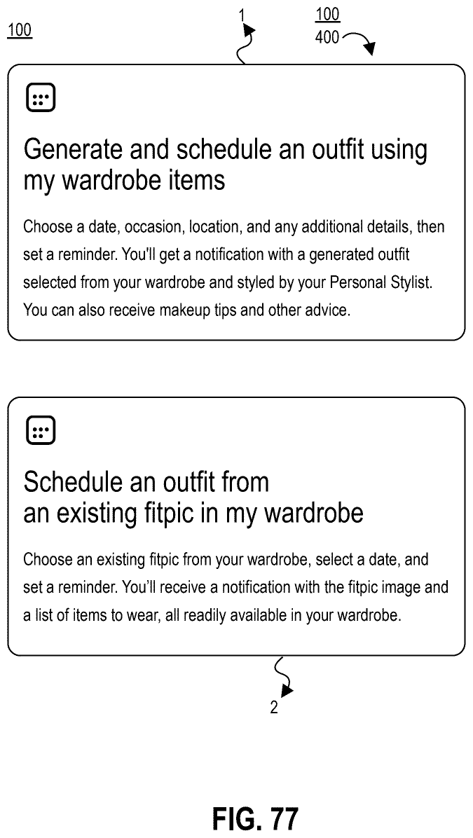

FIG. 77 The user clicking on the button ‘Schedule’ can see two options. Descriptions of arrows: (1) The first option will be ‘Schedule a generated outfit using my wardrobe items’. The user will choose a date, occasion, location, and any additional details, then set a reminder. The user will get a notification with a generated outfit selected from your wardrobe and styled by your Personal Stylist. The user can also receive makeup tips and other advice. (2) The second option will be ‘Schedule an outfit from an existing fitpic in my wardrobe’. The user will choose an existing fitpic from personal wardrobe, select a date, and set a reminder. The user will receive a notification with the fitpic image and a list of items to wear, all readily available in personal wardrobe.

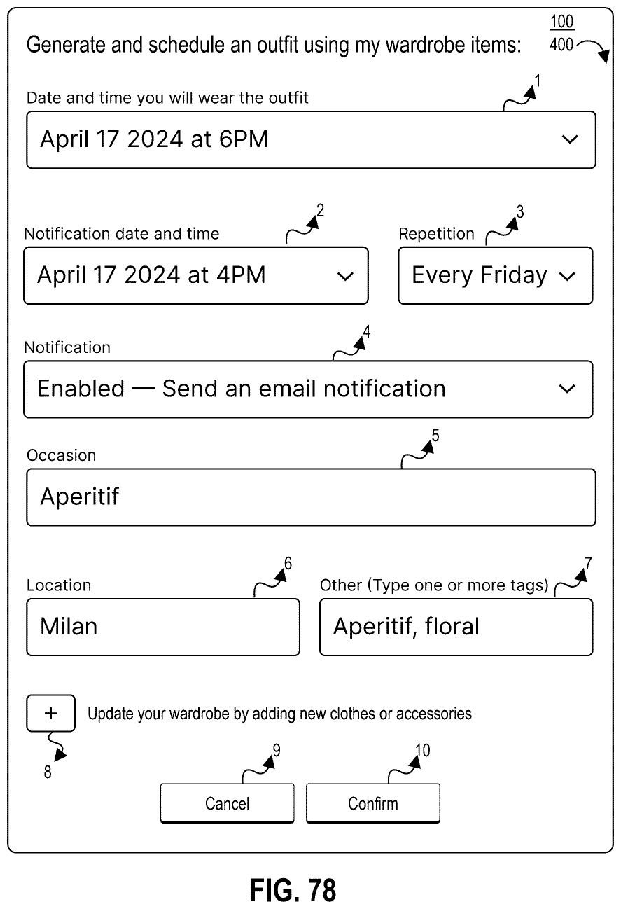

FIG. 78 The user selects the first option ‘Generate and schedule an outfit using my wardrobe items’. Descriptions of arrows: (1) The user select the date and time he will wear the outfit, (2) Set a date and time for the notification, (3) set the repetition option, (4) The user enable type of notification (Text message, email, or only in app notification), (5) occasion, (6) location, (7) other like tags, category and more. (8) The user can update your wardrobe by adding new clothes or accessories. (9) The user clicks the button ‘Cancel’ to close the view or (10) the button ‘Confirm’ to confirm and proceed.

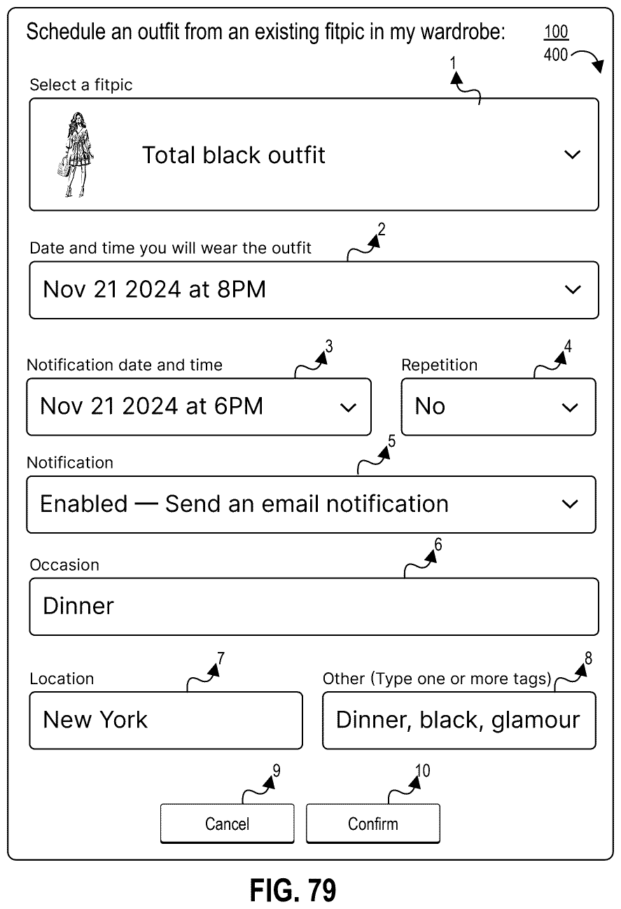

FIG. 79 The user selects the first option ‘Schedule an outfit from an existing fitpic in my wardrobe’. Descriptions of arrows: (1) The user select the fitpic would like to schedule for a specific date and time, (2) the date and time he will wear the outfit, (3) Set a date and time for the notification, (4) set the repetition option, (5) The user enable type of notification (Text message, email, or only in app notification), (6) occasion, (7) location, (8) other like tags, category and more. (9) The user clicks the button ‘Cancel’ to close the view or (10) the button ‘Confirm’ to confirm and proceed.

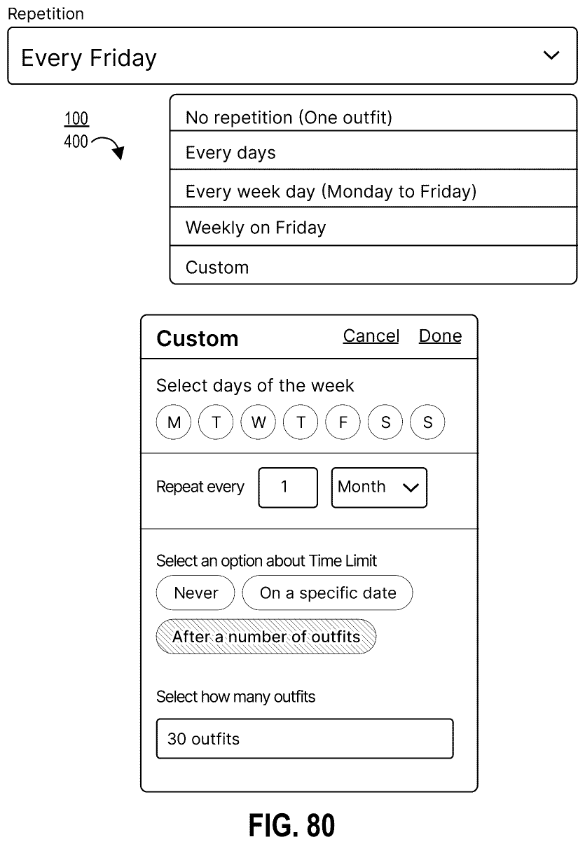

FIG. 80 The figure describes the repetition view where the user selects an option (No repetition, every day, every week, weekly on Friday, custom), and the customization view (Customize day of the week, repetition, time limits and number of outfits).

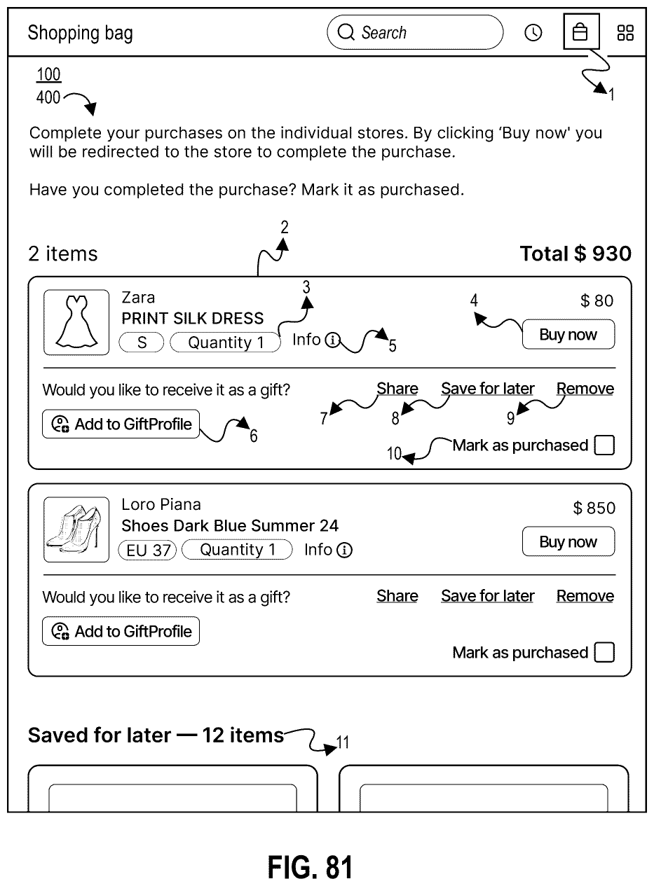

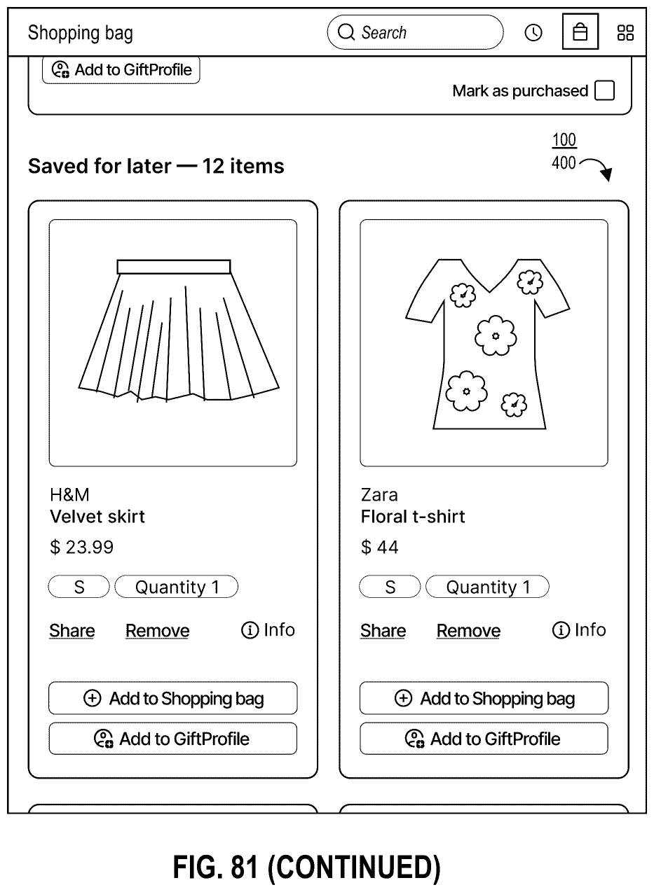

FIG. 81 The figure describes the feature ‘Shopping Bag’ where the user collects the items that he wants to buy. When the user finds an item on the platform, he can click on the add to shopping bag button. This is the section where the user will find all the items that he has added to be able to buy them. Descriptions of arrows: (1) The user visits the Shopping bag page by clicking the button on the nav bar on the top side of the screen. (2) The list of items appears with the total amount to pay. Each item has the product image, product name and brand. (3) Options such as quantity, sizes, colors etc., offered by the seller, (4) a buy now button, (5) other information like returns and delivery seller-policies, (6) the button ‘Add to GiftProfile’ to add it to a personal wishlist and other actions such as (7) share the item, (8) save for later (9) remove item or (10) mark as purchased. In fact the buyer can purchase an item on another website and by marking it as purchased the platform is communicated that it already has that item and the personal stylist will no longer suggest it.

FIG. 81 (Continued) The figure shows the scroll of the view to see the section ‘Saved for later’ Descriptions of arrows: (1) The user sees the item and the buttons to add it to the shopping bag or add to GiftProfile.

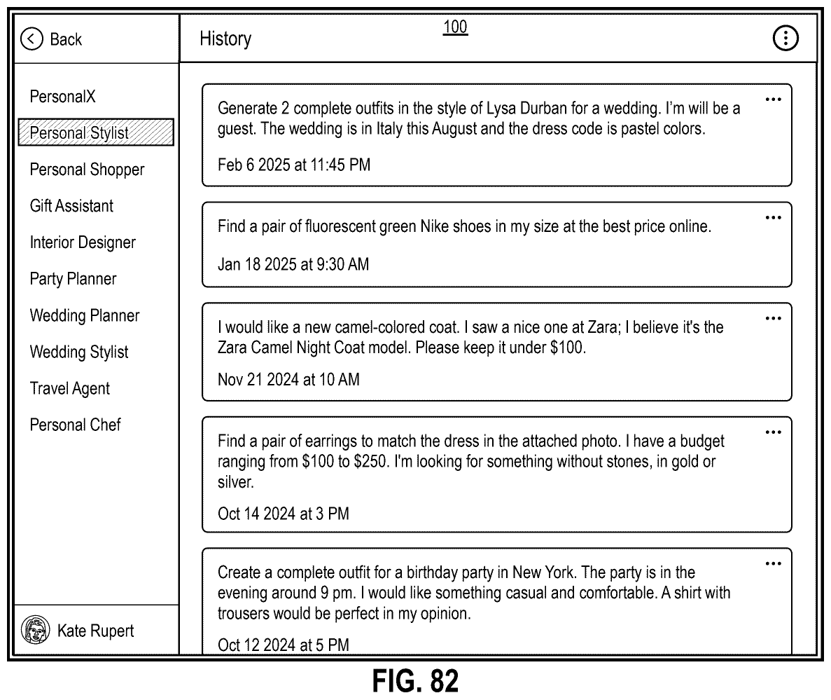

FIG. 82 The figure describes the ‘History’ page. The system collects the list of all the prompts sent by the user. It therefore contains the list of all the conversations that have been had with the PersonalX and other types of assistants available, thus showing the date and time.

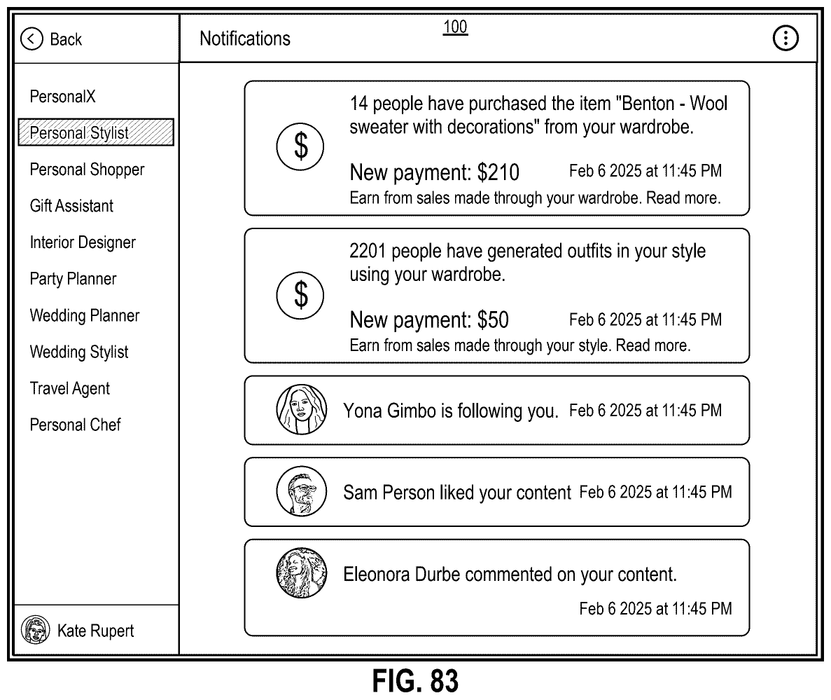

FIG. 83 The figure describes the notifications page. The user can click on the notifications symbol at the top of the navbar and access this page. On the sidebar on the left side of the screen there is the list of assistants that can be selected as a filter to see the related notifications. In the center instead we have the list of notifications.

Appendix A includes (i) respective lists of categories, hobbies, collections, relationships, sports, courses, genre of books, authors of books, occasions, styles, skin colors, eye colors, hair colors, types of hair, types of face shapes, types of body shape, categories of personal stylist, clothings, accessories, jewelry, underwear, times of day, contexts, weather conditions, dress codes, necklines, patterns, fabrics, jewelry materials, jewelry stones, shoes heels, materials for shoes, types of sleeves, types of dresses, type of bra, type of socks, types of shoes, types of rings, types of bracelets, types of watches, types of watch shapes, types of straps for watches, types of necklaces, types of earrings, types of shirts, types of t-shirts, types of pants, types of skirts, types of swimsuits, types of eyeglasses or sunglasses, types of bags, types of bags hardware, colors of bags hardware, materials of bags hardware, types of belts, types of belts hardware, (ii) respective questions about bracelets, rings, necklaces, clothings, dress, shirts, t-shirts, polo shirt, pullover, hoodie, cardigan, sweatshirt, jacket, tailleur, pants, jewelry, bracelets, rings, necklaces, and (iii) an alphabetical list of brands.

### Method for Personalized Outfit Recommendations Based on Celebrity Styles and Related Methods

The present disclosure also relate to a method of search comparison, and more particularly, to a system that allows users to search for outfits based on the style of celebrities or influencers.

In the digital age, the fashion industry has seen a significant transformation with the advent of online shopping and personalized recommendations. Consumers are increasingly looking for ways to express their individuality through fashion, often seeking inspiration from celebrities and influencers who set trends and define styles. The challenge for many is not just finding clothing that matches their personal taste but also ensuring that these choices fit within their specific constraints such as budget, occasion, and location. Traditional shopping methods often fall short in providing a seamless experience that combines these elements effectively.

Moreover, the rise of social media platforms has amplified the influence of celebrities and fashion icons, making their styles more accessible and desirable to the general public. However, translating these styles into practical, purchasable outfits that suit individual needs remains a complex task. This complexity is compounded by the need for visual confirmation of how these styles would look on the consumer, which is not typically addressed by standard e-commerce platforms. As a result, there is a growing demand for innovative solutions that can bridge the gap between celebrity-inspired fashion and personalized shopping experiences, offering users a more interactive and tailored approach to fashion discovery and purchase.

The method may involve a recommender system that can receive a desired style specification from a user, which is based on a style reference. The system can also receive user constraints, which may include a budget, location, or time of day. The system may generate outfit recommendations by matching the style reference with the user constraints and can present these recommendations to the user. Some examples of the style reference may include a celebrity or influencer's style. The presentation of outfit recommendations can include providing a fit pic of the user wearing a recommended outfit. The presentation of outfit recommendations may also include providing purchase links for recommended items. The presentation of outfit recommendations can involve displaying purchasable items grouped together to form a complete outfit. The method may further include receiving feedback from the user on the outfit recommendations and updating the recommender system based on the feedback. Generating outfit recommendations can also involve considering user preferences stored in a user profile. The user constraints may further include an occasion, a season, or a dress code. The generation of outfit recommendations can involve using machine learning algorithms to match the style reference with the user constraints. The presentation of outfit recommendations may include ranking the recommendations based on their relevance to the user. A system may include a user interface that can receive a desired style specification and user constraints from a user. The system may also include a recommender engine that can generate and present outfit recommendations to the user via the user interface. Some examples of the style reference in the system may include a celebrity or influencer's style. The user interface can present outfit recommendations by providing a fit pic of the user wearing a recommended outfit. The user interface may also present outfit recommendations by providing purchase links for recommended items. The user interface can present outfit recommendations by displaying purchasable items grouped together to form a complete outfit. The user interface may receive feedback from the user on the outfit recommendations, and the recommender engine can update itself based on the feedback. The recommender engine may generate outfit recommendations by considering user preferences stored in a user profile. The user constraints in the system may further include an occasion, a season, or a dress code. The recommender engine can generate outfit recommendations using machine learning algorithms to match the style reference with the user constraints. The user interface may present outfit recommendations by ranking them based on their relevance to the user.

The disclosure provides a method and system for generating personalized outfit recommendations. A user may specify a desired style based on a celebrity or influencer and provide additional details such as budget, location, and time of day. The system may match the style of the celebrity influencer with the user's constraints to find suitable outfit options. The system may present the outfit recommendations by displaying purchasable items grouped together to form a complete outfit, providing a fit pic of the user wearing the recommended outfit, and offering links where the user can purchase the recommended items. The user interface may facilitate the visualization and purchase of the recommended items, enhancing the overall user experience.

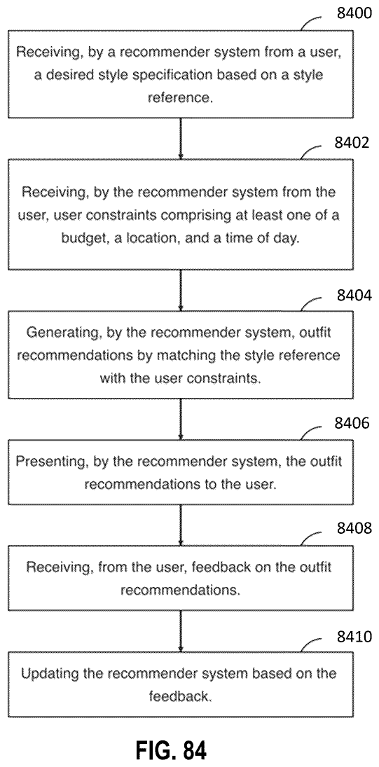

FIG. 84 is a flowchart illustrating a method for generating personalized outfit recommendations, according to an embodiment. A recommender system may receive a desired style specification from a user, which may be based on a style reference (8400). This style reference may include the style of a celebrity or influencer, allowing the user to define the search criteria for the outfit recommendations. The system may then utilize this style reference to align with the user's preferences. The style reference may be specified by the user, potentially involving the style of a celebrity or influencer, which may serve as a basis for the desired style specification. The system may then process this input to understand the user's style preferences. The style reference may be further detailed to include a celebrity or influencer's style, which may guide the system in tailoring the outfit recommendations to match the user's desired aesthetic. The system may then proceed to generate outfit recommendations by matching the style reference with the user constraints, which may include various factors such as budget, location, and time of day. This process may involve the use of machine learning algorithms to effectively align the style reference with the user constraints, ensuring that the recommendations are both relevant and personalized. The system may then present the outfit recommendations to the user, potentially providing a fit pic of the user wearing a recommended outfit, offering purchase links for recommended items, or displaying purchasable items grouped together to form a complete outfit. This presentation may be designed to facilitate the user's decision-making process by providing a comprehensive view of the recommended outfit options. The system may also consider user preferences stored in a user profile, further personalizing the recommendations to align with the user's individual tastes and preferences. This method may enable the user to receive tailored outfit recommendations that are both stylish and suitable for their specific needs and constraints.

In another step, the system may receive user constraints from the user, which may include a budget, a location, and a time of day (8402). These constraints may serve as additional parameters that the system can use to refine the search for outfit recommendations. The user may provide these constraints to set specific boundaries for the search, ensuring that the recommendations align with their personal requirements. The user constraints may also encompass an occasion, a season, and a dress code, further tailoring the recommendations to suit particular events or conditions. The system may utilize these constraints to match the style reference, which could be based on a celebrity or influencer, with the user's specified parameters. This process may involve the system considering various factors to generate suitable outfit options that meet the user's needs. The integration of these constraints into the recommendation process may enhance the system's ability to deliver personalized and relevant outfit suggestions to the user.

The process of generating outfit recommendations may be initiated by the system (8404). This step may involve the integration of a style reference, which could be based on a celebrity or influencer, with the user constraints provided earlier. The system may utilize these inputs to generate personalized outfit recommendations. The generation of these recommendations may further consider user preferences stored in a user profile, allowing for a more tailored suggestion. Additionally, machine learning algorithms may be employed to effectively match the style reference with the user constraints, enhancing the accuracy and relevance of the recommendations. This step may serve as a juncture in the method, as it combines various inputs to produce a set of outfit recommendations that align with the user's specified style and constraints. The use of machine learning algorithms may provide a sophisticated approach to analyzing and synthesizing the data, potentially leading to more precise and personalized recommendations.

The process may involve the presentation of outfit recommendations to the user by the system (8406). This step may encompass several potential actions that can be undertaken to effectively convey the recommendations. The system may present the outfit recommendations by providing a visual representation, such as a fit pic, which may depict the user wearing the recommended outfit. This visual aid may serve to enhance the user's understanding of how the outfit may appear when worn. Additionally, the system may offer purchase links for the recommended items, thereby facilitating the user's ability to acquire the suggested clothing items. Furthermore, the system may display purchasable items grouped together to form a complete outfit, which may assist the user in visualizing the ensemble as a cohesive unit. The recommendations may also be ranked based on their relevance to the user, potentially aiding the user in making informed decisions regarding the outfit choices. These actions may collectively contribute to a comprehensive presentation of outfit recommendations, allowing the user to engage with the suggestions in a manner that aligns with their preferences and constraints.

Feedback on the outfit recommendations may be received from the user (8408). This feedback may serve as an input to the system, allowing for the refinement and enhancement of future recommendations. The feedback may encompass various aspects of the outfit recommendations, such as the suitability of the style, the relevance of the items, and the overall satisfaction of the user. The user may provide this feedback through the user interface, which may be designed to facilitate easy and intuitive communication between the user and the system. The feedback may then be processed by the system, which may analyze the input to identify patterns, preferences, and areas for improvement. This process may involve the use of algorithms and data analysis techniques to ensure that the feedback is accurately interpreted and effectively utilized. The goal of receiving feedback may be to create a more personalized and satisfying experience for the user, by continuously adapting and improving the outfit recommendations based on the user's evolving preferences and needs.

The system may undergo an update process based on the feedback received from the user (8410). This update process may involve the system analyzing the feedback to refine its algorithms and improve the accuracy of future outfit recommendations. The feedback may be used to adjust the parameters and constraints within the system, ensuring that the recommendations align more closely with the user's preferences and constraints. The system may incorporate machine learning techniques to learn from the feedback and enhance its recommendation capabilities over time. This iterative process of updating the system based on user feedback may contribute to a more personalized and satisfactory user experience, as the system becomes more adept at understanding and catering to individual user needs. The system may continuously evolve, leveraging the feedback to optimize its performance and deliver more relevant and tailored outfit suggestions to the user.

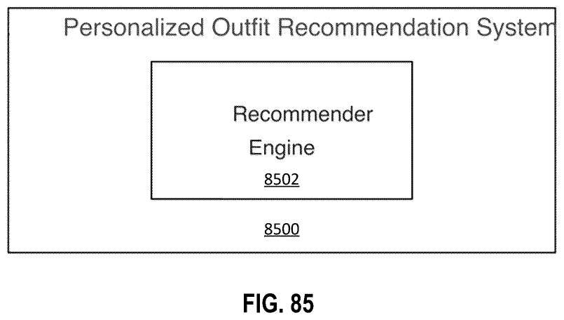

FIG. 85 illustrates a personalized outfit recommendation system 8500 with a recommender engine 8502, which may be a component in generating personalized outfit recommendations. The recommender engine may function by matching style references with user constraints. The style reference may be defined based on a celebrity or influencer, which may allow the user to specify a desired style. The user constraints may include budget, location, and time of day, which may be used to tailor the recommendations to the user's specific needs.

The recommender engine may receive a desired style specification based on a style reference, which may involve inputting style preferences. This process may be facilitated by the system, style reference, and user. The user may specify the desired style based on a celebrity or influencer, which may define the search criteria. Additionally, the user may provide further details such as budget, location, and time of day, which may set constraints for the search.

The recommender engine may generate outfit recommendations by matching the style reference with the user constraints. This action may involve the recommender engine, style reference, and user constraints working in conjunction to find suitable outfit options. The system may match the style of the celebrity influencer with the user's constraints, which may result in personalized recommendations.

The presentation of the outfit recommendations to the user may be achieved through various means. The system may display purchasable items grouped together to form a complete outfit, provide a fit pic of the user wearing the recommended outfit, and offer links where the user can purchase the recommended items. These actions may be facilitated by the user interface and system, which may present a complete outfit option, facilitate the purchase of the recommended items, and visualize the recommended outfit.

Implicitly, the recommender engine may also consider user preferences stored in a user profile, which may further personalize the recommendations. The system may update itself based on user feedback, which may enhance the accuracy and relevance of future recommendations. The integration of machine learning algorithms may also be implied, which may optimize the matching process between the style reference and user constraints.

More generally, a method and system for generating personalized outfit recommendations involve receiving a desired style specification and user constraints such as budget, location, and time of day is described above. The recommender system generates outfit recommendations by matching the style reference with these constraints and presents them to the user. The system can incorporate user feedback and preferences, and utilize machine learning algorithms to enhance recommendation accuracy. Additionally, the presentation of recommendations may include fit pics, purchase links, and ranked relevance to the user.

A method and system for generating personalized outfit recommendations may be characterized by the following clauses. Clause 1: A method for generating personalized outfit recommendations, comprising: receiving, by a recommender system from a user, a desired style specification based on a style reference; receiving, by the recommender system from the user, user constraints comprising at least one of a budget, a location, and a time of day; generating, by the recommender system, outfit recommendations by matching the style reference with the user constraints; and presenting, by the recommender system, the outfit recommendations to the user. Clause 2: The method of Clause 1, wherein the style reference comprises a celebrity or influencer's style. Clause 3: The method of Clause 1, wherein presenting the outfit recommendations comprises providing a fit pic of the user wearing a recommended outfit. Clause 4: The method of Clause 1, wherein presenting the outfit recommendations comprises providing purchase links for recommended items. Clause 5: The method of Clause 1, wherein presenting the outfit recommendations comprises displaying purchasable items grouped together to form a complete outfit. Clause 6: The method of Clause 1, further comprising: receiving, from the user, feedback on the outfit recommendations; and updating the recommender system based on the feedback. Clause 7: The method of Clause 1, wherein generating outfit recommendations further comprises considering user preferences stored in a user profile. Clause 8: The method of Clause 1, wherein the user constraints further comprise at least one of an occasion, a season, and a dress code. Clause 9: The method of Clause 1, wherein generating outfit recommendations comprises using machine learning algorithms to match the style reference with the user constraints. Clause 10: The method of Clause 1, wherein presenting the outfit recommendations comprises ranking the recommendations based on relevance to the user. Clause 11: A system for generating personalized outfit recommendations, comprising: a user interface configured to receive, from a user, a desired style specification based on a style reference and user constraints comprising at least one of a budget, a location, and a time of day; and a recommender engine configured to: generate outfit recommendations by matching the style reference with the user constraints; and present the outfit recommendations to the user via the user interface. Clause 12: The system of Clause 11, wherein the style reference comprises a celebrity or influencer's style. Clause 13: The system of Clause 11, wherein the user interface is further configured to present the outfit recommendations by providing a fit pic of the user wearing a recommended outfit. Clause 14: The system of Clause 11, wherein the user interface is further configured to present the outfit recommendations by providing purchase links for recommended items. Clause 15: The system of Clause 11, wherein the user interface is further configured to present the outfit recommendations by displaying purchasable items grouped together to form a complete outfit. Clause 16: The system of Clause 11, wherein: the user interface is further configured to receive, from the user, feedback on the outfit recommendations; and the recommender engine is further configured to update itself based on the feedback. Clause 17: The system of Clause 11, wherein the recommender engine is further configured to generate outfit recommendations by considering user preferences stored in a user profile. Clause 18: The system of Clause 11, wherein the user constraints further comprise at least one of an occasion, a season, and a dress code. Clause 19: The system of Clause 11, wherein the recommender engine is further configured to generate outfit recommendations using machine learning algorithms to match the style reference with the user constraints. Clause 20: The system of Clause 11, wherein the user interface is further configured to present the outfit recommendations by ranking the recommendations based on relevance to the user.

### AI-Based Stylist Recommendation System and Related Methods

The present disclosure also relates to an AI stylist recommendation feature, and more particularly, to a system and method for providing outfit or item recommendations based on the style of a specified person, such as a celebrity or influencer.

In recent years, the fashion industry has seen a significant shift towards digitalization, with online shopping and virtual styling becoming increasingly popular. Consumers are no longer limited to physical stores and can explore a vast array of fashion choices from the comfort of their homes. This shift has been driven by advancements in technology, particularly in artificial intelligence and machine learning, which have enabled more personalized and efficient shopping experiences. As consumers seek to emulate the styles of their favorite celebrities, movie characters, and influencers, there is a growing demand for tools that can provide tailored fashion recommendations that align with individual tastes and preferences.

The rise of social media platforms has further fueled this trend, as users are constantly exposed to new fashion trends and styles through influencers and celebrities they follow. This has created a need for innovative solutions that can bridge the gap between inspiration and purchase, allowing users to seamlessly transition from admiring a style to owning it. The integration of AI in fashion recommendation systems offers a promising avenue to meet this demand, providing users with curated outfit suggestions that reflect the style of their chosen icons, while also offering the convenience of direct purchasing options. As the fashion industry continues to evolve, the development of AI-driven stylist features represents a significant step towards enhancing the consumer shopping experience.

A computing device may receive a user's request for an outfit or item recommendation in the style of a specified entity. The device can generate a recommendation for shopable items based on the specified entity and create a visual representation of the user wearing these items. The device may then provide the visual representation along with links to purchase the recommended items.

The specified entity for the recommendation can be a celebrity, a movie character, or an influencer. The visual representation may include a fit pic, which can show how the items look on the user. The recommended shopable items can be displayed as distinct items, allowing the user to view each piece separately.

An AI stylist recommendation system may be used to generate the recommendation for shopable items. This system can include a shopping search bot or a personal stylist bot, which may assist in curating the recommendations.

A system may be configured to perform similar functions as the method described, where a computing device can receive a user request, generate recommendations, create visual representations, and provide purchase links. The specified entity for the style can be a celebrity, movie character, or influencer, and the visual representation may include a fit pic. The shopable items can be displayed distinctly, and an AI stylist recommendation system may be used, which can include a shopping search bot or a personal stylist bot.

A non-transitory computer-readable medium may store instructions that, when executed by a computing device, cause the device to perform the method of providing personalized outfit or item recommendations. The specified entity can be a celebrity, movie character, or influencer, and the visual representation may include a fit pic. The shopable items can be displayed as distinct items, and an AI stylist recommendation system may be used, which can include a shopping search bot or a personal stylist bot.

The user request for an outfit or item recommendation may be received via a shopping search bot or a personal stylist bot, which can facilitate the process of obtaining personalized recommendations.

This disclosure provides a method and system for offering personalized outfit or item recommendations. A computing device may receive a user request for an outfit or item recommendation in the style of a specified individual, such as a celebrity, movie character, or influencer. The computing device may generate a recommendation for one or more shopable items based on the specified individual, utilizing an AI stylist recommendation system. This system may include a shopping search bot or a personal stylist bot to enhance the recommendation process. The computing device may create a visual representation of the user wearing the recommended items, which may be displayed as distinct items or in the form of a fit pic. Additionally, the computing device may provide links to purchase the recommended items, facilitating the user's shopping experience. This feature may be integrated into existing platforms, allowing users to easily access personalized fashion suggestions.

In the context of the system, a user request for an outfit or item recommendation may be received by a computing device. This request can be initiated through a personal stylist bot or a shopping search bot, which may serve to integrate the AI stylist recommendation feature into existing platforms. The request may allow the user to specify a style associated with a particular individual, such as a celebrity, movie character, or influencer. The computing device may then generate a recommendation for one or more shopable items based on the specified individual. This recommendation process may be facilitated by an AI stylist recommendation system, which can match the style of the specified person to provide personalized recommendations. The computing device may create a visual representation of the user wearing the recommended items, which can be displayed as distinct items or in the form of a fit pic. This visual representation may serve to present the shopable items visually to the user. Additionally, the computing device may provide the visual representation along with links to purchase the recommended items, thereby facilitating the purchasing process. The entire procedure may be designed to enhance the user's shopping experience by offering personalized and visually engaging outfit recommendations.

In the context of the system, the AI stylist recommendation system may be utilized to generate a recommendation for one or more shopable items. This process may be based on the style of a specified individual, which can include a movie character, celebrity, or influencer. The computing device may play a role in this process by facilitating the generation of personalized recommendations. The recommendation may be tailored to match the style of a specific person, thereby providing a personalized experience for the user. The AI stylist recommendation system may be integrated with a computing device to enhance the recommendation process. The system may also consider the style of ‘x person’ to ensure that the recommendations align with the user's preferences. The computing device may further assist in creating a visual representation of the user wearing the recommended items. This visual representation may be displayed to the user as distinct items or in the form of a fit pic. The fit pic may serve to visualize the recommendation, allowing the user to see how the items may look when worn. The computing device may also provide links to purchase the recommended items, thereby facilitating the purchasing process. The links may be presented alongside the visual representation, offering a seamless transition from recommendation to purchase. The system may be designed to provide a comprehensive and personalized shopping experience, leveraging the capabilities of the AI stylist recommendation system and the computing device to deliver tailored outfit or item suggestions.

A computing device may be utilized to create a visual representation of the user wearing the recommended items. This visual representation may be displayed to the user as distinct items or in the form of a fit pic. The computing device may facilitate the visualization of the recommendation by presenting shopable items visually. The visual representation may include clothing items and shopable items, which may be depicted in a manner that allows the user to perceive how the items may appear when worn. The fit pic may serve as a tool to enhance the user's understanding of the recommended items'appearance. The computing device may also provide the visual representation and purchase links, which may facilitate the purchase of recommended items. The links to purchase those items may be included to streamline the purchasing process for the user. The integration of these elements may allow the user to seamlessly transition from viewing the visual representation to acquiring the items, thereby enhancing the overall user experience.

According to an embodiment, the computing device may be configured to provide the visual representation and purchase links, which may facilitate the purchase of recommended items. This process may involve the computing device offering links to purchase those items, potentially enhancing the user's shopping experience. The computing device may be responsible for ensuring that the visual representation and purchase links are accurately provided, which may assist in the seamless transition from recommendation to purchase. The links may be designed to direct the user to the appropriate platforms where the recommended items can be purchased, thereby streamlining the purchasing process. The computing device may also ensure that the visual representation is clear and informative, which may aid the user in making informed purchasing decisions. The integration of these functionalities may be significant in providing a comprehensive and user-friendly recommendation system.

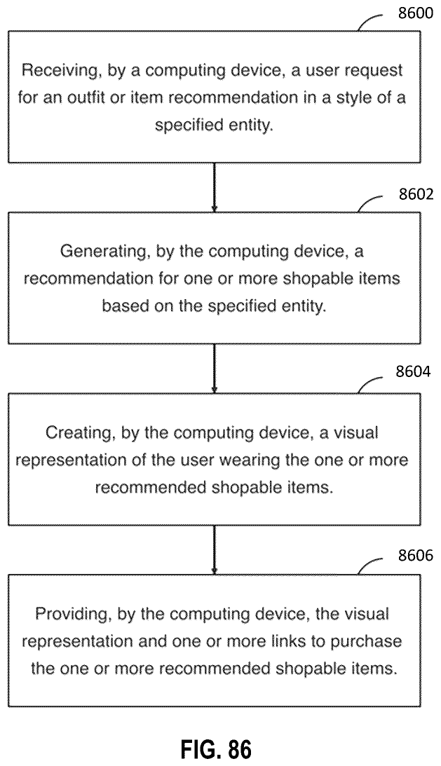

FIG. 86 is a flowchart illustrating a method in step 8600 for receiving a user request for an outfit or item recommendation in the style of a specified individual, according to an embodiment. At step 8600, a computing device may receive a user request for an outfit or item recommendation. This request may be made in the style of a specified individual, which can include a celebrity, movie character, or influencer. The specified individual may be referred to as ‘x person’ in the context of the system. The user request may be received via a shopping search bot or a personal stylist bot, which are integrated into existing platforms to facilitate the recommendation process. The computing device may then process this request to initiate the recommendation process, allowing the user to receive personalized outfit or item suggestions. The integration of the shopping search or personal stylist bot may enhance the user experience by providing a seamless interface for requesting recommendations. The system may be designed to accommodate various user preferences and styles, ensuring that the recommendations align with the user's desired aesthetic. The computing device may utilize an AI stylist recommendation feature to generate these recommendations, leveraging advanced algorithms to match the style of the specified individual. This process may involve analyzing the user's request and comparing it with a database of styles associated with the specified individual. The AI stylist recommendation feature may be capable of adapting to different fashion trends and user preferences, providing a dynamic and personalized recommendation experience. The overall system may be designed to offer a comprehensive solution for users seeking fashion advice, integrating various components to deliver a cohesive and user-friendly experience.

In step 8602, the process may involve generating a recommendation for one or more shopable items based on a specified individual. This process may be facilitated by a computing device, which may utilize an AI stylist recommendation system to perform this task. The AI stylist recommendation system may comprise components such as a shopping search bot or a personal stylist bot, which may assist in tailoring the recommendations to match the style of a specific person, such as a celebrity, movie character, or influencer. The computing device may analyze the style preferences associated with the specified individual and generate a list of shopable items that align with these preferences. The AI stylist recommendation feature may be designed to integrate seamlessly into existing platforms, allowing users to request personalized outfit or item recommendations. The system may leverage data and algorithms to ensure that the recommendations are both relevant and appealing to the user, potentially enhancing the overall user experience by providing tailored fashion suggestions.

At step 8604, a visual representation of the user wearing the recommended shopable items may be created by the computing device. This visual representation can potentially include a fit pic, which may serve to present the shopable items visually to the user. The computing device may utilize the AI stylist recommendation feature to generate this visual representation, which may be displayed to the user as distinct items or in the form of a fit pic. The fit pic may provide a visual depiction of the user adorned in the recommended items, thereby enhancing the user's ability to visualize the recommendation. This process may involve the integration of various components, such as the computing device and the AI stylist recommendation feature, to ensure that the visual representation aligns with the user's request for an outfit or item recommendation in the style of a specified individual. The creation of the visual representation may be a significant step in the overall method, as it may facilitate the user's decision-making process by providing a tangible visualization of the recommended items.

At step 8606, the computing device may provide the visual representation and one or more links to purchase the recommended shopable items. This step may involve the computing device facilitating the display of the visual representation, which may include the user wearing the recommended items, and may also include distinct items. The visual representation may be presented in a manner that allows the user to view the items as separate elements or as part of a cohesive outfit. The computing device may also generate and provide links that enable the user to purchase the recommended items directly. These links may be integrated into the visual representation or provided alongside it, allowing for a seamless transition from viewing to purchasing. The computing device may ensure that the links are functional and direct the user to the appropriate purchasing platforms. This step may be significant in bridging the gap between recommendation and acquisition, thereby enhancing the overall user experience by providing a convenient and efficient means of obtaining the recommended items. The process may be designed to be intuitive, allowing users to easily navigate from the visual representation to the purchasing stage, thereby streamlining the shopping experience.

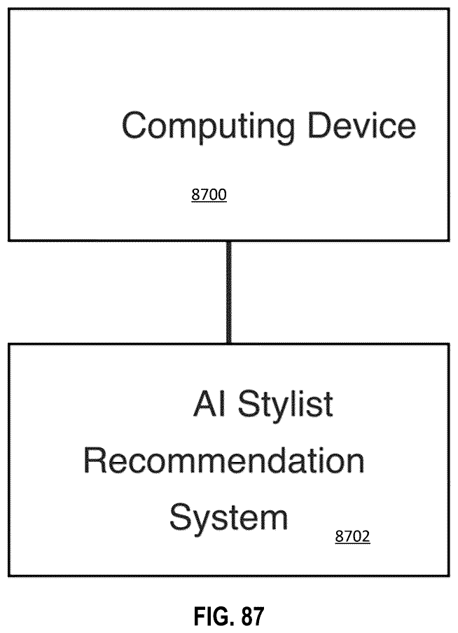

FIG. 87 illustrates the AI Stylist Recommendation System 8702, which may be responsible for generating personalized outfit or item recommendations. The AI Stylist Recommendation System 8702 may include sub-components such as the Shopping Search Bot and the Personal Stylist Bot. The Shopping Search Bot may facilitate the reception of user requests, while the Personal Stylist Bot may assist in receiving user requests and providing personalized styling. The AI Stylist Recommendation System 8702 may generate recommendations for shopable items based on the style of a specified individual, which may include celebrities, movie characters, or influencers. The system may allow a user to request a recommendation through a bot, which may initiate the recommendation process. The AI Stylist Recommendation System 8702 may generate a recommendation for one or more shopable items, which may be displayed to the user (e.g., at a computing device 8700) as distinct items or in the form of a fit pic. The visual representation of the user wearing the recommended items may be created to visualize the recommendation. The system may provide the visual representation and purchase links to facilitate the purchase of recommended items. The AI Stylist Recommendation System 8702 may integrate the feature into existing platforms to provide outfit or item suggestions. The system may match the style of a specific person, allowing users to receive recommendations in the style of a specified individual. The AI Stylist Recommendation System 8702 may be featured within a shopping search or personal stylist bot, enhancing the user experience by providing personalized recommendations.

More generally, a method and system for providing personalized outfit or item recommendations involve receiving a user request for recommendations in the style of a specified entity, such as a celebrity, movie character, or influencer are described above. The system generates recommendations for shopable items and creates a visual representation of the user wearing these items. It then provides the visual representation along with links to purchase the recommended items. The recommendations are generated by an AI stylist recommendation system, which may include a shopping search bot or a personal stylist bot.

A method and system for providing personalized outfit or item recommendations may be characterized by the following clauses. Clause 1: A method for providing personalized outfit or item recommendations, comprising: receiving, by a computing device, a user request for an outfit or item recommendation in a style of a specified entity; generating, by the computing device, a recommendation for one or more shopable items based on the specified entity; creating, by the computing device, a visual representation of the user wearing the one or more recommended shopable items; and providing, by the computing device, the visual representation and one or more links to purchase the one or more recommended shopable items. Clause 2: The method of Clause 1, wherein the specified entity is at least one of a celebrity, a movie character, or an influencer. Clause 3: The method of Clause 1, wherein the visual representation comprises a fit pic. Clause 4: The method of Clause 1, wherein the one or more recommended shopable items are displayed as distinct items. Clause 5: The method of Clause 1, wherein generating the recommendation for one or more shopable items is performed by an AI stylist recommendation system. Clause 6: The method of Clause 5, wherein the AI stylist recommendation system comprises at least one of a shopping search bot or a personal stylist bot. Clause 7: A system for providing personalized outfit or item recommendations, comprising: a computing device configured to: receive a user request for an outfit or item recommendation in a style of a specified entity; generate a recommendation for one or more shopable items based on the specified entity; create a visual representation of the user wearing the one or more recommended shopable items; and provide the visual representation and one or more links to purchase the one or more recommended shopable items. Clause 8: The system of Clause 7, wherein the specified entity is at least one of a celebrity, a movie character, or an influencer. Clause 9: The system of Clause 7, wherein the visual representation comprises a fit pic. Clause 10: The system of Clause 7, wherein the one or more recommended shopable items are displayed as distinct items. Clause 11: The system of Clause 7, wherein generating the recommendation for one or more shopable items is performed by an AI stylist recommendation system. Clause 12: The system of Clause 11, wherein the AI stylist recommendation system comprises at least one of a shopping search bot or a personal stylist bot. Clause 13: A non-transitory computer-readable medium storing instructions that, when executed by a computing device, cause the computing device to perform a method for providing personalized outfit or item recommendations, the method comprising: receiving a user request for an outfit or item recommendation in a style of a specified entity; generating a recommendation for one or more shopable items based on the specified entity; creating a visual representation of the user wearing the one or more recommended shopable items; and providing the visual representation and one or more links to purchase the one or more recommended shopable items. Clause 14: The non-transitory computer-readable medium of Clause 13, wherein the specified entity is at least one of a celebrity, a movie character, or an influencer. Clause 15: The non-transitory computer-readable medium of Clause 13, wherein the visual representation comprises a fit pic. Clause 16: The non-transitory computer-readable medium of Clause 13, wherein the one or more recommended shopable items are displayed as distinct items. Clause 17: The non-transitory computer-readable medium of Clause 13, wherein generating the recommendation for one or more shopable items is performed by an AI stylist recommendation system. Clause 18: The non-transitory computer-readable medium of Clause 17, wherein the AI stylist recommendation system comprises at least one of a shopping search bot or a personal stylist bot. Clause 19: The method of Clause 1, wherein the user request is received via at least one of a shopping search bot or a personal stylist bot. Clause 20: The system of Clause 7, wherein the user request is received via at least one of a shopping search bot or a personal stylist bot.

### Social Shopping Environment With Multi-Agent Search and Related Methods

The present disclosure also relates to a personal stylist system and method, and more particularly, to a system and method for conducting a multi-agent shopping search within a social shopping environment.

In recent years, the fashion industry has seen a significant shift towards digitalization, with online shopping becoming increasingly popular among consumers. This trend has been driven by the convenience and accessibility of online platforms, which allow users to browse and purchase clothing from the comfort of their homes. However, despite the growth of e-commerce, many consumers still face challenges when it comes to finding clothing that matches their personal style and preferences. Traditional online shopping platforms often lack personalized recommendations, making it difficult for users to discover new styles or outfits that suit their tastes.

Moreover, the rise of social media has transformed the way people engage with fashion, with many individuals seeking inspiration from influencers and peers. This has led to a growing demand for platforms that combine social interaction with shopping, allowing users to share their fashion choices and discover new trends through their social networks. As a result, there is a need for innovative solutions that integrate social elements into the shopping experience, providing users with personalized recommendations and the ability to explore and interact with fashion in a more engaging and interactive way.

The computer-implemented method may provide personalized style recommendations within a social shopping environment. The method can involve a personal stylist agent searching for a wardrobe linked to a specific person, with the wardrobe stored in a remote storage system. The personal stylist agent may identify styles associated with the wardrobe. A user can request recommendations in the style of the specific person, and the method may generate virtual fit pics showing digital representations of the user wearing clothing items based on the identified styles. These virtual fit pics can be provided to the user and may include interactive elements for purchasing the clothing items. The user may select to follow the wardrobe of the specific person, and the wardrobe can be displayed in the user's content stream. The specific person may provide new digital representations or clothing items, which can be displayed in the user's content stream.

The system may offer personalized style recommendations in a social shopping environment, comprising a remote storage system for storing wardrobes associated with persons. A personal stylist agent can search for a wardrobe linked to a specific person and identify styles associated with the wardrobe. A user interface may receive a request from a user for style recommendations and provide virtual fit pics showing digital representations of the user wearing clothing items based on identified styles. These virtual fit pics can include interactive elements for purchasing the clothing items. A social wardrobe feed may allow the user to follow a specific person's wardrobe, display it in the user's content stream, and show new digital representations or clothing items provided by the specific person. The styles identified in the method may include classic, business casual, or elegant options. The request for style recommendations can be made through a button click. Interactive elements in the virtual fit pics may include shoppable links. New digital representations may comprise fitpics. The styles identified in the system may include classic, business casual, or elegant options. The request for style recommendations in the system can be made through a button click. Interactive elements in the system's virtual fit pics may include shoppable links. New digital representations in the system may comprise fitpics. The remote storage system in the method may be cloud-based. Virtual fit pics in the method can be generated based on the user's body measurements and clothing items. The user's content stream in the method may be a social media feed. New digital representations or clothing items in the method can be displayed in real-time in the user's content stream. The remote storage system in the system may be cloud-based. Virtual fit pics in the system can be generated based on the user's body measurements and clothing items. The user's content stream in the system may be a social media feed. New digital representations or clothing items in the system can be displayed in real-time in the user's content stream. The method may include receiving a purchase request from the user for clothing items and processing the request. The system's user interface can receive a purchase request from the user for clothing items and process the request.

The disclosure provides a computer-implemented method and system for offering personalized style recommendations within a social shopping environment. The core components include a personal stylist agent, a remote storage system, a user interface, and a social wardrobe feed. The personal stylist agent may search for a wardrobe associated with a specific person, which is stored in a cloud-based remote storage system, and identify styles linked to that wardrobe. Users can request style recommendations through a user interface, which may generate virtual fit pics—digital representations of the user wearing clothing items based on identified styles. These virtual fit pics can include interactive elements, such as shoppable links, enabling users to purchase clothing items. The social wardrobe feed may allow users to follow specific wardrobes, displaying them in their content stream, and update the stream with new digital representations or clothing items as they are added by the specific person. This system and method can facilitate a seamless and interactive shopping experience, allowing users to visualize and purchase outfits while staying updated with the latest wardrobe additions.

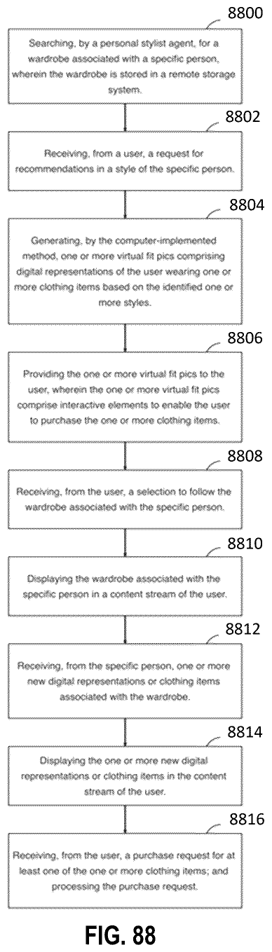

FIG. 88 is a flowchart illustrating a method in step 8800 for searching for a wardrobe associated with a specific person, according to an embodiment. At step 8800, the personal stylist agent may initiate a search for a wardrobe that is associated with a specific person. This wardrobe may be stored in a remote storage system, which could potentially be a cloud-based storage system. The personal stylist agent may utilize this search to identify one or more styles associated with the wardrobe, which may include styles such as classic, business casual, or elegant. The search may be conducted based on the styles that the specific person has chosen to affiliate with their wardrobe. This process may involve accessing and exploring wardrobe options and filtering these options by style. The wardrobe stored in the cloud may serve as a repository for the personal stylist agent to identify and recommend styles. The search may be facilitated by the personal stylist agent, which may be configured to efficiently locate and identify the wardrobe and its associated styles. The wardrobe's storage in a remote system may allow for seamless access and retrieval of style information, enabling the personal stylist agent to provide personalized style recommendations in a social shopping environment.

In step 8802, the user interface may be designed to receive a request from a user for style recommendations associated with a specific person. This request may be facilitated through a button click, which can serve as a mechanism for the user to express interest in obtaining personalized style suggestions. The user interface may act as a conduit for this interaction, allowing the user to engage with the system in a manner that is both intuitive and efficient. The action of receiving a request for recommendations may be integral to the system's functionality, as it may initiate the process of generating tailored style advice for the user. The button click may be a component of this interaction, providing a straightforward and accessible means for the user to communicate their preferences to the system. This step may highlight the importance of user engagement in the social shopping environment, as it may set the stage for subsequent actions that aim to deliver personalized and interactive style experiences.

At step 8804, the computer-implemented method may generate one or more virtual fit pics, which may comprise digital representations of the user wearing one or more clothing items based on the identified styles. The generation of these virtual fit pics may be based on the user's body measurements and the selected clothing items. This process may involve the creation of virtual pictures that can visually represent the user in various outfits, potentially enhancing the user's shopping experience by providing a more personalized and interactive approach to style recommendations. The virtual fit pics may include interactive elements, such as shoppable links, which may enable the user to purchase the clothing items directly from the virtual representation. This integration of interactive elements may facilitate a seamless transition from style visualization to purchase, thereby potentially streamlining the shopping process within the social shopping environment. The method may leverage the capabilities of the personal stylist agent to ensure that the virtual fit pics align with the user's style preferences, as identified from the wardrobe associated with a specific person. This approach may enhance the personalization of style recommendations, offering users a tailored shopping experience that reflects their unique fashion sense.

In the context of the system, the process of providing virtual fit pics to the user may involve several interconnected actions. Initially, the generation of virtual fit pics, which are digital representations of the user wearing selected clothing items, may be based on the identified styles associated with the user's preferences. These virtual fit pics may be provided to the user through a user interface, which may include interactive elements designed to facilitate the user's engagement with the clothing items. The interactive elements within the virtual fit pics may comprise shoppable links, allowing the user to explore purchasing options directly from the visual representation. This integration of interactive elements may enable the user to seamlessly transition from viewing the virtual fit pics to initiating a purchase process for the clothing items depicted. The system may leverage these interactive elements to enhance the user's shopping experience by providing a direct and intuitive pathway to purchase, thereby bridging the gap between style visualization and acquisition. The overall process may be designed to offer a personalized and engaging shopping experience, where the user can visualize potential outfits and make informed purchasing decisions based on the virtual representations provided.

At step 8808, the user may choose to follow a wardrobe associated with a specific person. This action may involve the user selecting an option to receive updates related to the wardrobe of interest. The wardrobe, which may be stored in a remote storage system, could be linked to a specific person whose style the user finds appealing. By following the wardrobe, the user may gain access to a content stream that showcases the wardrobe's items. This content stream may be part of a social media feed, allowing the user to stay updated with any new digital representations or clothing items associated with the wardrobe. The process of following a wardrobe may enhance the user's engagement with the social shopping environment, providing a personalized experience tailored to their style preferences. The system may facilitate this interaction by displaying the wardrobe in the user's content stream, ensuring that any updates or new items are readily accessible. This integration of social media elements with personalized style recommendations may create a dynamic and interactive shopping experience for the user.

In the context of the system, the step of displaying the wardrobe associated with a specific person in a content stream of the user may involve several interconnected actions. The wardrobe, which may be associated with a specific person, can be displayed in the user's content stream, potentially enhancing the user's engagement with the platform. This process may involve the use of a social media feed, which can serve as the content stream for the user. The wardrobe, potentially comprising various styles and clothing items, may be showcased in this feed, allowing the user to view and interact with the wardrobe in a dynamic and engaging manner. The content stream may be designed to integrate seamlessly with the user's existing social media activities, providing a cohesive and immersive experience. The display of the wardrobe in the content stream may be facilitated by the system's ability to manage and present digital representations of the wardrobe items, potentially including images and other media. This integration may allow the user to explore the wardrobe in a visually appealing format, potentially encouraging further interaction and engagement with the platform. The system may also be capable of updating the content stream in real-time, ensuring that the user receives the most current and relevant information about the wardrobe and its associated items. This capability may enhance the user's experience by providing timely updates and maintaining the relevance of the content presented in the feed. Overall, the display of the wardrobe in the user's content stream may serve as a component of the system's functionality, potentially driving user engagement and facilitating a more personalized and interactive shopping experience.

At step 8812, the system may receive new digital representations or clothing items from a specific person, which may be associated with their wardrobe. This process may involve the specific person providing new fitpics or other digital representations that reflect updates to their wardrobe. These new digital representations may be stored and managed within the system, potentially involving the use of cloud-based storage solutions to ensure accessibility and integration with the existing wardrobe data. The system may then process these new inputs to update the wardrobe's digital presence, ensuring that the latest styles and items are accurately reflected.

The new digital representations, which may include fitpics, can be integrated into the content stream of users who follow the specific person's wardrobe. This integration may involve displaying the new items in a social media-like feed, allowing users to view and interact with the latest updates in real-time. The system may facilitate this by leveraging interactive elements within the digital representations, such as shoppable links, which may enable users to explore and potentially purchase the new clothing items directly from the feed.

The process of receiving and displaying new digital representations may be designed to enhance user engagement by providing a dynamic and interactive shopping experience. By allowing users to follow specific wardrobes and receive updates in their content stream, the system may create a personalized and socially-driven shopping environment. This approach may encourage users to explore new styles and make informed purchasing decisions based on the latest fashion trends and updates from the wardrobes they follow.

At step 8814, the process may involve displaying one or more new digital representations or clothing items in the content stream of the user. This step may be part of a broader system designed to provide personalized style recommendations within a social shopping environment. The content stream, which may be a social media feed, can serve as a platform where users may view updates related to wardrobes they follow. The new digital representations or clothing items, potentially including fitpics, may be displayed in real-time, allowing users to stay updated with the latest additions to the wardrobes they are interested in. This real-time display may enhance user engagement by providing immediate access to new styles and clothing items. The system may utilize a personal stylist agent to manage and update the content stream, ensuring that the user receives the most current information. The integration of these elements may facilitate a dynamic and interactive shopping experience, where users can explore and potentially purchase new clothing items directly from their content stream.

At step 8816, a purchase request for at least one of the clothing items may be received from the user, and the processing of this purchase request may be initiated. The user may interact with the system to express interest in acquiring specific clothing items, which may have been previously recommended or visualized through virtual fit pics. The system may facilitate this process by providing a seamless interface for the user to make selections and proceed with the purchase. The processing of the purchase request may involve verifying the availability of the selected items, confirming the user's payment details, and ensuring the transaction is completed successfully. This step may be crucial in transitioning from the recommendation phase to the actual acquisition of clothing items, thereby enhancing the user's shopping experience within the social shopping environment. The system may also ensure that the user's preferences and previous interactions are taken into account to streamline the purchase process, potentially offering personalized suggestions or alternatives if the initially selected items are unavailable.

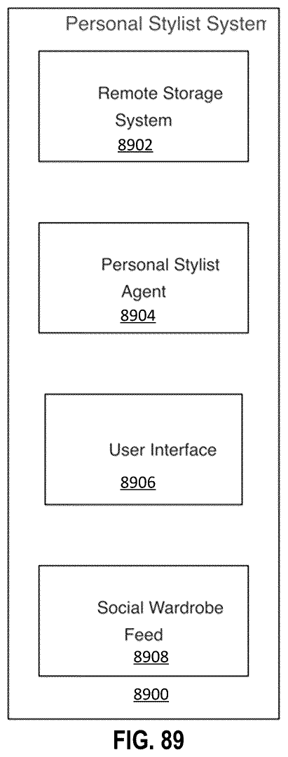

FIG. 89 illustrates the Remote Storage System 8900, which may be a component in the social shopping environment. The Remote Storage System 8902 may store wardrobes in a cloud-based system, allowing for efficient and scalable storage solutions. This system may facilitate the storing of wardrobe data, enabling the personal stylist agent to search for a wardrobe associated with a specific person. The wardrobe data may be accessed and explored for style recommendations, which may be filtered by style, such as classic, business casual, or elegant. The Remote Storage System 8902 may work in conjunction with other components, such as the Personal Stylist Agent and the User Interface, to provide a seamless user experience. The Personal Stylist Agent may search for wardrobes stored in the cloud and identify styles associated with those wardrobes. The User Interface may receive user requests for style recommendations and process purchase requests. The Social Wardrobe Feed may display wardrobes and updates in the user's content stream, providing real-time updates of new digital representations or clothing items. The integration of these components may enable the generation of virtual fit pics, which may include shoppable links, allowing users to visualize outfits and make purchases directly. The Remote Storage System 8902 may play a role in ensuring that the wardrobe data is readily available for these processes, supporting the overall functionality of the social shopping environment.

The Personal Stylist Agent component 8904 may be responsible for searching and identifying styles from wardrobes stored in a cloud-based system. This component may function by accessing the wardrobe data associated with a specific person and filtering wardrobe options by style, such as classic, business casual, or elegant. The Personal Stylist Agent may utilize a style identification sub-component to perform this task, which may involve analyzing the stored wardrobe data to identify the styles that align with the user's preferences or requests.

The Personal Stylist Agent may also interact with the user interface to receive user input for style recommendations. This interaction may be initiated by a button click, which may trigger the agent to search for wardrobe options based on the specified styles. The agent may then generate virtual fit pics, which are digital representations of the user wearing selected clothing items. These virtual fit pics may include shoppable links, allowing the user to visualize outfits and make purchases directly from the images.

Additionally, the Personal Stylist Agent may contribute to the social wardrobe feed by updating the user's content stream with new digital representations or clothing items associated with the followed wardrobes. This process may involve receiving updates from the specific person who owns the wardrobe and displaying these updates in real-time within the user's feed. The agent's ability to search, identify, and update styles may enhance the personalized shopping experience by providing tailored recommendations and facilitating seamless interactions within the social shopping environment.

The user interface component 8906 may serve as an element in the system, facilitating the interaction between the user and the personalized style recommendation process. This component may be responsible for receiving user requests, such as when a user may click a button to request style recommendations in the style of a specific person. The user interface may also process purchase requests, enabling users to engage with the system seamlessly. The sub-component, Virtual Fit Pics, may generate virtual fit pics that include shoppable links, allowing users to visualize themselves in various outfits and potentially make purchases directly through the interface. The user interface may thus act as a conduit for delivering style recommendations to the user by creating a visual representation of the style through these virtual fit pics. The actions associated with the user interface may include receiving user input for style recommendations and facilitating the visualization of outfits, which may be crucial for enabling users to explore and purchase clothing items based on their preferences. The integration of these functionalities within the user interface component 8906 may enhance the overall user experience by providing a streamlined and interactive platform for personalized style exploration and shopping.

The Social Wardrobe Feed component 8908 may display wardrobes and updates in the user's content stream. This component may include a Real-time Display sub-component, which may display new digital representations in real-time. The content stream may be associated with a specific person and may showcase the wardrobe in the user's feed. The feed may receive updates with new wardrobe items, which may include new digital representations or clothing items. These updates may be displayed in the content stream, allowing users to follow wardrobes and receive updates in their feed. The Social Wardrobe Feed component 8908 may facilitate the continuous engagement of users with the wardrobe content, enhancing the social shopping experience by providing real-time updates and interactive elements. The component may integrate seamlessly with other system components, such as the Personal Stylist Agent and User Interface, to ensure a cohesive and personalized user experience.

More generally, a computer-implemented method and system for providing personalized style recommendations in a social shopping environment are described. The method involves searching for a wardrobe associated with a specific person, identifying styles, and generating virtual fit pics for users. These virtual fit pics allow users to see digital representations of themselves wearing clothing items and include interactive elements for purchasing. Users can follow specific wardrobes, which are displayed in their content streams, and receive updates with new digital representations or clothing items. The system comprises a remote storage system, a personal stylist agent, a user interface, and a social wardrobe feed, all working together to enhance the shopping experience.

A computer-implemented method and system for providing personalized style recommendations in a social shopping environment may be characterized by the following clauses. Clause 1: A computer-implemented method for providing personalized style recommendations in a social shopping environment, the method comprising: searching, by a personal stylist agent, for a wardrobe associated with a specific person, wherein the wardrobe is stored in a remote storage system; identifying, by the personal stylist agent, one or more styles associated with the wardrobe; receiving, from a user, a request for recommendations in a style of the specific person; generating, by the computer-implemented method, one or more virtual fit pics comprising digital representations of the user wearing one or more clothing items based on the identified one or more styles; providing the one or more virtual fit pics to the user, wherein the one or more virtual fit pics comprise interactive elements to enable the user to purchase the one or more clothing items; receiving, from the user, a selection to follow the wardrobe associated with the specific person; displaying the wardrobe associated with the specific person in a content stream of the user; receiving, from the specific person, one or more new digital representations or clothing items associated with the wardrobe; and displaying the one or more new digital representations or clothing items in the content stream of the user. Clause 2: A system for providing personalized style recommendations in a social shopping environment, the system comprising: a remote storage system configured to store one or more wardrobes associated with one or more persons; a personal stylist agent configured to: search for a wardrobe associated with a specific person from the one or more wardrobes stored in the remote storage system; and identify one or more styles associated with the wardrobe; a user interface configured to: receive, from a user, a request for recommendations in a style of the specific person; and provide one or more virtual fit pics to the user, wherein the one or more virtual fit pics comprise digital representations of the user wearing one or more clothing items based on the identified one or more styles, and wherein the one or more virtual fit pics comprise interactive elements to enable the user to purchase the one or more clothing items; and a social wardrobe feed configured to: receive, from the user, a selection to follow the wardrobe associated with the specific person; display the wardrobe associated with the specific person in a content stream of the user; receive, from the specific person, one or more new digital representations or clothing items associated with the wardrobe; and display the one or more new digital representations or clothing items in the content stream of the user. Clause 3: The computer-implemented method of Clause 1, wherein the one or more styles comprise at least one of classic, business casual, or elegant. Clause 4: The computer-implemented method of Clause 1, wherein the request for recommendations is received via a button click. Clause 5: The computer-implemented method of Clause 1, wherein the interactive elements comprise shoppable links. Clause 6: The computer-implemented method of Clause 1, wherein the one or more new digital representations comprise one or more fitpics. Clause 7: The system of Clause 2, wherein the one or more styles comprise at least one of classic, business casual, or elegant. Clause 8: The system of Clause 2, wherein the request for recommendations is received via a button click. Clause 9: The system of Clause 2, wherein the interactive elements comprise shoppable links. Clause 10: The system of Clause 2, wherein the one or more new digital representations comprise one or more fitpics. Clause 11: The computer-implemented method of Clause 1, wherein the remote storage system comprises a cloud-based storage system. Clause 12: The computer-implemented method of Clause 1, wherein the one or more virtual fit pics are generated based on the user's body measurements and the one or more clothing items. Clause 13: The computer-implemented method of Clause 1, wherein the content stream of the user comprises a social media feed. Clause 14: The computer-implemented method of Clause 1, wherein the one or more new digital representations or clothing items are displayed in real-time in the content stream of the user. Clause 15: The system of Clause 2, wherein the remote storage system comprises a cloud-based storage system. Clause 16: The system of Clause 2, wherein the one or more virtual fit pics are generated based on the user's body measurements and the one or more clothing items. Clause 17: The system of Clause 2, wherein the content stream of the user comprises a social media feed. Clause 18: The system of Clause 2, wherein the one or more new digital representations or clothing items are displayed in real-time in the content stream of the user. Clause 19: The computer-implemented method of Clause 1, further comprising: receiving, from the user, a purchase request for at least one of the one or more clothing items; and processing the purchase request. Clause 20: The system of Clause 2, wherein the user interface is further configured to: receive, from the user, a purchase request for at least one of the one or more clothing items; and process the purchase request.

What is claimed is:

1. A computer-implemented method for providing personalized style recommendations in a social shopping environment, the method comprising:
searching, by a personal stylist agent, for a wardrobe associated with a specific person, wherein the wardrobe is stored in a remote storage system;
identifying, by the personal stylist agent, one or more styles associated with the wardrobe;
receiving, from a user, a request for recommendations in a style of the specific person;
generating, by the computer-implemented method, one or more virtual fit pics comprising digital representations of the user wearing one or more clothing items based on the identified one or more styles;
providing the one or more virtual fit pics to the user, wherein the one or more virtual fit pics comprise interactive elements to enable the user to purchase the one or more clothing items;
receiving, from the user, a selection to follow the wardrobe associated with the specific person;
displaying the wardrobe associated with the specific person in a content stream of the user;
receiving, from the specific person, one or more new digital representations or clothing items associated with the wardrobe; and displaying the one or more new digital representations or clothing items in the content stream of the user.

2. A system for providing personalized style recommendations in a social shopping environment, the system comprising:
a remote storage system configured to store one or more wardrobes associated with one or more persons;
a personal stylist agent configured to:
search for a wardrobe associated with a specific person from the one or more wardrobes stored in the remote storage system; and identify one or more styles associated with the wardrobe; a user interface configured to:
receive, from a user, a request for recommendations in a style of the specific person; and
provide one or more virtual fit pics to the user, wherein the one or more virtual fit pics comprise digital representations of the user wearing one or more clothing items based on the identified one or more styles, and wherein the one or more virtual fit pics comprise interactive elements to enable the user to purchase the one or more clothing items; and
a social wardrobe feed configured to:
receive, from the user, a selection to follow the wardrobe associated with the specific person;
display the wardrobe associated with the specific person in a content stream of the user;
receive, from the specific person, one or more new digital representations or clothing items associated with the wardrobe; and
display the one or more new digital representations or clothing items in the content stream of the user.

3. The computer-implemented method of claim 1, wherein the one or more styles comprise at least one of classic, business casual, or elegant.

4. The computer-implemented method of claim 1, wherein the request for recommendations is received via a button click.

5. The computer-implemented method of claim 1, wherein the interactive elements comprise shoppable links.

6. The computer-implemented method of claim 1, wherein the one or more new digital representations comprise one or more fitpics.

7. The system of claim 2, wherein the one or more styles comprise at least one of classic, business casual, or elegant.

8. The system of claim 2, wherein the request for recommendations is received via a button click.

9. The system of claim 2, wherein the interactive elements comprise shoppable links.

10. The system of claim 2, wherein the one or more new digital representations comprise one or more fitpics.

11. The computer-implemented method of claim 1, wherein the remote storage system comprises a cloud-based storage system.

12. The computer-implemented method of claim 1, wherein the one or more virtual fit pics are generated based on the user's body measurements and the one or more clothing items.

13. The computer-implemented method of claim 1, wherein the content stream of the user comprises a social media feed.

14. The computer-implemented method of claim 1, wherein the one or more new digital representations or clothing items are displayed in real-time in the content stream of the user.

15. The system of claim 2, wherein the remote storage system comprises a cloud-based storage system.

16. The system of claim 2, wherein the one or more virtual fit pics are generated based on the user's body measurements and the one or more clothing items.

17. The system of claim 2, wherein the content stream of the user comprises a social media feed.

18. The system of claim 2, wherein the one or more new digital representations or clothing items are displayed in real-time in the content stream of the user.

19. The computer-implemented method of claim 1, further comprising receiving, from the user, a purchase request for at least one of the one or more clothing items; and processing the purchase request.

20. The system of claim 2, wherein the user interface is further configured to: receive, from the user, a purchase request for at least one of the one or more clothing items; and process the purchase request.
